(19) United States
(12) Patent Application Publication
(10) Pub. No.: US 2026/0339313 A1
(43) Pub. Date: Oct. 29, 2026

(54) APPARATUS FOR AND METHOD OF GUIDED FAULT RESOLUTION FOR OPERATING SYSTEM

(71) Applicant: Quick Quack Car Wash Holdings, LLC, Roseville, CA (US)

(72) Inventors: Christopher Clinton Chappell, Lincoln, CA (US); Lukas Duncan Simonis, Sacramento, CA (US); Joshua David Schumacher, Sacramento, CA (US); Subramanian K. Swaminathan, San Diego, CA (US); Joseph Allen Steele, III, Plumas Lake, CA (US)

(73) Assignee: Quick Quack Car Wash Holdings, LLC, Roseville, CA (US)

(21) Appl. No.: 19/658,929

(22) Filed: Apr. 27, 2026

Related U.S. Application Data
(60) Provisional application No. 63/794,590, filed on Apr. 25, 2025.

(51) Int. Cl. G05B 23/02

(52) U.S. Cl. CPC G05B 23/0272; G05B 23/0235; G05B 23/0275

(57) ABSTRACT

An apparatus for guided fault resolution for an operating system includes one or more sensors, at least a processor, and a memory storing instructions that cause the processor to receive operation data including command-status data and sensor data for at least a control component of the operating system. The processor identifies at least a root-cause component and an associated fault state, generates a fault resolution protocol including one or more resolution instructions, and generates display data for a communication interface to present a component identification, a fault indication, and a first resolution instruction. The processor receives a completion input and updated operation data after performance of the first resolution instruction and updates the display data to present a subsequent resolution instruction.

### CROSS-REFERENCE TO RELATED APPLICATIONS

This application claims the benefit of priority of U.S. Provisional Patent Application Ser. No. 63/794,590, filed on Apr. 25, 2025, and titled “SYSTEMS AND METHODS FOR DISPENSING SYSTEMS,” which is incorporated by reference herein in its entirety.

### FIELD OF THE INVENTION

The present invention generally relates to the field of operating systems. In particular, the present invention is directed an apparatus for and method of guided fault resolution for an operating system.

### BACKGROUND

Conventional operating systems commonly rely on fault notifications when abnormal operation is detected. In many cases, site operators are often required to interpret the fault notifications manually. Accordingly, there is a need for systems and methods that address these challenges.

### SUMMARY OF THE DISCLOSURE

In some aspects, the techniques described herein relate to an apparatus for guided fault resolution for an operating system. The apparatus includes one or more sensors incorporated with an operating system, at least a processor, and a memory communicatively connected to the at least a processor, wherein the memory contains instructions configuring the at least a processor to receive operation data associated with operation of the operating system, wherein the operation data includes command-status data associated with the operating system, and sensor data from the one or more sensors for at least a control component of the operating system, identify at least a root-cause component and an associated fault state as a function of the operation data, generate a fault resolution protocol corresponding to the at least a root-cause component and the associated fault state, wherein the fault resolution protocol includes one or more resolution instructions, generate display data for a communication interface, wherein the display data causes the communication interface to present one or more of an identification of the at least a root-cause component, a fault indication corresponding to the associated fault state, and a first resolution instruction of the one or more resolution instructions, receive a completion input indicating completion of the first resolution instruction and updated operation data associated with the operation of the operating system, and update the display data to present a subsequent resolution instruction of the one or more resolution instructions as a function of the updated operation data.

In some aspects, the techniques described herein relate to a method of guided fault resolution for an operating system. The method includes receiving, using at least a processor, operation data associated with operation of the operating system, wherein the operation data includes command-status data associated with the operating system, and sensor data from the one or more sensors for at least a control component of the operating system, identifying, using the at least a processor, at least a root-cause component and an associated fault state as a function of the operation data, generating, using the at least a processor, a fault resolution protocol corresponding to the at least a root-cause component and the associated fault state, wherein the fault resolution protocol includes one or more resolution instructions, generating, using the at least a processor, display data for a communication interface, wherein the display data causes the communication interface to present one or more of an identification of the at least a root-cause component, a fault indication corresponding to the associated fault state, and a first resolution instruction of the one or more resolution instructions, receiving, using at least a processor, a completion input indicating completion of the first resolution instruction and updated operation data associated with the operation of the operating system, and updating, using at least a processor, the display data to present a subsequent resolution instruction of the one or more resolution instructions as a function of the updated operation data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary embodiment of an apparatus for guided fault resolution for an operating system;

FIG. 2 illustrates an exemplary communication interface;

FIG. 3 illustrates an exemplary embodiment of an operating system;

FIG. 4 illustrates another exemplary embodiment of the operating system;

FIG. 5 illustrates an exemplary embodiment of a dispensing station;

FIG. 6 illustrates another exemplary embodiment of an operating system;

FIG. 7 illustrates an exemplary embodiment of an apparatus for generating a mixture of a fluid and an active agent;

FIGS. 8A-C illustrate an exemplary embodiment of a controller;

FIGS. 9A-9B illustrate an exemplary embodiment of a soap channel;

FIG. 10 illustrates a block diagram of an exemplary system for creating mixtures;

FIG. 11 illustrates a block diagram of an exemplary machine-learning module;

FIG. 12 illustrates a diagram of an exemplary neural network;

FIG. 13 illustrates a block diagram of an exemplary node in a neural network;

FIG. 14 illustrates a flow diagram of an exemplary embodiment of a method of generating a mixture of a fluid and an active agent; and

FIG. 15 illustrates a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus for and methods of guided fault resolution for an operating system. The apparatus includes one or more sensors incorporated with an operating system, at least a processor, and a memory communicatively connected to the at least a processor, wherein the memory contains instructions configuring the at least a processor to receive operation data associated with operation of the operating system, wherein the operation data includes command-status data associated with the operating system, and sensor data from the one or more sensor for at least a control component of the operating system, identify at least a root-cause component and an associated fault state as a function of the operation data, generate a fault resolution protocol corresponding to the at least a root-cause component and the associated fault state, wherein the fault resolution protocol includes one or more resolution instructions, generate display data for a communication interface, wherein the display data causes the communication interface to present one or more of an identification of the at least a root-cause component, a fault indication corresponding to the associated fault state, and a first resolution instruction of the one or more resolution instructions, receive a completion input indicating completion of the first resolution instruction and updated operation data associated with the operation of the operating system, and update the display data to present a subsequent resolution instruction of the one or more resolution instructions as a function of the updated operation data.

In some embodiments, a fault resolution protocol may be implemented within communication interface of apparatus to reduce operator skill required for maintenance and fault remediation of operating system. Rather than merely presenting a generic fault indication corresponding to associated fault state, apparatus may receive operation data including command-status data and sensor data, identify at least a root-cause component and associated fault state as a function of operation data, and generate display data that causes communication interface to guide a user through a stepwise corrective process. In some embodiments, fault resolution protocol may include one or more resolution instructions, one or more prompts, one or more component identifications, one or more diagrams, and one or more verification steps presented through communication interface. For example, and without limitation, where at least a root-cause component includes a valve and associated fault state corresponds to a stuck fault condition, communication interface may present an identification of at least a root-cause component together with first resolution instruction identifying the valve to be inspected, one or more diagrams or visual cues showing a relevant location of the valve, and one or more subsequent resolution instructions to be performed as a function of updated operation data. In this way, technical troubleshooting knowledge that might otherwise reside in a separate service manual or with a trained technician may be integrated directly into apparatus and communication interface of operating system.

Exemplary embodiments illustrating aspects of the present disclosure are described below in the context of several specific examples.

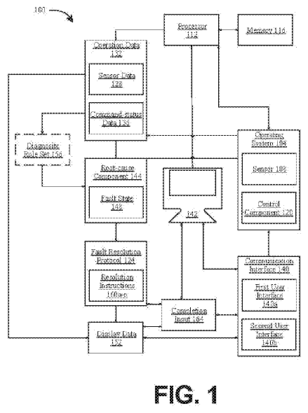

Referring now to FIG. 1, an exemplary embodiment of an apparatus 100 for guided fault resolution for an operating system 104 is illustrated. Apparatus 100 includes one or more sensors 108 incorporated with operating system 104, at least a processor 112, and a memory 116 communicatively connected to at least a processor 112. In some embodiments, apparatus 100 may be integrated physically within operating system 104. In some embodiments, apparatus 100 may be integrated communicatively connected to operating system 104. In some embodiments, apparatus 100 may be distributed across an embedded controller, a local maintenance interface, and a remote computing device. In some embodiments, apparatus 100 may be configured to support real-time monitoring, event-driven fault identification, historical comparison, guided troubleshooting, and iterative workflow adaptation based on live system response.

With continued reference to FIG. 1, operating system 104 may be configured to dispense, meter, mix, regulate, route, or otherwise control movement of one or more fluids, active agents, or mixtures thereof. For the purposes of this disclosure, “operating system” is a system a system configured to perform a function. In some cases, operating system 104 may include one or more interacting components configured to perform a function through mechanical, electrical, fluidic, or combined operation. In some cases, operating system 104 may include coordinated behavior of components such as control components, sensors, fluid paths, electrical circuits, actuators, and control logic that together produce an intended operational outcome. In some embodiments, operating system 104 may include a fluid dispensing system, a pumping system, a valve actuation system, an injection system, or a hybrid system integrating mechanical, electrical, and fluidic subsystems. In a non-limiting example, operating system 104 may be configured to transport, transfer, combine, regulate, or deliver one or more materials. In some embodiments, operating system 104 may include one or more storage tanks, one or more pumps, one or more valves, one or more injectors, one or more flow passages, one or more manifolds, one or more regulators, one or more sensors 108, and one or more control components 120. In some embodiments, operating system 104 may be configured to receive water and an active agent and output a mixture at one or more application points. For example, and without limitation, operating system 104 may be configured to deliver soap, wax, tire shine, presoak chemistry, or rinse chemistry in a car wash environment. In some embodiments, operating system 104 may include separate channels for different active agents, each channel having distinct pressure behavior, flow targets, priming states, maintenance requirements, and fault signatures. In some embodiments, an operating system 104 may be implemented within or applied to any industrial facility. As a non-limiting example, operating system 104 may be implemented within or applied to manufacturing environments, processing plants, service facilities, or automated equipment installations.

With continued reference to FIG. 1, operating system 104 may include a fluid dispensing system configured to dispense a mixture of fluid and an active agent. For the purposes of this disclosure, a “fluid dispensing system” is a dispensing system configured to receive, transport, transfer, meter, regulate, mix, or dispense one or more fluids, one or more active agents, or a combination thereof. For the purposes of this disclosure, a “mixture” is a material combination including two or more constituent materials. In some cases, mixture may include two or more constituent materials combined in a common flow path, common volume, or common output stream. In some cases, the mixture may include at least a fluid and an active agent combined such that the active agent is carried, diluted, suspended, entrained, dissolved, dispersed, or otherwise conveyed by the fluid. For the purposes of this disclosure, a “fluid” is a flowable material. In some cases, fluid may be capable of movement through a conduit, channel, manifold, injector, valve, or other fluidic structure. For the purposes of this disclosure, an “active agent” is a material configured to produce, contribute to, or enhance a functional treatment when dispensed alone or in combination with a fluid. In some embodiments, the fluid may include water, rinse liquid, solvent, carrier fluid, pressurized liquid, compressed gas, air, or another flowable medium suitable for combination with an active agent or for independent dispensing. In some embodiments, the active agent may include soap, wax, sealant, shine chemistry, pre-treatment chemistry, surfactant, foam additive, cleaning chemistry, or another function-providing material suitable for dispensing. In some embodiments, the mixture may be homogeneous or heterogeneous and may include dissolved materials, suspended materials, emulsified materials, foamed materials, aerated materials, or partially combined materials. In some embodiments, the fluid dispensing system may include one or more storage reservoirs, pumps, valves, injectors, manifolds, channels, regulators, fittings, sensors 108, controllers, or delivery outlets configured to cooperate to produce and deliver a desired flow, pressure, composition, or application state. In some embodiments, different channels of operating system 104 may have different expected pressure, flow, suction, depletion, and timing signatures, and at least a processor 112 may therefore apply channel-specific diagnostic logic and channel-specific fault resolution protocol 124 content. For example, and without limitation, a chemistry channel that relies on venturi suction may be diagnosed differently from a pressurized direct-injection channel.

With continued reference to FIG. 1, one or more sensors 108 are incorporated with operating system 104. For the purposes of this disclosure, “sensor” is a device configured to detect a physical, electrical, mechanical, chemical, or logical condition and to output information representative of that condition. One or more sensors 108 are configured to generate sensor data 128 for operating system 104. In some embodiments, one or more sensors 108 may include a pressure sensor, a flow sensor, a current sensor, a level sensor, a voltage sensor, a vacuum sensor, a temperature sensor, a motor feedback sensor, or a combination thereof. In some embodiments, one or more sensors 108 may be positioned upstream of a valve, downstream of a valve, adjacent an injector, within a tank, near a pump head, on a controller board, or along a fluid line component. In some embodiments, one or more sensors 108 may sample continuously. In some embodiments, one or more sensors 108 may sample at discrete intervals, upon actuation events, upon threshold crossings, or during verification windows following a troubleshooting step. For example, and without limitation, a pressure sensor may capture pressure decay after de-energization of a valve, a current sensor may capture coil current during actuation of a solenoid, and a level sensor may capture fluid depletion trends during repeated dosing cycles.

With continued reference to FIG. 1, sensor data 128 includes sensor data 128 generated by one or more sensors 108 for at least a control component 120 of operating system 104. For the purposes of this disclosure, “sensor data” is data generated by one or more sensors and representative of one or more measured, sensed, filtered, derived, or estimated conditions of an operating system or a component thereof. Sensor data 128 may include at least one of pressure data, flow data, current data, and level data. For the purposes of this disclosure, “pressure data” is data representative of force per unit area associated with a fluid, gas, mixture, or flow path within operating system 104. Pressure data may be representative of pressure at a static condition, during active flow, during transition between states, or during a fault event. In some embodiments, pressure data may include static pressure, dynamic pressure, upstream pressure, downstream pressure, differential pressure, suction pressure, backpressure, transient pressure, or pressure persistence during a commanded off state. In some embodiments, pressure data may be used to identify whether a valve is sealing properly, whether an injector is drawing as expected, whether a line is obstructed, or whether a downstream condition persists despite a commanded deactivation. For the purposes of this disclosure, “flow data” is data representative of movement of a fluid, gas, active agent, or mixture through a conduit. In some cases, the conduit may include channel, manifold, injector, valve, pump, or other fluidic structure of operating system 104. Flow data may be representative of a quantity of material moving per unit time, a direction of movement, a presence or absence of expected movement, or a change in movement over time. In some embodiments, flow data may include volumetric flow rate, mass flow rate, directional flow indication, transient flow during priming, reduced flow conditions, intermittent flow conditions, or absence of expected flow. In some embodiments, flow data may be used to determine whether a commanded dispensing event is actually occurring, whether a line is partially blocked, whether a pump is producing expected throughput, or whether an injector is receiving sufficient carrier fluid to draw an active agent. For the purposes of this disclosure, “current data” is data representative of electrical current associated with a powered component. In some cases, the powered component may include actuator, driver, circuit, or control path of operating system 104. Current data may be representative of energization state, load condition, electrical continuity, electrical fault behavior, or dynamic current response over time. In some embodiments, current data may include coil current, motor current, driver current, current draw during energization, startup current, steady-state current, pulsed current, below-threshold current, above-threshold current, or current traces over time. In some embodiments, current data may be used to determine whether a valve coil is energized, whether a motor is stalled, whether a control component is drawing abnormal power, or whether an electrical fault such as an open-circuit or short-circuit condition is present. For the purposes of this disclosure, “level data” is data representative of a level in quantity of a fluid, active agent, or mixture within a storage region of an operating system. In some cases, level data may include amount, height, volume, depletion state, refill state, or change in quantity of a fluid, active agent, or mixture within a storage region, reservoir, tank, or other contained portion of operating system 104. Level data may be representative of instantaneous level, level over time, depletion behavior, refill behavior, or expected-versus-observed consumption. In some embodiments, level data may include instantaneous tank level, rate of depletion, failure of expected depletion, refill-state data, depletion patterns over repeated cycles, or recovery patterns after replenishment. In some embodiments, level data may be used to determine whether an active agent is being drawn when a channel is active, whether a reservoir has become empty, whether a depletion pattern is inconsistent with expected dosing, or whether a leak, blockage, or priming failure is affecting delivery of an active agent. In some embodiments, pressure data may include static pressure, dynamic pressure, upstream pressure, downstream pressure, differential pressure, suction pressure, or pressure persistence during a commanded off state. In some embodiments, flow data may include volumetric flow rate, directional flow indication, transient flow during priming, reduced flow conditions, or absence of expected flow. In some embodiments, current data may include coil current, motor current, driver current, current draw during energization, below-threshold current, above-threshold current, or current traces over time. In some embodiments, level data may include instantaneous tank level, rate of depletion, failure of expected depletion, refill-state data, or depletion patterns over repeated cycles. For example, and without limitation, sensor data 128 may include a pressure trace indicating continued downstream pressure after a valve-off command, a current trace indicating no current through the valve coil, and a level profile indicating no active-agent draw despite a commanded dispensing event.

With continued reference to FIG. 1, apparatus 100 includes at least a processor 112. At least a processor 112 is configured to receive operation data 132 associated with operation of operating system 104. In some embodiments, at least a processor 112 may include a microcontroller, a central processing unit, a digital signal processor, a field-programmable gate array, an application-specific integrated circuit, or a combination thereof. In some embodiments, at least a processor 112 may be configured to execute rule-based fault logic, temporal filtering, state estimation, signal conditioning, threshold evaluation, mismatch detection, historical comparison, workflow generation, display generation, and communication control. In some embodiments, at least a processor 112 may be configured to process local telemetry and remote telemetry in parallel. In some embodiments, at least a processor 112 may be configured to distinguish transient conditions from persistent conditions by applying persistence windows, smoothing filters, hysteresis logic, or comparison to expected state transitions.

With continued reference to FIG. 1, apparatus 100 includes a memory 116 communicatively connected to at least a processor 112. Memory 116 contains instructions configuring at least a processor 112 to perform the guided fault resolution operations recited herein. In some embodiments, memory 116 may include volatile memory, non-volatile memory, flash memory, solid-state memory, removable media, or distributed storage. In some embodiments, memory 116 may store multiple diagnostic rule libraries for multiple dispensing channels. In some embodiments, memory 116 may store component-specific service procedures, image assets, maintenance diagrams, prior completion histories, verification thresholds, and user-role-specific interface content. In some embodiments, memory 116 may store machine learning models configured to support anomaly detection, classification, ranking of candidate faults, ranking of candidate instructions, or adaptation of a fault resolution protocol 124 based on live telemetry and prior outcomes.

With continued reference to FIG. 1, apparatus 100 may include circuitry such as without limitation a processor 112 communicatively connected to a memory 116; for instance, circuitry may include and/or be included in a computing device. Processor 112 may include any computing device as described in this disclosure, including without limitation a microcontroller, microprocessor, digital signal processor (DSP) and/or system on a chip (SoC) as described in this disclosure. Processor 112 may include, be included in, and/or communicate with a mobile device such as a mobile telephone or smartphone. Processor 112 may include a single computing device operating independently, or may include two or more computing device operating in concert, in parallel, sequentially or the like; two or more computing devices may be included together in a single computing device or in two or more computing devices. Processor 112 may interface or communicate with one or more additional devices as described below in further detail via a network interface device. Network interface device may be utilized for connecting processor 112 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 112 may include but is not limited to, for example, a computing device or cluster of computing devices in a first location and a second computing device or cluster of computing devices in a second location. Processor 112 may include one or more computing devices dedicated to data storage, security, distribution of traffic for load balancing, and the like. Processor 112 may distribute one or more computing tasks as described below across a plurality of computing devices of computing device, which may operate in parallel, in series, redundantly, or in any other manner used for distribution of tasks or memory between computing devices. Processor 112 may be implemented, as a non-limiting example, using a “shared nothing” architecture.

With continued reference to FIG. 1, memory 116 may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor 112 may access the information from primary memory.

With continued reference to FIG. 1, as used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, processor 112 may be designed and/or configured to perform any method, method step, or sequence of method steps in any embodiment described in this disclosure, in any order and with any degree of repetition. For instance, processor 112 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 112 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, at least a processor 112 is configured to receive operation data 132 associated with operation of operating system 104. For the purposes of this disclosure, “operation data” is data representative of operation of an operating system or a component thereof. In some cases, operation data 132 may include actual, expected, commanded, historical, inferred, or measured operation of an operating system 104 or a component thereof. Operation data 132 includes command-status data 136 associated with operating system 104 and sensor data 128 from one or more sensors 108 for at least a control component 120 of operating system 104. In some embodiments, operation data 132 may be gathered from controller registers, sensor buses, input/output modules, driver circuits, internal state machines, network messages, or local maintenance interactions. In some embodiments, operation data 132 may be synchronized into common time windows to support correlation between commanded events and observed physical response. In some embodiments, operation data 132 may be labeled with channel identity, component identity, product identity, time information, maintenance mode status, or environmental state. For example, and without limitation, operation data 132 may include a commanded valve-off event at a first time, downstream pressure readings over a following interval, coil current samples during the interval, and level readings from a corresponding active-agent reservoir.

With continued reference to FIG. 1, command-status data 136 is associated with operating system 104. For the purposes of this disclosure, “command-status data” is data representative of a commanded state of an operating system or a component thereof. Command-status data 136 may correspond to an intended operational state, a requested operational state, or an expected operational state for operating system 104 or for at least a control component 120 of operating system 104. In some embodiments, command-status data 136 may be used to define how operating system 104 is supposed to operate at a given time such that at least a processor 112 may compare that intended operation against actual sensed operation represented by sensor data 128. In some cases, command-status data 136 may include data corresponding to commands generated internally by operating system 104, commands issued by a controller, commands generated by a supervisory process, or commands entered by a user. In some embodiments, command-status data 136 may include data corresponding to a user command entered locally at operating system 104 or remotely through a remote user device 142 communicatively connected to operating system 104. In some embodiments, command-status data 136 may include data corresponding to a user interaction with second user interface 140b to input, modify, confirm, schedule, cancel, or override a command for operating system 104 or for at least a control component 120 of operating system 104. In some embodiments, such a user interaction may include selection of an activation control, a deactivation control, a priming control, a flushing control, a reset control, a maintenance-mode control, or another control associated with operation of operating system 104. In some cases, command-status data 136 may include command data associated with one or more operational states of operating system 104. In some embodiments, command-status data 136 may include a valve open command, a valve close command, a pump run command, a pump stop command, a priming command, a flush-mode command, a channel activation state, a duty-cycle value, a motor speed target, a pressure setpoint, or a maintenance override state. In some embodiments, command-status data 136 may include commands associated with a selected dispensing channel, a selected active agent, a selected fluid pathway, or a selected troubleshooting operation. In some embodiments, command-status data 136 may identify both a target component and a target operational state for that component, thereby permitting apparatus 100 to determine whether the target component responds as expected.

With continued reference to FIG. 1, for the purposes of this disclosure, “remote user device” is a computing device that is communicatively connected to operating system and is located external to the operating system. In some embodiments, remote user device may include a mobile device, a tablet, a laptop, a desktop workstation, or a server-based interface through which a user interacts with operating system 104. In some embodiments, remote user device may be configured to receive display data, transmit completion input, provide command inputs corresponding to command-status data, and present fault indication and one or more resolution instructions 160a-n via a second user interface. In some embodiments, remote user device may communicate with operating system 104 over a wired network, a wireless network, or a cloud-based communication infrastructure, thereby enabling remote monitoring, diagnostics, and guided fault resolution.

With continued reference to FIG. 1, command-status data 136 may be derived from one or more sources within or communicatively connected to operating system 104. In some embodiments, command-status data 136 may be derived from a controller output, a driver signal, a supervisory control message, a software state machine, a remote command message, a local user-interface event, or a remote user-interface event. In some embodiments, command-status data 136 may be represented as binary states, enumerated operating modes, numeric setpoints, pulse-width modulation values, temporal command sequences, or combinations thereof. In some embodiments, command-status data 136 may also include timing information associated with when a command was entered, transmitted, received, scheduled, or expected to take effect, such that at least a processor 112 may evaluate whether a corresponding sensor response occurs within an expected interval. In some cases, command-status data 136 may be used to establish an expected operational behavior of operating system 104 or of at least a control component 120 such that at least a processor 112 may compare the expected operational behavior against sensor data 128 to identify a mismatch, fault, degradation, or non-responsive state. In some embodiments, command-status data 136 may indicate that a component is expected to open, close, energize, de-energize, run, stop, prime, flush, or otherwise change state, while sensor data 128 may indicate whether the corresponding physical or electrical response actually occurred. In some embodiments, command-status data 136 may therefore function as a reference against which observed operating behavior is evaluated during identification of at least a root-cause component 144 and an associated fault state 148. In some cases, command-status data 136 may be particularly useful where a user interacts with second user interface 140b to initiate or modify operation of operating system 104. In some embodiments, a user may interact with second user interface 140b of a remote user device 142 to request activation of a dispensing channel, initiation of a priming sequence, stopping of a pump, closure of a valve, or entry into a maintenance mode, and command-status data 136 may include data representative of that user-originated command. In some embodiments, apparatus 100 may use that user-originated command as part of the operation data 132 used to determine whether operating system 104 responded properly. For example, and without limitation, command-status data 136 may indicate that a user has commanded a valve to close through second user interface 140b while sensor data 128 indicates continued downstream pressure, thereby supporting identification of a mismatch between commanded state and observed operating state.

With continued reference to FIG. 1, at least a control component 120 of operating system 104 may include at least one of a valve, a pump, an injector, and a fluid line component of operating system 104. For the purposes of this disclosure, “control component” is a component of an operating system subject to control, monitoring, diagnosis, or guided remediation. For the purposes of this disclosure, a “valve” is a component configured to control fluidic communication within operating system 104. A valve may be used to selectively control whether a fluid, an active agent, or a mixture is permitted to pass through a portion of operating system 104. For the purposes of this disclosure, a “pump” is a component configured to impart movement to a fluid, an active agent, or a mixture within operating system 104. A pump may be used to draw, push, meter, or otherwise transport material through operating system 104. For the purposes of this disclosure, an “injector” is a component configured to introduce one material into another material within operating system 104. An injector may be used to introduce an active agent into a fluid stream, a pressurized channel, or another flow path. For the purposes of this disclosure, a “fluid line component” is a component configured to define at least part of a flow path for a fluid, an active agent, or a mixture within operating system 104. A fluid line component may be used to maintain fluid communication between other components of operating system 104. In some embodiments, at least a control component 120 may include at least one of a valve, a pump, an injector, and a fluid line component of operating system 104. In some embodiments, a valve-type control component 120 may include a solenoid valve, a motorized ball valve, a proportional valve, a shutoff valve, a check valve, or a selector valve. In some embodiments, a pump-type control component 120 may include a peristaltic pump, a gear pump, a vane pump, a diaphragm pump, or another positive-displacement pump. In some embodiments, an injector-type control component 120 may include a venturi injector, an injection junction, a check-valve-assisted injector, or a pressure-driven mixing interface. In some embodiments, a fluid line component may include tubing, a hose, a fitting, a connector, a manifold passage, a designated channel, or a fluidic branch. For example, and without limitation, control component 120 may be a water solenoid whose energized state is expected to correlate with downstream pressure behavior, or a peristaltic pump whose commanded run state is expected to correlate with active-agent depletion and metered flow behavior.

With continued reference to FIG. 1, at least a processor 112 is configured to identify at least a root-cause component 144 and an associated fault state 148 as a function of operation data 132. For the purposes of this disclosure, “root-cause component” is a component identified as a likely source of an observed or inferred fault. For the purposes of this disclosure, “fault state” is a diagnosed or detected abnormal operating condition of a component or system. Identification of at least a root-cause component 144 and associated fault state 148 may include evaluating command-status data 136 together with sensor data 128 to determine whether a measured, sensed, or inferred operating behavior of operating system 104 deviates from an expected operating behavior. In some embodiments, at least a processor 112 may evaluate operation data 132 over one or more time windows, one or more command intervals, one or more dispensing cycles, or one or more maintenance verification intervals to determine whether a deviation is transient, persistent, recurring, or progressive. In some embodiments, at least a processor 112 may evaluate a single candidate control component 120 or may evaluate multiple candidate control components 120 in parallel and may identify at least a root-cause component 144 from among the multiple candidate control components 120 based on comparative likelihood, relative confidence, elimination of inconsistent candidates, or satisfaction of one or more diagnostic criteria.

With continued reference to FIG. 1, in some embodiments, root-cause component 144 may be identified from among multiple candidate control components 120 using elimination logic, rule-based ranking, probabilistic scoring, temporal correlation, or confidence aggregation. In some embodiments, elimination logic may include excluding a first candidate control component 120 where corresponding sensor data 128 indicates behavior consistent with commanded state while retaining a second candidate control component 120 where corresponding sensor data 128 indicates behavior inconsistent with commanded state. In some embodiments, rule-based ranking may include assigning relative weights to different fault indicators, such as persistent downstream pressure, below-threshold current, absent level depletion, or below-threshold flow, and ranking multiple candidate components based on the extent to which operation data 132 satisfies one or more rule conditions. In some embodiments, probabilistic scoring may include assigning a likelihood value, confidence score, fault probability, or ranked output to each candidate control component 120 and to each candidate fault state 148. In some embodiments, temporal correlation may include correlating the timing of a command event, such as a valve-close command or a pump-start command, with one or more subsequent changes or failures to change in pressure data, flow data, current data, or level data. In some embodiments, confidence aggregation may include combining outputs from multiple evaluators, such as a threshold-based evaluator, a historical-comparison evaluator, and a model-based evaluator, to generate a combined root-cause determination.

With continued reference to FIG. 1, in some embodiments, fault state 148 may include a stuck-open state, a stuck-closed state, a no-flow state, an over-pressure state, an under-pressure state, a blocked state, a leak state, an electrical fault state, an open-circuit state, a short-circuit state, a stall state, or a partial-performance state. In some embodiments, a stuck-open state may correspond to a condition in which a valve or comparable flow-control component continues to permit flow or pressure persistence despite command-status data 136 indicating an off, closed, or deactivated condition. In some embodiments, a stuck-closed state may correspond to a condition in which a valve or comparable flow-control component fails to permit expected flow despite command-status data 136 indicating an on, open, or activated condition. In some embodiments, a no-flow state may correspond to a condition in which flow data indicates no meaningful movement of fluid, active agent, or mixture despite a command requesting dispensing or pumping. In some embodiments, an over-pressure state may correspond to pressure data exceeding an expected range, threshold, or operating envelope for a selected channel or component. In some embodiments, an under-pressure state may correspond to pressure data failing to reach an expected value or failing to sustain pressure during a commanded dispensing interval. In some embodiments, a blocked state may correspond to a partial or complete obstruction of an injector, valve passage, line, fitting, or other fluidic region. In some embodiments, a leak state may correspond to unexpected depletion, pressure decay, or flow loss inconsistent with expected closed-system behavior. In some embodiments, an electrical fault state may correspond to abnormal electrical operation of a valve coil, motor, driver, or control path. In some embodiments, an open-circuit state may correspond to commanded energization with little or no current response. In some embodiments, a short-circuit state may correspond to commanded energization with excessive current or an otherwise abnormal current signature. In some embodiments, a stall state may correspond to a condition in which a pump or other driven component is commanded to operate but exhibits current behavior or output behavior consistent with a mechanical or fluidic impediment. In some embodiments, a partial-performance state may correspond to a condition in which a component operates, but not at an expected level of effectiveness, such as reduced flow, delayed response, weak suction, incomplete priming, or intermittent operation.

With continued reference to FIG. 1, identification of at least a root-cause component 144 and associated fault state 148 may use direct threshold logic. In some embodiments, direct threshold logic may include comparing pressure data, flow data, current data, level data, or combinations thereof against one or more predetermined thresholds, ranges, persistence intervals, rates of change, or expected response windows. In some embodiments, direct threshold logic may include evaluating whether pressure remains above a pressure threshold for longer than a pressure persistence interval after a valve-close command, whether flow remains below a minimum flow threshold during a pump-run interval, whether current remains below an energization threshold during a valve-on state, or whether level data fails to decrease by an expected amount during a commanded dispensing cycle. In some embodiments, thresholds may be absolute thresholds. In some embodiments, thresholds may be adaptive thresholds that vary as a function of channel type, active agent type, fluid type, ambient condition, prior calibration, or historical operation data 132. In some embodiments, direct threshold logic may additionally include hysteresis, debounce intervals, transient suppression intervals, or state-confirmation intervals to reduce false-positive identifications.

With continued reference to FIG. 1, identification of at least a root-cause component 144 and associated fault state 148 may use historical comparison. In some embodiments, at least a processor 112 may compare present operation data 132 to historical operation data 132 associated with prior healthy operation, prior degraded operation, prior maintenance outcomes, prior fault events, or prior channel-specific performance signatures. In some embodiments, historical comparison may include comparing a present pressure profile to a prior pressure profile for the same commanded event, comparing a present current trace to a baseline current trace for the same component, comparing a present depletion pattern to a historical depletion pattern for the same active agent channel, or comparing present response latency to a known historical response latency. In some embodiments, historical comparison may permit apparatus 100 to distinguish between a true abnormal condition and a normal variation associated with a particular site, chemistry, channel, or operating mode. For example, and without limitation, where a first dispensing channel normally exhibits a relatively slow pressure decay after deactivation and a second dispensing channel normally exhibits a relatively fast pressure decay, at least a processor 112 may compare present operation data 132 against channel-specific historical operation data 132 to avoid misclassifying the first dispensing channel as faulty. For example, and without limitation, at least a processor 112 may identify a likely leak state where level data indicates materially faster depletion than a corresponding historical depletion profile during substantially similar dispensing commands.

With continued reference to FIG. 1, identification of at least a root-cause component 144 and associated fault state 148 may use one or more machine learning models in combination with deterministic logic. In some embodiments, a first model may be configured to receive time-series operation data 132 and output one or more anomaly scores, deviation indicators, or feature embeddings representative of whether present system behavior is abnormal relative to prior healthy behavior. In some embodiments, a second model may be configured to receive the output of the first model together with pressure data, flow data, current data, level data, command-status data 136, or derived features therefrom and to output one or more probabilities associated with candidate root-cause components 144 or candidate fault states 148. In some embodiments, deterministic logic may be used as a gating layer before invocation of a model, as a verification layer after invocation of a model, or as a parallel evaluator whose output is combined with one or more model outputs. In some embodiments, deterministic logic may ensure that a model-supported diagnosis is consistent with physical operating constraints, safety limits, or required causal relationships between command-status data 136 and sensor data 128. In some embodiments, this combined architecture may permit apparatus 100 to benefit from both explainable rules and adaptive learned behavior.

With continued reference to FIG. 1, in some embodiments, one or more machine learning models may include a time-series anomaly detection model, a component classification model, a fault-state classification model, a ranking model, or a combination thereof. In some embodiments, a time-series anomaly detection model may include an autoencoder, temporal convolutional network, recurrent neural network, long short-term memory network, gated recurrent unit network, transformer-based model, isolation forest, one-class support vector machine, or another model configured to evaluate whether a present sequence of operation data 132 deviates from expected operation. In some embodiments, a component classification model may include a gradient-boosted tree model, random forest model, logistic regression model, neural network model, support vector machine model, or ensemble thereof configured to identify which control component 120 is most likely to be the source of the fault. In some embodiments, a fault-state classification model may be configured to distinguish between different types of abnormal states for a selected component, such as distinguishing a stuck-open state from a leak state or distinguishing a blocked state from an under-pressure state. In some embodiments, a ranking model may be configured to rank multiple candidate diagnoses or to rank one or more fault resolution protocol 124 options for presentation after a diagnosis is made.

With continued reference to FIG. 1, in some embodiments, training data for one or more machine learning models may include structured and unstructured datasets corresponding to operation of operating system across multiple temporal intervals and operating conditions. Such training data may include historical command-status data, historical sensor data, maintenance logs, confirmed fault reports, component replacement records, technician annotations, verification outcomes, and system-generated diagnostic traces, or combinations thereof. In some embodiments, training data may be aggregated across multiple deployments of operating system to capture variability in environmental conditions, component wear states, installation configurations, and usage patterns.

With continued reference to FIG. 1, in some embodiments, sources of the training data may include onboard data logging subsystems of operating system, remote telemetry servers, cloud-based monitoring platforms, service databases, and engineering validation repositories. In some embodiments, training data may be sourced from a single installation site, a plurality of geographically distributed sites, controlled laboratory testing environments, simulated fault injection sessions, digital twin simulations, or engineering validation runs. In some embodiments, fleet-level telemetry ingestion pipelines may continuously stream operation data and associated outcomes into a centralized training corpus, thereby enabling periodic retraining or continuous learning workflows.

With continued reference to FIG. 1, in some embodiments, training labels associated with the training data may include annotations identifying root-cause component, fault state, fault severity level, confidence level, resolution outcome, time-to-resolution metrics, and classifications indicating whether a detected anomaly corresponds to a true fault condition or a benign transient event. In some embodiments, labels may be generated through technician-confirmed diagnoses, automated verification routines, post-resolution validation checks, or consensus labeling across multiple diagnostic systems. In some embodiments, semi-supervised or weakly supervised labeling approaches may be used, wherein partial labels are inferred from resolution success signals or system recovery behavior.

With continued reference to FIG. 1, in some embodiments, the training data may include multiple labeled cohorts corresponding to different failure modes and operational contexts. For example, and without limitation, a first cohort may include examples in which a valve-type control component is confirmed to be in a stuck-open fault state, a second cohort may include examples in which a pump-type control component is confirmed to be in a stall or no-flow fault state, and a third cohort may include examples in which a low-pressure condition is attributed to depletion of an active agent rather than a mechanical or electrical failure. In some embodiments, such cohort-based organization of training data may improve model discrimination between similar observable signatures arising from distinct underlying causes.

With continued reference to FIG. 1, in some embodiments, derived training features may be computed from raw training data to enhance model performance. Such derived features may include pressure decay rate following a valve closure command, pressure persistence interval during an expected off state, flow onset delay relative to a pump activation command, current peak value during actuation, current steady-state value during sustained operation, depletion slope of an active-agent reservoir over time, and actuation-to-response latency between command issuance and observed sensor response. In some embodiments, feature extraction pipelines may include signal filtering, smoothing, normalization, time-window segmentation, frequency-domain transformation, or statistical aggregation to generate features suitable for input into one or more machine learning models.

With continued reference to FIG. 1, in some embodiments, the one or more machine learning models trained using the foregoing training data may include classification models configured to predict root-cause component and fault state, anomaly detection models configured to identify deviations from normal operation, sequence models configured to analyze temporal patterns in operation data, and ranking models configured to prioritize candidate faults or resolution instructions. In some embodiments, such models may be trained using supervised learning techniques, unsupervised learning techniques, or hybrid approaches, and may be periodically updated as additional training data is collected from operating system deployments.

With continued reference to FIG. 1, in some embodiments, at least a processor 112 may identify at least a root-cause component 144 and associated fault state 148 using a staged diagnostic pipeline. In some embodiments, a first stage may pre-process operation data 132 by filtering noise, aligning timestamps, normalizing values, or partitioning data into event windows. In some embodiments, a second stage may apply deterministic logic to eliminate non-candidate components and to identify one or more candidate fault families. In some embodiments, a third stage may apply one or more machine learning models to score remaining candidate components and candidate fault states. In some embodiments, a fourth stage may apply rule-based validation to confirm that a highest-ranked candidate diagnosis satisfies one or more minimum consistency requirements. In some embodiments, a fifth stage may assign a final confidence value or may trigger generation of a fault resolution protocol 124 that is appropriate for the identified root-cause component 144 and associated fault state 148. For example, and without limitation, a staged pipeline may first determine that an anomaly is localized to a particular dispensing channel, then determine that a valve-related rule family is implicated, then score multiple valve fault states using a classifier, and then confirm a stuck-open fault state using persistence of downstream pressure and below-threshold coil current.

With continued reference to FIG. 1, in some embodiments, identification of at least a root-cause component 144 and associated fault state 148 may be refined using contextual information. In some embodiments, contextual information may include a selected operating mode, a maintenance mode state, an environmental condition, a channel identity, an active agent type, a recent repair history, or a time since last service event. In some embodiments, contextual information may be used to adjust thresholds, select a subset of candidate diagnostic rules, select a subset of candidate machine learning models, or alter a confidence aggregation process. For example, and without limitation, an injector fault on a channel associated with a high-viscosity active agent may be evaluated differently from an injector fault on a channel associated with a low-viscosity active agent. For example, and without limitation, a pressure anomaly observed during a commanded priming cycle may be interpreted differently from a pressure anomaly observed during a normal dispensing cycle. In some embodiments, contextual refinement may improve both diagnostic specificity and robustness across varying installation conditions.

With continued reference to FIG. 1, in some embodiments, at least a processor 112 may be configured to output not only the identified root-cause component 144 and associated fault state 148, but also one or more supporting explanations, contributing data features, or diagnostic confidence indicators. In some embodiments, apparatus 100 may retain which rule or rules were satisfied, which sensor relationships were inconsistent with commanded operation, which historical comparisons were determinative, or which model outputs contributed to the final diagnosis. In some embodiments, such supporting information may be used in generation of display data 152, generation of fault resolution protocol 124, logging, later audit review, technician escalation, or further model training. For example, and without limitation, apparatus 100 may identify a valve as root-cause component 144, identify a stuck-open state as associated fault state 148, and retain that the diagnosis was supported by a valve-close command, persistent downstream pressure, and below-threshold valve current over a defined verification interval. In some embodiments, apparatus 100 may resolve a technical problem associated with inaccurate fault isolation, excessive maintenance downtime, repeated unsuccessful troubleshooting actions, or inability of a site operator to distinguish between multiple candidate component failures that produce similar observable symptoms. In some embodiments, apparatus 100 may resolve this technical problem using a technical solution in which command-status data 136, sensor data 128, historical operation data 132, diagnostic rule logic, and optionally one or more model outputs are jointly evaluated to identify at least a root-cause component 144 and associated fault state 148 with greater specificity than threshold-only or code-only fault reporting. In some embodiments, this technical solution may operate by correlating an expected operational state of operating system 104 against measured physical or electrical behavior of one or more control components 120, filtering or ranking multiple candidate diagnoses, and preserving supporting diagnostic information for use in generation of display data 152 and fault resolution protocol 124. In some embodiments, by doing so, apparatus 100 may improve technical operation of operating system 104 by reducing false-positive fault classifications, reducing repeated actuation of non-faulted components, reducing time required to localize a failed component, reducing unnecessary replacement of properly functioning parts, and improving execution of component-specific corrective actions based on technically supported fault identification.

With continued reference to FIG. 1, identifying at least a root-cause component 144 and associated fault state 148 may include selecting a diagnostic rule set 156 that defines a plurality of fault conditions as logical relationships between command-status data 136 and sensor data 128. For the purposes of this disclosure, “diagnostic rule set” is a set of logical rules configured to evaluate operation data and associate that evaluation with a diagnosed component or fault state. In some embodiments, diagnostic rule set 156 may include one or more rules, condition groups, comparison relationships, threshold relationships, state-transition relationships, temporal relationships, persistence relationships, exclusion relationships, or combinations thereof that are usable to determine whether operation data 132 is consistent with expected operation or with one or more fault conditions. In some embodiments, diagnostic rule set 156 may be configured to define a plurality of fault conditions as logical relationships between command-status data 136 and sensor data 128 such that a commanded condition for at least a control component 120 may be compared against a measured, sensed, derived, or inferred operational response of at least a control component 120. In some embodiments, diagnostic rule set 156 may be stored as one or more decision trees, threshold tables, rule matrices, executable logic blocks, state machines, lookup structures, conditional expressions, firmware-updatable condition packages, or combinations thereof. In some embodiments, diagnostic rule set 156 may include channel-specific logic, component-specific logic, startup suppression logic, transient suppression logic, environmental compensation logic, maintenance-mode logic, chemistry-specific logic, timing-window logic, or verification logic. For example, and without limitation, a rule may define a candidate stuck-open valve condition when command-status data 136 indicates a valve-off state, pressure data remains above a threshold for a persistence period, and current data indicates a below-threshold coil current. For example, and without limitation, another rule may define a pump-stall condition when command-status data 136 indicates a commanded pump-on state, current data exceeds a threshold, and flow data remains below a threshold. For example, and without limitation, another rule may define a candidate depletion-related fault condition when command-status data 136 indicates an active dispensing interval, level data indicates a below-threshold remaining quantity of active agent, and flow data fails to reach an expected flow condition for that interval.

With continued reference to FIG. 1, identifying at least a root-cause component 144 and associated fault state 148 may include identifying at least a root-cause component 144 and associated fault state 148 as a function of operation data 132 and diagnostic rule set 156. In some embodiments, at least a processor 112 may be configured to evaluate multiple candidate fault conditions in parallel, assign confidence values to multiple candidate root-cause components 144, and select a most-likely diagnosis. In some embodiments, at least a processor 112 may be configured to evaluate rule satisfaction across multiple time windows, multiple command events, multiple dispensing cycles, or multiple channels of operating system 104. In some embodiments, at least a processor 112 may be configured to use persistence criteria so that short-lived transients do not trigger an incorrect diagnosis. In some embodiments, at least a processor 112 may be configured to apply tolerance bands, hysteresis margins, channel-specific calibration values, component-specific calibration values, or environmental correction values before determining that a logical relationship satisfies a fault condition. In some embodiments, a first rule may narrow the analysis to a valve family, a second rule may distinguish stuck-open from stuck-closed behavior, and a third rule may validate the inference against historical operation data 132. In some embodiments, a first rule may identify a candidate hydraulic or fluidic abnormality, a second rule may determine whether the abnormality is likely attributable to a pump, injector, valve, or fluid line component, and a third rule may determine whether the most likely associated fault state 148 corresponds to blockage, leak, under-performance, or another diagnosed condition. In some embodiments, rule outputs may be combined with outputs from a learned model to improve ranking of multiple candidates. In some embodiments, identifying at least a root-cause component 144 and associated fault state 148 may include generating a ranked list of candidate diagnoses, selecting a highest-ranked diagnosis, and storing lower-ranked diagnoses for later validation if updated operation data 132 indicates that the highest-ranked diagnosis was incomplete or incorrect.

With continued reference to FIG. 1, identifying at least a root-cause component 144 and associated fault state 148 may include determining, from command-status data 136, a commanded state of at least a control component 120. For the purposes of this disclosure, “commanded state” is a state represented by a control signal of a component. In some embodiments, commanded state may include open, closed, on, off, partially open, running, stopped, priming, flushing, maintenance mode, target speed, target duty cycle, target pressure state, target flow state, target timing state, or another expected operational state for at least a control component 120. In some embodiments, commanded state may be derived directly from a controller output signal or indirectly from a control sequence context. In some embodiments, commanded state may include a time-bounded state, such as a state expected only during a predefined interval following a trigger. In some embodiments, commanded state may include a user-originated state associated with a user interaction through first user interface 140a or second user interface 140b. In some embodiments, commanded state may include a scheduled state, a queued state, an override state, an emergency state, or a test state associated with a maintenance, calibration, or troubleshooting operation. In some embodiments, determining commanded state may include parsing one or more control records, reading one or more output registers, decoding one or more driver signals, reading one or more timing parameters, or correlating one or more command events to a target control component 120. For example, and without limitation, commanded state may indicate that a dispensing channel is active and that a pump is expected to rotate at a selected speed while a valve is expected to remain in an open state. For example, and without limitation, commanded state may indicate that a valve is expected to close within a defined interval after completion of a dispensing cycle, thereby establishing a basis for evaluating whether downstream pressure or flow should decay within an expected response period.

With continued reference to FIG. 1, identifying at least a root-cause component 144 and associated fault state 148 may include determining, from sensor data 128, an observed operating state of at least a control component 120. For the purposes of this disclosure, “observed operating state” is a state represented by inferred or detected physical or electrical behavior of a component. In some embodiments, observed operating state may include measured fluid flow, measured pressure response, measured current draw, measured level depletion, measured suction behavior, derived actuation response, inferred position behavior, inferred sealing behavior, or inferred material-transfer behavior. In some embodiments, observed operating state may be derived from one sensor alone or from multiple sensors in combination. In some embodiments, observed operating state may be derived using raw sensor outputs, filtered sensor outputs, normalized sensor outputs, time-windowed sensor outputs, or features derived from sensor outputs, such as slope, decay rate, persistence duration, actuation-to-response latency, peak value, minimum value, moving average, or variance. For example, and without limitation, observed operating state of a valve may be inferred from downstream pressure persistence and flow behavior. For example, and without limitation, observed operating state of a pump may be inferred from motor current, vibration response, level depletion, and measured output flow. In some embodiments, observed operating state of an injector may be inferred from suction pressure, upstream flow availability, downstream mixture behavior, and active-agent depletion. In some embodiments, observed operating state of a fluid line component may be inferred from pressure drop across different regions, reduction in expected downstream flow, repeated priming failures, or unexpected pressure loss during a commanded active interval. In some embodiments, observed operating state may be filtered to remove noise, transient spikes, or startup artifacts before being compared to commanded state.

With continued reference to FIG. 1, identifying at least a root-cause component 144 and associated fault state 148 may include identifying at least a root-cause component 144 and associated fault state 148 in response to a mismatch between commanded state and observed operating state. In some embodiments, a mismatch may include a valve commanded off while downstream pressure remains elevated, a pump commanded on while no level depletion occurs, an injector expected to draw chemistry while suction remains absent, or a fluid line expected to pass flow while downstream flow remains below a threshold. In some embodiments, mismatch detection may include a time-lag allowance so that normal response delay does not generate a false fault. In some embodiments, mismatch detection may include multi-sensor corroboration, such as requiring both abnormal pressure and abnormal current before identifying a valve as root-cause component 144. In some embodiments, mismatch detection may include persistence analysis, drift analysis, and recurrence analysis. In some embodiments, mismatch detection may include evaluating whether a measured state fails to reach an expected state, remains in a prior state longer than expected, oscillates between states, or transitions in a manner inconsistent with a commanded sequence. In some embodiments, mismatch detection may include distinguishing between a complete mismatch and a partial mismatch such that at least a processor 112 may determine whether associated fault state 148 corresponds to a complete failure, a partial-performance state, or a progressively degrading condition. In some embodiments, mismatch detection may additionally include comparing a present mismatch pattern against one or more known mismatch patterns associated with prior confirmed faults. For example, and without limitation, a persistent mismatch between a commanded off state and continued downstream pressure may be classified as a stuck-open fault state 148 associated with a valve root-cause component 144. For example, and without limitation, a mismatch between a commanded pump-on state and a continued absence of expected level depletion together with below-threshold flow may support identification of a pump-related, line-related, or injector-related root-cause component 144, with further rule analysis distinguishing among those candidates.

With continued reference to FIG. 1, identifying at least a root-cause component 144 and associated fault state 148 may include retrieving historical operation data 132 associated with prior operation of operating system 104 as a function of operation data 132. For the purposes of this disclosure, “historical operation data” is operation data stored or derived from prior operation of an operating system. In some embodiments, historical operation data 132 may include prior command sequences, prior pressure traces, prior flow traces, prior current signatures, prior level-consumption profiles, prior fault indications, prior operator interactions, prior maintenance completions, prior post-repair verification results, prior calibration values, prior environmental conditions, or prior channel-specific performance baselines. In some embodiments, retrieval of historical operation data 132 may be triggered when operation data 132 deviates from a normal pattern, satisfies a candidate fault criterion, indicates an ambiguous condition, or suggests a recurring issue. In some embodiments, historical operation data 132 may be local to one site, aggregated across multiple sites, limited to a specific channel, limited to a specific component family, or segmented by environmental condition, product type, maintenance state, user role, or service history. In some embodiments, retrieving historical operation data 132 may include selecting a comparison dataset based on channel identity, active agent type, fluid type, component type, commanded state, operating mode, or current environmental or maintenance conditions. In some embodiments, retrieving historical operation data 132 may include selecting a first subset of prior healthy-operation records and a second subset of prior degraded-operation records such that current operation data 132 may be compared against both subsets to improve diagnostic specificity. For example, and without limitation, historical operation data 132 for a first chemistry channel may be maintained separately from historical operation data 132 for a second chemistry channel where the two channels exhibit different normal suction, depletion, or pressure-decay behavior. In some case, processor 112 may retrieve historical operation data 132 or any historical data from a database. In some embodiments, processor 112 may be communicatively connected with database. For example, and without limitation, in some cases, database may be local to processor 112. In another example, and without limitation, database may be remote to processor 112 and communicative with processor 112 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 112 connects directly, dynamically, and non-hierarchically to as many other computing devices as possible. A “network topology” as used in this disclosure is an arrangement of elements of a communication network.

With continued reference to FIG. 1, in some embodiments, database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, identifying at least a root-cause component 144 and associated fault state 148 may include identifying at least a root-cause component 144 and associated fault state 148 by comparing operation data 132 to historical operation data 132. In some embodiments, comparison may be made to a healthy baseline, a degraded baseline, a recently serviced baseline, a site-specific baseline, or a fleet-wide baseline. In some embodiments, comparison may include statistical comparison, threshold deviation analysis, sequence alignment, nearest-neighbor comparison, learned embedding comparison, similarity scoring, rate-of-change comparison, event-latency comparison, or profile-shape comparison. In some embodiments, at least a processor 112 may be configured to compare median pressure during off-command intervals, current draw during commanded energization, depletion per dispensing cycle, and actuation-to-response latency against historical operation data 132. In some embodiments, at least a processor 112 may be configured to determine whether present operation data 132 is closer to a historically healthy pattern or to a historically faulty pattern, and to use that determination to refine a diagnosis generated from diagnostic rule set 156. In some embodiments, historical comparison may permit at least a processor 112 to distinguish between a component fault and a normal but atypical operating characteristic for a given installation. For example, and without limitation, if a particular channel historically exhibits a rapid pressure decay after valve de-energization but operation data 132 indicates persistent pressure across repeated events, at least a processor 112 may identify a likely valve-related fault state 148. For example, and without limitation, if present level depletion per dispensing cycle is materially lower than historical level depletion for substantially similar command intervals while flow and suction indicators are also reduced, at least a processor 112 may identify a likely injector-related or pump-related abnormality. In some embodiments, historical comparison may refine or confirm an initial rule-based diagnosis. In some embodiments, historical comparison may also resolve a technical problem associated with false or ambiguous fault attribution in systems having channel-to-channel variability, site-to-site variability, or changing operating characteristics over time. In some embodiments, this technical problem may be addressed by a technical solution in which current operation data 132 is not evaluated in isolation but is instead compared to historical operation data 132 selected to correspond to a relevant channel, component family, operating mode, or maintenance context. In some embodiments, by doing so, at least a processor 112 may improve technical fault-isolation accuracy, reduce unnecessary component replacement, reduce repeated unsuccessful troubleshooting actions, and improve selection of a fault resolution protocol 124 that is better matched to the actual behavior of operating system 104.

With continued reference to FIG. 1, at least a processor 112 is configured to generate a fault resolution protocol 124 corresponding to at least a root-cause component 144 and associated fault state 148. For the purposes of this disclosure, “fault resolution protocol” is a set of actions configured to guide a user through remediation or resolution of a fault. Fault resolution protocol 124 includes one or more resolution instructions 160a-n. In some embodiments, fault resolution protocol 124 may be selected from a library of stored protocols, wherein each stored protocol may be associated with a respective component family, fault family, channel type, operating mode, maintenance state, or verification condition. In some embodiments, fault resolution protocol 124 may be assembled dynamically from a component-specific segment, a fault-state-specific segment, a safety segment, and a verification segment. In some embodiments, dynamic assembly of fault resolution protocol 124 may include selecting a first protocol segment associated with at least a root-cause component 144, selecting a second protocol segment associated with associated fault state 148, selecting a third protocol segment associated with a current operating context of operating system 104, and combining the selected segments into an ordered or condition-dependent sequence of one or more resolution instructions 160a-n. In some embodiments, fault resolution protocol 124 may be adapted based on user role, component accessibility, channel type, prior completions, updated operation data 132, prior maintenance history, tool availability, or safety permissions. In some embodiments, at least a processor 112 may generate fault resolution protocol 124 such that lower-risk and lower-complexity actions are presented before higher-risk or more invasive actions. In some embodiments, fault resolution protocol 124 may include one or more verification checkpoints at which updated operation data 132 is evaluated before additional instructions are presented. In some embodiments, fault resolution protocol 124 may include one or more conditional branches such that a first branch is used when updated operation data 132 indicates persistence of associated fault state 148 and a second branch is used when updated operation data 132 indicates partial correction, incomplete execution, or emergence of a secondary abnormal condition. In some embodiments, fault resolution protocol 124 may further include one or more component-location indicators, one or more expected telemetry values, one or more caution conditions, one or more operator action triggers, or one or more escalation paths to a technician or remote support process. For example, and without limitation, a protocol for a suspected injector blockage may begin with a visual inspection and priming verification, then proceed to removal and cleaning steps, and then proceed to post-cleaning suction validation. For example, and without limitation, a protocol for a suspected valve-related fault may begin with electrical-connection verification and a commanded cycle test, may continue to pressure persistence confirmation and mechanical inspection, and may then proceed to replacement planning if post-verification pressure data remains inconsistent with the commanded state. For example, and without limitation, a protocol for a suspected pump under-performance condition may begin with confirmation of fluid availability and tubing integrity, may proceed to motor-current verification and flow confirmation, and may then branch between a priming-oriented instruction path and a replacement-oriented instruction path as a function of updated operation data 132.

With continued reference to FIG. 1, one or more resolution instructions 160a-n are included in fault resolution protocol 124. For the purposes of this disclosure, “resolution instruction” is an action item presented for purposes of resolving a fault. In some embodiments, one or more resolution instructions 160a-n may include a component inspection instruction, a connection verification instruction, a priming instruction, a cleaning instruction, a reset instruction, a replacement instruction, a tubing check instruction, a manual actuation instruction, a pressure confirmation instruction, a current confirmation instruction, or a follow-up confirmation instruction. In some embodiments, one or more resolution instructions 160a-n may further include a line-isolation instruction, a purge instruction, a calibration instruction, a parameter-confirmation instruction, a fluid-availability confirmation instruction, a sensor-verification instruction, a component-reseating instruction, a fastener-check instruction, a disassembly instruction, a reassembly instruction, or a post-repair validation instruction. In some embodiments, one or more resolution instructions 160a-n may be textual. In some embodiments, one or more resolution instructions 160a-n may include graphical overlays, diagrams, photographs, animations, expected sensor outcomes, warnings, and tool callouts. In some embodiments, one or more resolution instructions 160a-n may include live telemetry windows, expected threshold ranges, timers, progress indicators, highlighted component regions, channel identifiers, or action triggers requesting completion input 164. In some embodiments, one or more resolution instructions 160a-n may be arranged sequentially. In some embodiments, one or more resolution instructions 160a-n may be arranged in a branching decision path. In some embodiments, each resolution instruction 160a-n may be associated with a respective expected verification outcome such that updated operation data 132 may be evaluated after execution of the instruction to determine whether a subsequent instruction is to be presented, whether a modified instruction is to be generated, or whether an escalation path is to be invoked. In some embodiments, one or more resolution instructions 160a-n may be selected to correspond to specific physical access requirements, safety requirements, or operator-skill requirements. In some embodiments, one or more resolution instructions 160a-n may be associated with one or more telemetry conditions expected before performance of the instruction, during performance of the instruction, or after performance of the instruction. For example, and without limitation, a pressure confirmation instruction may direct a user to observe whether downstream pressure decays below a threshold within a defined interval after a commanded valve-close event. For example, and without limitation, a current confirmation instruction may direct a user to observe whether a motor current enters an expected range during a commanded pump run state. For example, and without limitation, a priming instruction may direct a user to initiate a priming cycle and then confirm that level data and flow data reflect expected material movement for the selected channel.

With continued reference to FIG. 1, first resolution instruction 160a is included in one or more resolution instructions 160a-n. For the purposes of this disclosure, “first resolution instruction” is an initial resolution instruction in a fault resolution protocol. First resolution instruction 160a is configured to be presented before a subsequent resolution instruction 160b. In some embodiments, first resolution instruction 160a may be selected to minimize downtime, minimize risk, and reduce operator skill burden. In some embodiments, first resolution instruction 160a may be selected to maximize diagnostic value while minimizing disruption to operating system 104, such that the earliest presented instruction is likely to either resolve a common fault cause or generate updated operation data 132 that materially narrows the remaining candidate diagnoses. In some embodiments, first resolution instruction 160a may direct an operator to inspect a valve body, confirm a wiring connection, verify fluid presence, inspect tubing for a pinch, run a priming routine, or observe a displayed pressure value during a test command. In some embodiments, first resolution instruction 160a may be selected based on whether at least a root-cause component 144 is physically accessible without disassembly, whether the suspected fault is safely verifiable during system operation, whether the instruction requires tools, or whether the instruction may be completed by a site operator rather than a technician. In some embodiments, first resolution instruction 160a may include a prerequisite condition, such as placing operating system 104 into a maintenance mode, isolating a selected channel, or confirming that pressure has decayed to a safe state before physical inspection. In some embodiments, first resolution instruction 160a may be configured to generate a defined verification result, such as a change in pressure data, flow data, current data, or level data, so that updated operation data 132 may be used to determine whether associated fault state 148 persists. In some embodiments, first resolution instruction 160a may be accompanied by a highlighted component map, one or more expected telemetry ranges, one or more safety warnings, or one or more visual indicators showing where the operator is to inspect or actuate. For example, and without limitation, first resolution instruction 160a for a suspected stuck-open valve may direct the operator to inspect whether the valve is physically obstructed, to confirm electrical connection integrity, and to observe whether pressure persists after a commanded off cycle. For example, and without limitation, first resolution instruction 160a for a suspected injector blockage may direct the operator to confirm that upstream flow is available, to verify that a priming sequence completes, and to inspect whether an injector passage or check-valve region is obstructed. For example, and without limitation, first resolution instruction 160a for a suspected pump-related under-performance condition may direct the operator to verify fluid presence in a corresponding reservoir, inspect tubing continuity, and observe whether a commanded pump activation produces the expected current and flow response.

With continued reference to FIG. 1, subsequent resolution instruction 160b is included in one or more resolution instructions 160a-n. For the purposes of this disclosure, “subsequent resolution instruction” is a resolution instruction following a prior resolution instruction in a fault resolution protocol. Subsequent resolution instruction 160b is configured to be presented as a function of updated operation data 132. In some embodiments, subsequent resolution instruction 160b may be predetermined as the next step in a stored sequence. In some embodiments, subsequent resolution instruction 160b may be selected conditionally based on whether updated operation data 132 indicates persistence of a fault, partial improvement, or emergence of a different inferred issue. In some embodiments, subsequent resolution instruction 160b may escalate the interaction from inspection to disassembly, from local verification to replacement planning, or from operator action to remote technician involvement. In some embodiments, subsequent resolution instruction 160b may be selected after evaluation of one or more post-step verification conditions, such as whether pressure decays within an expected interval, whether current enters a target range, whether flow rises above a threshold, whether level depletion begins or returns to an expected rate, or whether a prior mismatch between commanded state and observed operating state has been reduced or eliminated. In some embodiments, subsequent resolution instruction 160b may be different for a persistent fault state 148 than for a partially corrected fault state 148. In some embodiments, subsequent resolution instruction 160b may preserve continuity with first resolution instruction 160a by referencing a previously inspected component, a previously confirmed measurement, or a previously attempted corrective action. In some embodiments, subsequent resolution instruction 160b may be chosen to isolate among remaining candidate root-cause components 144 after first resolution instruction 160a has excluded or weakened one or more initial candidates. In some embodiments, subsequent resolution instruction 160b may request a more invasive action only after updated operation data 132 indicates that a less invasive action has failed to produce the expected operational change. In some embodiments, subsequent resolution instruction 160b may include one or more modified telemetry expectations, one or more conditional warnings, or one or more action triggers requesting additional completion input 164. For example, and without limitation, where first resolution instruction 160a involved verification of a wiring connection and updated operation data 132 still indicates below-threshold coil current, subsequent resolution instruction 160b may direct inspection of an upstream driver path, conductor continuity, or replacement of the affected electromechanical component. For example, and without limitation, where first resolution instruction 160a involved priming of a selected channel and updated operation data 132 indicates improved but still below-threshold flow, subsequent resolution instruction 160b may direct inspection and cleaning of an injector passage or replacement of a partially obstructed check-valve assembly. For example, and without limitation, where first resolution instruction 160a involved observation of pressure decay after a commanded valve-close event and updated operation data 132 indicates continued pressure persistence across repeated verification cycles, subsequent resolution instruction 160b may direct removal, disassembly, or replacement of the identified valve-related root-cause component 144.

With continued reference to FIG. 1, at least a processor 112 is configured to generate display data 152 for a communication interface 140. For the purposes of this disclosure, “display data” is data that controls presentation of content at a communication interface. For the purposes of this disclosure, “communication interface” is a hardware, software, or combined interface configured to present information to a user, and/or receive information from a user. Display data 152 is configured to cause communication interface 140 to present one or more of an identification of at least a root-cause component 144, a fault indication corresponding to associated fault state 148, and first resolution instruction 160a of one or more resolution instructions 160a-n. In some embodiments, display data 152 may include text, icons, values, status colors, component maps, procedural cards, diagrams, progress indicators, confirmation controls, and action triggers. In some embodiments, display data 152 may further include one or more layout definitions, one or more screen-state definitions, one or more data-binding definitions, one or more alert-priority indicators, one or more interface timing controls, one or more animation controls, one or more user-selectable controls, or combinations thereof. In some embodiments, display data 152 may be generated as a structured collection of interface elements that are associated with at least a root-cause component 144, associated fault state 148, first resolution instruction 160a, completion input 164, and updated operation data 132, such that communication interface 140 may dynamically update a presented troubleshooting state without requiring manual navigation by a user. In some embodiments, display data 152 may define not only what content is presented, but also when the content is presented, how long the content remains visible, whether the content blinks, pulses, expands, collapses, changes color, changes priority, or is replaced after receipt of updated operation data 132. In some embodiments, display data 152 may be generated as a function of user role, current channel state, current maintenance mode, current diagnostic confidence, prior presented instructions, or current operating risk associated with operating system 104. In some embodiments, communication interface 140 may include a local display, a touch panel, an embedded web interface, a maintenance dashboard, a smartphone screen, a tablet screen, or a remote supervisory portal. In some embodiments, communication interface 140 may further include one or more local light indicators, one or more sound indicators, one or more annunciators, one or more status lamps, or one or more haptic indicators configured to present at least part of display data 152 in a non-textual manner. For example, and without limitation, display data 152 may cause a local maintenance panel to present a highlighted schematic region corresponding to at least a root-cause component 144 while a remote supervisory portal simultaneously presents a richer troubleshooting card including first resolution instruction 160a, live sensor values, and an action trigger requesting completion input 164. For example, and without limitation, display data 152 may cause communication interface 140 to present a first view corresponding to an active fault condition, a second view corresponding to guided execution of first resolution instruction 160a, and a third view corresponding to post-step verification using updated operation data 132.

With continued reference to FIG. 1, communication interface 140 may include a first user interface 140a of at least a control component 120 and a second user interface 140b of a remote user device 142 communicatively connected to operating system 104. For the purposes of this disclosure, “first user interface” is a user interface associated with a component of an operating system. For the purposes of this disclosure, “second user interface” is a user interface associated with a remote user device. In some embodiments, first user interface 140a may be located on a controller enclosure, maintenance panel, skid, close to control components 120 or equipment-adjacent display. In some embodiments, second user interface 140b may be located on a smartphone, tablet, laptop, or remote supervisory workstation. In some embodiments, first user interface 140a may provide quick local alert presentation, while second user interface 140b may provide richer graphics, longer workflows, historical views, remote notifications, and collaboration features. In some embodiments, first user interface 140a may be configured for lower-latency local presentation of status information that is immediately relevant to an operator positioned at operating system 104, whereas second user interface 140b may be configured for broader contextual presentation including historical operation data 132, prior completion history, remote support notes, or expanded diagrams. In some embodiments, first user interface 140a may include one or more physical buttons, one or more indicator lights, one or more compact text displays, one or more local audible indicators, or one or more simplified touch controls usable in an equipment-adjacent environment. In some embodiments, second user interface 140b may include one or more richer input mechanisms, such as full touch controls, typed annotations, image-capture functions, video support, remote acknowledgment controls, scheduling controls, or escalation controls that permit a remote user to participate in guided fault resolution. In some embodiments, first user interface 140a and second user interface 140b may present different subsets of display data 152. In some embodiments, first user interface 140a may present only a fault indication, a component identification, and a local confirmation control, while second user interface 140b may present step-by-step resolution instructions 160a-n, historical context, confidence information, expected telemetry changes, and one or more action triggers. In some embodiments, first user interface 140a and second user interface 140b may be synchronized such that a completion input 164 entered through one interface updates the content presented through the other interface. In some embodiments, first user interface 140a may be used where the operator is physically proximate the identified root-cause component 144, while second user interface 140b may be used where a supervisor, technician, or remote support user is assisting or monitoring the guided fault resolution process. For example, and without limitation, first user interface 140a may show a fault indication and an interaction control, while second user interface 140b may show full step-by-step resolution instructions 160a-n with diagrams and verification action triggers. For example, and without limitation, first user interface 140a may present a simplified indicator that a specific injector channel requires inspection, while second user interface 140b may present a visual diagram of the injector region, a sequence of inspection and cleaning steps, and a completion action trigger after each step.

With continued reference to FIG. 1, display data 152 is configured to cause communication interface 140 to present an identification of at least a root-cause component 144. In some embodiments, the identification may include a component name, a channel identifier, a subsystem name, a location descriptor, a highlighted diagram region, an image overlay, or a schematic callout. In some cases, the identification may include blinking lights of a light indicator close to at least a root-cause component 144, making noise or sound of a sound indicator close to or at a root-cause component 144, and the like. In some embodiments, the identification may include relationship context, such as whether the component is upstream or downstream of another component, whether it is associated with a particular chemistry channel, and whether it has a history of prior similar faults. In some embodiments, the identification may further include one or more physical-location references, one or more maintenance-access references, one or more part-type references, one or more channel-path references, or one or more connection references that help a user physically locate at least a root-cause component 144. In some embodiments, the identification may include a relative position within operating system 104, such as upper, lower, inlet-side, outlet-side, upstream, downstream, left-side, right-side, or manifold-associated position. In some embodiments, the identification may be presented using multiple modalities simultaneously, such as a text label on a screen together with a blinking local light indicator or an audible local announcement. In some embodiments, a light indicator may blink in a selected pattern corresponding to at least a root-cause component 144, and a sound indicator may generate a selected sound, tone, or spoken message to direct attention to the identified component location. In some embodiments, the identification may also indicate whether at least a root-cause component 144 is likely accessible without disassembly, whether a protective panel is to be removed, whether a channel is to be isolated before access, or whether a maintenance mode is to be entered before physical interaction. For example, and without limitation, communication interface 140 may present that a particular injector on a selected channel or a particular valve on a designated water line has been identified as at least a root-cause component 144. For example, and without limitation, communication interface 140 may present a highlighted schematic branch corresponding to a chemistry channel together with a blinking local light at the associated pump location and a text indication stating that the identified component is upstream of an injector and downstream of a storage reservoir. For example, and without limitation, communication interface 140 may present a location descriptor indicating that at least a root-cause component 144 is positioned within a lower manifold region behind a service panel, thereby reducing time required for a user to locate the component physically.

With continued reference to FIG. 1, display data 152 is configured to cause communication interface 140 to present a fault indication corresponding to associated fault state 148. For the purposes of this disclosure, “fault indication” is information representative of the presence, type, status, or condition of a fault associated with a component or system. In some embodiments, the fault indication may include a textual description, a symbolic indicator, a severity marker, a confidence score, a colored alert state, a code, or a graphical animation. In some embodiments, the fault indication may include blinking different color of a light indicator close to at least a root-cause component 144, making different noise, sound or announcement of a sound indicator close to or at a root-cause component 144, and the like. In some embodiments, the fault indication may explain the mismatch between command-status data 136 and sensor data 128. In some embodiments, the fault indication may be accompanied by live values, such as current pressure, measured current, or recent level depletion. In some embodiments, the fault indication may distinguish among different categories of abnormal operation, such as fluidic abnormality, electrical abnormality, depletion abnormality, response-latency abnormality, or partial-performance abnormality. In some embodiments, the fault indication may include one or more severity gradations indicating whether continued operation of operating system 104 is permitted, conditionally permitted, or discouraged until remediation is performed. In some embodiments, the fault indication may include one or more visual distinctions corresponding to fault family, such as a first color family for fluidic issues, a second color family for electrical issues, and a third color family for depletion or supply issues. In some embodiments, the fault indication may include one or more live telemetry overlays showing the specific values or relationships that supported identification of associated fault state 148, such as persistent pressure during an off-command state, below-threshold current during an on-command state, or absence of expected depletion during a commanded dispensing interval. In some embodiments, an audible or visual indicator associated with the fault indication may vary depending on fault severity, risk level, or urgency of remediation. For example, and without limitation, the fault indication may indicate that a valve appears stuck open because fluid pressure persists while the valve is not energized. For example, and without limitation, the fault indication may indicate that a pump is likely under-performing because command-status data 136 indicates a run state while flow data and level data do not reflect expected material transfer. For example, and without limitation, the fault indication may indicate that an injector-associated channel is likely blocked because upstream conditions indicate available flow while suction-related behavior and active-agent depletion do not reflect expected draw. For example, and without limitation, a first local light pattern may indicate a lower-priority verification condition while a second local light pattern and an audible alert may indicate a higher-priority fault requiring action trigger intervention.

With continued reference to FIG. 1, display data 152 is configured to cause communication interface 140 to present first resolution instruction 160a of one or more resolution instructions 160a-n. In some embodiments, first resolution instruction 160a may be displayed adjacent to the component identification and the fault indication so that an operator is informed of what to inspect and why that inspection is recommended. In some embodiments, first resolution instruction 160a may include safety warnings, images, diagrams, part-handling cautions, expected sensor values, and a control for submitting completion input 164. In some embodiments, first resolution instruction 160a may include a first step for calibrating, troubleshooting, confirming a fault, or the like. In some embodiments, first resolution instruction 160a may be tailored to a site operator, a maintenance mechanic, or a technician with a higher permission level. In some embodiments, first resolution instruction 160a may be simplified automatically when the user role indicates a lower training level. In some embodiments, first resolution instruction 160a may be presented together with one or more prerequisites, such as entering a maintenance mode, confirming that a line is depressurized, confirming that power is disabled for a selected component, or confirming that a selected channel is isolated from normal dispensing operation. In some embodiments, first resolution instruction 160a may further include one or more expected outcomes that are to be observed after the instructed action is performed, thereby supporting later evaluation of updated operation data 132. In some embodiments, first resolution instruction 160a may be selected to maximize diagnostic value while minimizing risk, downtime, or unnecessary disassembly. In some embodiments, first resolution instruction 160a may be associated with a component-specific visual aid, such as a zoomed view of a pump head, a highlighted valve location, an injector cleaning diagram, or a tubing-routing illustration. In some embodiments, first resolution instruction 160a may include one or more calibrated test steps, such as initiating a test cycle, observing a pressure-decay interval, observing a current-response interval, or confirming whether level data changes after a priming action. In some embodiments, first resolution instruction 160a may include one or more user-selectable controls by which a user may indicate successful completion, inability to perform the instruction, uncertain completion, or abnormal observation during performance of the instruction. In some embodiments, tailoring of first resolution instruction 160a to a user role may include presenting a simplified instruction for a site operator and a more technically detailed instruction for a trained technician, even when both instructions correspond to the same associated fault state 148. For example, and without limitation, first resolution instruction 160a may direct a user to inspect whether a valve body is obstructed, to verify an electrical connection, and to observe whether pressure persists after a commanded off cycle. For example, and without limitation, first resolution instruction 160a may direct a user to initiate a priming routine for a suspected blocked injector channel, observe whether suction behavior changes, and submit completion input 164 after confirming whether active-agent depletion begins. For example, and without limitation, first resolution instruction 160a may include a first calibration-oriented step in which a user is instructed to confirm that a sensor reading falls within a reference range before more invasive troubleshooting is attempted.

With continued reference to FIG. 1, at least a processor 112 is configured to receive a completion input 164 indicating completion of first resolution instruction 160a and updated operation data 132 associated with operation of operating system 104. For the purposes of this disclosure, “completion input” is an input indicating that a resolution instruction has been completed. For the purposes of this disclosure, “updated operation data” is operation data acquired after initiation, or completion of a resolution instruction. Completion input 164 is configured to indicate completion of first resolution instruction 160a. Updated operation data 132 is configured to reflect system behavior after the first troubleshooting action has been performed or attempted. In some embodiments, completion input 164 may include a button selection, a touch input, a voice confirmation, a scanned identifier, an authenticated signoff, or a sensor-detected confirmation event. In some embodiments, completion input 164 may include a binary completion acknowledgment, a partial-completion acknowledgment, a timed acknowledgment, a role-authenticated acknowledgment, or a completion indicator associated with a particular user role, device, or troubleshooting session. In some embodiments, completion input 164 may be received through first user interface 140a, second user interface 140b, or both, and may be associated with a timestamp, a user identifier, a selected control component 120, a selected dispensing channel, or a selected fault resolution protocol 124 state. In some embodiments, completion input 164 may be generated automatically when operating system 104 detects occurrence of a commanded verification action, such as a confirmed valve cycle, a confirmed priming routine, a confirmed reset event, or a confirmed maintenance-mode transition. In some embodiments, updated operation data 132 may include newly sampled pressure data, flow data, current data, level data, or combinations thereof captured after a verification window. In some embodiments, updated operation data 132 may additionally include post-step command-status data 136, updated commanded state, updated observed operating state, derived comparison features, persistence indicators, or verification results generated after execution or attempted execution of first resolution instruction 160a. In some embodiments, updated operation data 132 may be captured immediately after receipt of completion input 164, after expiration of a defined stabilization interval, after a post-step diagnostic cycle, after a commanded verification event, or after a selected number of post-step telemetry samples are obtained. In some embodiments, at least a processor 112 may use completion input 164 together with updated operation data 132 to determine whether the instructed action has likely been performed correctly, whether associated fault state 148 persists, whether the fault has partially improved, or whether a new abnormal condition has emerged. For example, and without limitation, completion input 164 may correspond to user confirmation that an injector passage has been cleaned, and updated operation data 132 may include post-cleaning suction pressure, downstream flow behavior, and active-agent depletion behavior obtained during a post-cleaning verification cycle. For example, and without limitation, completion input 164 may correspond to user confirmation that a valve connector has been reseated, and updated operation data 132 may include coil current values and downstream pressure-decay behavior obtained after a commanded valve cycle.

With continued reference to FIG. 1, at least a processor 112 is configured to modify display data 152 to present a subsequent resolution instruction 160b of one or more resolution instructions 160a-n as a function of updated operation data 132. In some embodiments, updated operation data 132 may indicate that a fault state persists or has not been fully resolved, and at least a processor 112 may therefore update display data 152 to present subsequent resolution instruction 160b corresponding to continued remediation. In some embodiments, updated operation data 132 may indicate that the fault state has been resolved, and at least a processor 112 may update display data 152 to present a fault-cleared indication, a completion confirmation, or a summary of performed resolution instructions 160a-n in place of subsequent resolution instruction 160b. For example, and without limitation, upon detection that sensor data and command-status data align with expected operating conditions, display data 152 may be updated to indicate successful resolution and optionally provide guidance for returning operating system to normal operation. In some embodiments, at least a processor 112 may compare updated operation data 132 to expected post-step behavior associated with first resolution instruction 160a. In some embodiments, if updated operation data 132 indicates persistence of the diagnosed fault, display data 152 may be updated or modified to present subsequent resolution instruction 160b. In some embodiments, if updated operation data 132 indicates partial improvement or incomplete execution, display data 152 may be updated differently. In some embodiments, updating display data 152 may include refreshing live telemetry, changing visual emphasis, replacing a procedural card, showing a new diagram, or requesting additional evidence. In some embodiments, at least a processor 112 may determine whether updated operation data 132 satisfies one or more expected post-step criteria, such as decay of pressure below a threshold, increase of flow above a threshold, current response within an expected range, restoration of expected level depletion, or elimination of a previously detected mismatch between commanded state and observed operating state. In some embodiments, subsequent resolution instruction 160b may be selected from a stored sequence, selected from a ranked set of candidate instructions, or generated by combining a next-step action with one or more updated warnings, diagrams, action triggers, or telemetry requirements. In some embodiments, modifying display data 152 may include advancing a workflow state, changing a displayed progress indicator, changing a severity marker, changing a component highlight, or modifying a fault explanation as a function of updated operation data 132. In some embodiments, if updated operation data 132 indicates that a first attempted corrective action affected one telemetry channel but not another telemetry channel, at least a processor 112 may select a subsequent resolution instruction 160b that targets the remaining unresolved abnormality. In some embodiments, subsequent resolution instruction 160b may be more invasive, more component-specific, more verification-oriented, or more escalatory than first resolution instruction 160a. For example, and without limitation, if a first instruction directed the user to reseat a connector and updated operation data 132 still indicates no current at a valve coil, a subsequent resolution instruction 160b may direct inspection of upstream wiring or replacement of the coil. For example, and without limitation, if a first instruction directed a user to perform a priming cycle and updated operation data 132 indicates restoration of level depletion but continued below-threshold downstream flow, subsequent resolution instruction 160b may direct inspection of a downstream injector or a partially obstructed fluid line component. For example, and without limitation, if updated operation data 132 indicates that pressure decay has improved but still does not satisfy an expected post-step threshold, subsequent resolution instruction 160b may direct a more focused leak-check or seal-inspection procedure rather than a full component replacement step.

With continued reference to FIG. 1, modifying display data 152 may include receiving updated operation data 132 indicating that first resolution instruction 160a has not been completed and modifying display data 152 as a function of updated operation data 132 by presenting a modified instruction. For the purposes of this disclosure, “modified instruction” is an instruction adapted from a prior resolution instruction. In some embodiments, modified instruction may simplify a prior instruction, add missing detail, emphasize a prerequisite, narrow the action to a subtask, request a measurement, or redirect the user to an alternate safe step. In some embodiments, modified instruction may be generated when updated operation data 132 indicates that the expected system response to the first step has not occurred and that telemetry suggests the original step was not fully executed. In some embodiments, modified instruction may be generated by extracting a substep from first resolution instruction 160a, reordering one or more actions of first resolution instruction 160a, adding a missing preparatory action, or replacing a broad instruction with a more component-specific instruction. In some embodiments, modified instruction may be generated when updated operation data 132 indicates absence of any post-step change that would ordinarily occur if first resolution instruction 160a had been completed, such as absence of a commanded cycle, absence of any current response, absence of any priming behavior, or absence of any pressure or flow perturbation. In some embodiments, modified instruction may include one or more additional visual aids, one or more step-by-step sub-instructions, one or more safety reminders, one or more role-specific simplifications, or one or more telemetry-based explanations of why the prior instruction appears incomplete. In some embodiments, modified instruction may be selected to reduce ambiguity for a lower-skill operator or to reduce the number of physical actions required before a meaningful verification result can be obtained. In some embodiments, modified instruction may also cause communication interface 140 to present a more limited set of user controls, thereby guiding the user through a narrower corrective path. For example, and without limitation, if first resolution instruction 160a directed a user to inspect and clear an injector and updated operation data 132 indicates continued blockage-like behavior without evidence of a priming cycle, modified instruction may direct the user specifically to run the priming cycle before rechecking injector behavior. For example, and without limitation, if first resolution instruction 160a directed a user to inspect a valve connection and updated operation data 132 indicates no change in current, modified instruction may direct the user specifically to verify whether the connector is fully seated and whether a latch mechanism is engaged before any further troubleshooting step is taken. For example, and without limitation, if first resolution instruction 160a required inspection behind a service panel and telemetry suggests the relevant component was not yet cycled or tested, modified instruction may narrow the instruction to opening the panel, identifying the highlighted component, and actuating a specific local test control.

With continued reference to FIG. 1, modifying display data 152 may include identifying partial completion of first resolution instruction 160a as a function of updated operation data 132, generating a modified instruction and an action trigger requesting an additional completion input 164 as a function of the identification, and modifying display data 152 to present the modified instruction and the action trigger. For the purposes of this disclosure, “action trigger” is an interface element configured to solicit user input or further action. In some embodiments, partial completion may be inferred when some but not all expected telemetry changes have occurred, when elapsed time suggests interruption, when the user indicates uncertainty, or when a verification sensor shows intermediate progress. In some embodiments, action trigger may request confirmation that a connector was reseated, that a valve was cycled, that a line was primed, that a part was removed and reinstalled, that a measurement was observed, or that a photograph or note is being submitted. In some embodiments, modified instruction and action trigger may cooperate to reduce ambiguity and keep the operator on a guided path without requiring free-form troubleshooting judgment. In some embodiments, identification of partial completion may include determining that one subset of expected telemetry changes has occurred while another subset has not occurred, such as confirmation of a priming event without restoration of expected flow, confirmation of a commanded cycle without restoration of expected current behavior, or partial restoration of pressure response without elimination of a mismatch condition. In some embodiments, action trigger may request a structured response, such as yes/no confirmation, selection among multiple observed conditions, input of a measured value, capture of an image, confirmation of a component position, or confirmation that a prerequisite condition has been satisfied. In some embodiments, action trigger may also request selection of a reason first resolution instruction 160a could not be fully completed, such as lack of access, missing tools, safety constraints, uncertainty regarding component identification, or absence of expected test controls. In some embodiments, modified instruction generated after identification of partial completion may explicitly reference the portion of first resolution instruction 160a that appears incomplete and may add one or more narrower actions configured to complete that portion before subsequent resolution instruction 160b is presented. In some embodiments, action trigger may be coupled with one or more contextual indicators, such as an updated diagram, a highlighted component region, or a list of expected telemetry changes that were not observed. For example, and without limitation, if updated operation data 132 indicates that a priming cycle occurred but active-agent depletion remains below an expected threshold, modified instruction may direct the user to inspect a downstream injector passage and action trigger may request confirmation that the injector passage has been opened and cleared. For example, and without limitation, if updated operation data 132 indicates that a valve cycle was attempted but pressure persistence has only partially improved, modified instruction may direct the user to confirm seal integrity and action trigger may request entry of a post-cycle pressure value observed during a defined interval. For example, and without limitation, if telemetry indicates that a component was accessed but not returned to an expected installed state, action trigger may request confirmation of reinstallation before further verification proceeds.

With continued reference to FIG. 1, in some embodiments, identification of root-cause component 144, associated fault state 148, generation of fault resolution protocol 124, and modifying of display data 152 may additionally be supported by one or more models. In some embodiments, a first model may be an anomaly-detection model configured to receive time-windowed command-status data 136 and sensor data 128 and output an anomaly score. In some embodiments, the anomaly-detection model may be trained using historical operation data 132 collected during known healthy operation across multiple sites and multiple channels. In some embodiments, the training data may be sourced from controller telemetry logs, commissioning runs, service records, and fleet telemetry archives. In some embodiments, the anomaly-detection model may include an autoencoder, isolation forest, recurrent neural network, temporal convolutional network, transformer-based sequence model, or ensemble model. In some embodiments, a second model may be a component-and-fault classifier configured to receive raw sensor features, derived features, anomaly scores, and context features and output probabilities associated with candidate root-cause components 144 and candidate fault states 148. In some embodiments, the second model may be trained using labeled service episodes in which the actual failed component and actual fault condition were confirmed by maintenance personnel. In some embodiments, labels may be sourced from technician notes, part replacement records, guided workflow outcomes, or curated engineering datasets. In some embodiments, the first model may receive one or more time-aligned sequences of command-status data 136, pressure data, flow data, current data, level data, and one or more derived features such as decay rates, persistence intervals, actuation-to-response delays, moving averages, rolling variances, or inter-sensor correlations. In some embodiments, the first model may output one or more anomaly scores for a selected channel, a selected component family, a selected operating interval, or a selected fault family. In some embodiments, the second model may receive one or more anomaly outputs from the first model together with contextual information such as channel identity, fluid type, active-agent type, maintenance mode status, user role, environmental condition, prior failure history, or prior completion outcomes. In some embodiments, the second model may output a ranked list of candidate root-cause components 144, a ranked list of candidate fault states 148, one or more confidence values, or one or more explanatory feature weights indicating which telemetry relationships most influenced the diagnosis. In some embodiments, one or more models may be invoked before deterministic rule evaluation, after deterministic rule evaluation, or in parallel with deterministic rule evaluation. In some embodiments, deterministic rule logic may operate as a gating mechanism that limits the search space for one or more models, while model outputs may operate as a ranking or tie-breaking mechanism where multiple rule-based diagnoses remain plausible. In some embodiments, training data may be labeled not only with final confirmed failures, but also with partial failures, intermittent failures, non-faulted transient conditions, and unsuccessful troubleshooting episodes, thereby improving model ability to distinguish true component faults from benign or temporary deviations. For example, and without limitation, a first model may learn that a certain pattern of persistent downstream pressure and below-threshold valve current during repeated off-command intervals is strongly associated with a stuck-open valve condition. For example, and without limitation, a second model may learn to distinguish between pump-related under-performance and injector-related blockage where both conditions reduce expected flow but differ in current response, suction behavior, and level depletion patterns. For example, and without limitation, a model-supported diagnosis may be used to increase confidence in a rule-based identification where operation data 132 is noisy, ambiguous, or incomplete.

With continued reference to FIG. 1, in some embodiments, a third model may be a workflow-selection model configured to receive as inputs the identified root-cause component 144, associated fault state 148, command-status data 136, sensor data 128, historical operation data 132, user role information, prior completion behavior, and updated operation data 132, and to output a ranked set of candidate resolution instructions 160a-n. In some embodiments, training data for the workflow-selection model may include prior troubleshooting sessions, recorded operator choices, telemetry before and after each instruction, and final success outcomes. In some embodiments, labels may identify which instruction led to successful remediation, which sequence minimized downtime, or which path should be avoided for safety reasons. In some embodiments, outputs of the workflow-selection model may be filtered by deterministic safety rules and role-permission rules before being used to generate fault resolution protocol 124. In some embodiments, the workflow-selection model may be configured to rank not only individual instructions, but also instruction sequences, branch transitions, escalation points, or modified instructions that are likely to produce a useful verification result with minimal downtime or minimal operator burden. In some embodiments, the workflow-selection model may consider whether a prior user has repeatedly failed to complete similar instructions, whether a particular site or channel historically responds better to one troubleshooting path than another, whether a selected user role is authorized for a more invasive step, or whether updated operation data 132 indicates that a simpler verification step should precede a replacement or disassembly step. In some embodiments, the workflow-selection model may be trained using session-level and step-level labels, such that the model learns both which instruction ultimately resolved a fault and which intermediate steps were useful for narrowing a diagnosis even if they did not themselves resolve the fault. In some embodiments, model inputs may include time since fault detection, number of previously completed instructions, number of prior failed attempts, a complexity level of the current step, availability of live telemetry, or one or more indicators of site-specific channel behavior. In some embodiments, model outputs may include one or more ranked next-step candidates together with estimated probabilities of success, estimated risk values, estimated required skill levels, or estimated diagnostic value. In some embodiments, deterministic safety rules and role-permission rules may suppress any model-suggested step that would require disassembly, component isolation, electrical access, or other restricted activity beyond the permitted level of the current user. For example, and without limitation, a workflow-selection model may determine that a low-skill operator should receive a verification-oriented modified instruction, whereas a trained technician may receive a more direct replacement or disassembly instruction. For example, and without limitation, the workflow-selection model may rank a priming-oriented instruction above an injector-disassembly instruction where historical session data indicates that a large fraction of similar apparent blockage conditions were resolved through incomplete-prime correction rather than physical blockage removal. For example, and without limitation, the workflow-selection model may identify that, after two failed attempts at connector verification and persistent no-current telemetry, a coil-replacement path has a higher expected resolution probability than further repeated local inspection steps.

With continued reference to FIG. 1, in some embodiments, apparatus 100 may be configured to store and log operation data 132, command-status data 136, sensor data 128, identified root-cause component 144, associated fault state 148, fault resolution protocol 124, completion input 164, updated operation data 132, modified instruction, and action trigger. In some embodiments, such logged information may become historical operation data 132 for later analysis. In some embodiments, logged information may be used to refine thresholds, update diagnostic rule set 156, retrain one or more models, support remote maintenance review, or generate recurring-fault analytics. In some embodiments, apparatus 100 may therefore improve over time by combining deterministic rule logic, historical comparison, and guided workflow outcome feedback to produce increasingly accurate and increasingly useful guided fault resolution behavior. In some embodiments, stored logs may include timestamped telemetry windows, presented interface states, user acknowledgments, user-entered notes, selected controls, fault-code histories, verification outcomes, and post-remediation telemetry samples. In some embodiments, logs may be stored locally, transmitted to a remote storage service, mirrored across multiple systems, or retained in both device-local and remote repositories. In some embodiments, stored logs may preserve step-by-step causality across a troubleshooting session, such that apparatus 100 may later determine which instruction was presented, which input was received, which telemetry changed, which modified instruction was generated, and whether the final remediation was successful. In some embodiments, logged information may be segmented by site, component type, channel type, active-agent type, fault family, user role, or maintenance mode, thereby supporting more precise later analysis and model training. In some embodiments, stored logs may be used to generate site-level recurring-fault statistics, channel-level degradation trends, component-family failure frequencies, or instruction-effectiveness metrics indicating which instructions most often lead to successful remediation. In some embodiments, stored logs may be used to detect drift in system behavior over time, such as gradual change in normal pressure-decay behavior, gradual increase in typical current draw, or gradual reduction in expected depletion rate for a selected active-agent channel. In some embodiments, that drift information may be used to adjust thresholds, update expected verification criteria or select different troubleshooting sequences for aging systems. In some embodiments, stored logs may also support remote technician review by permitting a remote user to inspect not only a final diagnosis, but also the underlying command-status data 136, sensor data 128, presented instructions, user responses, and post-step verification results that led to the diagnosis. For example, and without limitation, apparatus 100 may store a session in which a suspected stuck-open valve diagnosis was generated, a connector-reseating instruction was completed, updated operation data 132 still indicated persistent downstream pressure, and a later valve replacement step resolved the fault. For example, and without limitation, apparatus 100 may log repeated priming-related faults for a selected chemistry channel across multiple days, thereby enabling later identification of a recurring injector or supply-side issue rather than isolated user error. For example, and without limitation, apparatus 100 may use accumulated logs to determine that a certain modified instruction consistently improves completion rate for lower-skill operators and may therefore prioritize that modified instruction in future similar troubleshooting sessions.

With continued reference to FIG. 1, in some embodiments, apparatus 100 and fault resolution protocol 124 may be applied to an operating system 104 encompassing a facility, such as a car wash or other industrial installation. In some embodiments, operation data 132 may include sensor data 128 corresponding to motor currents, supply voltages, temperatures, water flows, pressures, and other facility-level parameters acquired from sensors 108, including sensors associated with operating system 104 and an IO-Link network. In some embodiments, apparatus 100 may include or be communicatively connected to a server configured to aggregate operation data 132, and communication interface 140 may be implemented on one or more remote user devices, such as tablet devices, to present fault indication and one or more resolution instructions 160a-n for facility-wide fault diagnosis and guided remediation.

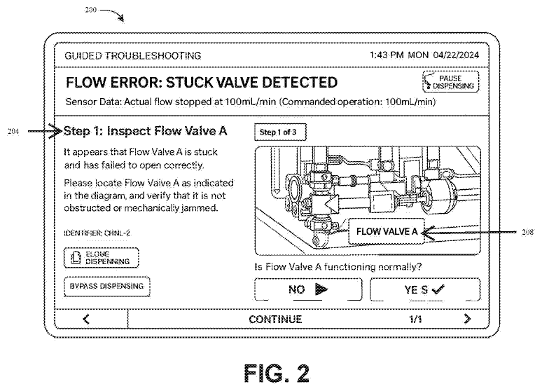

Referring now to FIG. 2, an exemplary communication interface 200 is illustrated. In the illustrated embodiment, the communication interface 200 may present guided troubleshooting information associated with an operating system fault and may be configured to communicate fault-specific operational data, a recommended corrective workflow, and one or more user-selectable response options. Communication interface 200 may include a resolution instruction 204 that identifies a particular diagnostic or corrective action to be performed, such as inspection of a designated flow valve, and may further provide explanatory text describing a suspected malfunction condition and a corresponding verification procedure. The communication interface 200 may present a root-cause component 208 within a graphical depiction of system hardware, wherein the root-cause component 208 visually identifies a component associated with the detected fault so as to direct an operator to a relevant physical location within the operating system. In some embodiments, the communication interface 200 may include fault status information, sensor-derived data, workflow progression indicators, and input controls enabling the operator to confirm whether the identified component is functioning normally and to continue, pause, bypass, or otherwise manage a guided resolution process.

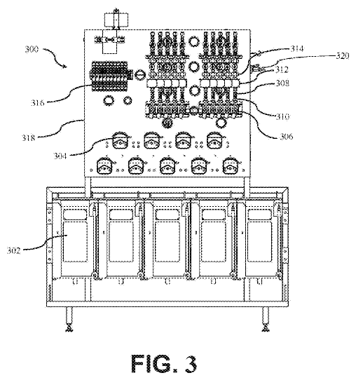

Referring now to FIG. 3, an exemplary embodiment of an operating system 300 is described. In one or more embodiments, operating system may be configured to dispense a fluid. In one or more embodiments, operating system be configured to control dilution rates of an active agent such as soap. In one or more embodiments, operating system may control dilution rates by means of controlling active agent flow rates and dilutant flow rates. In one or more embodiments, operating system may further be configured to create a foam by controlling air intake into a mixture of soap and water and/or an active agent and fluid. In one or more embodiments, operating system may further be configured to create a foam through air injection, wherein air may be pushed into the liquid stream. In one or more embodiments, operating system 300 may be configured to dispense a mixture containing a fluid and an active agent. In some embodiments, an active agent can be a chemical and/or combination of chemicals that is ultimately used to clean a device or product. For example, and without limitations, active agent may include chemicals used to clean, or apply the aforementioned solid or liquid film to, a car, a car tire, and/or the like. In one or more embodiments, active agent may include water-soluble substances used to create a solid or liquid film on the surface of the device or product being cleaned for the purpose of enhancing hydrophobicity, shine, repulsion of particulates, or effectiveness of rinsing of other active agents. In one or more embodiments, an active agent may include a soap, a cleaning agent and/or any other combinations of fluids and/or solvents. In one or more embodiments, operating system may be configured to mix and active agent, such as soap and a fluid, such as water to create a mixture. In one or more embodiments, operating system may include one or more storage tanks 302. In one or more embodiments, an active agent may be applied to a car wash system and/or to a device, such as vehicle without dilution with a fluid. In one or more embodiments, operating system may be configured to control flow rate of active agent into system. In one or more embodiments, storage tanks 302 may be configured to store one or more active agents. In one or more embodiments, each storage tank 302 of a plurality of storage tanks may be configured to house and/or store a separate active agent, such as for example, a soap for a differing purposes. In one or more embodiments, storage tanks 302 may include sensors, such as but not limited to, proximity sensors, ultrasonic sensors, pressure sensors and/or the like to sense an amount of active agent within each storage tank 302. In one or more embodiments, storage tanks 302 may include any storage tanks as described in this disclosure. In one or more embodiments, storage tanks may include level sensors, ultrasonic sensos, radar sensors, pressure differential sensor and/or the like,

With continued reference to FIG. 3, operating system 300 may include one or more peristaltic pumps 304. A peristaltic pump, also known as a hose or tube pump, is a type of positive displacement pump that moves fluids through a flexible tube using a rotating mechanism. The core working principle involves compressing and releasing the tube in a sequential manner to create a vacuum effect that draws fluid into the tubing and pushes it forward. This may be achieved by rollers or shoes mounted on a rotating rotor that press against the tubing, pinching it closed at multiple points. As the rotor turns, the pinched section moves along the tube, pushing the liquid ahead while drawing more liquid in behind it. Since the fluid only contacts the inner surface of the tubing, this pump design is especially suited for sterile, corrosive, or abrasive fluids, making it popular in medical, pharmaceutical, food processing, and chemical industries. It is also highly valued for its ability to handle shear-sensitive materials gently, its self-priming capability, and its ability to run dry without damage. Maintenance is straightforward, typically involving only tube replacement since the tubing is the primary wear component. Additionally, flow rate can be easily adjusted by changing the rotor speed or tube diameter, giving the peristaltic pump flexibility across a wide range of applications. In one or more embodiments, a different style of positive displacement pump might be used in lieu of peristaltic pump, such as but not limited to, a vane pump, a gear pump, a gerotor pump, Roots-type pump, a rotary motor or solenoid-driven diaphragm pump, a piston pump, or a progressive cavity pump. A non-positive displacement pump could also be used if its flow rate is monitored by a flow measurement system such as an orifice and differential pressure sensor, an ultrasonic flow sensor, a thermal mass flow sensor, a positive displacement flow sensor (e.g., microgear), a turbine flow sensor, or an electromagnetic flow sensor. In one or more embodiments, any positive displacement pump may be used to pump active agent through system. In one or more embodiments, peristaltic pump may be used to measure a flow rate of active agent within operating system 300.

With continued reference to FIG. 3, each storage tank 302 may include a peristaltic pump 304 configured to move and/or pump active agent or soap from storage tanks. In one or more embodiments, peristaltic pump may be used to monitor precise flow of an active agent such as soap. In one or more embodiments, peristaltic pump may be activated and/or controlled using pressure and/or flow sensors. In one or more embodiments, each storage tank 302 may be fluidly connected to a peristaltic pump, such that active agents, such as soap within storage tank are pumped and/or extracted using peristaltic pumps 304. Peristaltic pumps is described in further detail below. In one or more embodiments, peristaltic pump may include gear pumps configured to high pressure and high precision flow. In one or more embodiments, each storage tank may contain level sensors configured to sense an active agent within each storage container. In one or more embodiments, level sensors may identify the presence of active agent and thus the amount of active agent remaining within each storage tank 302. In one or more embodiments, level sensors may be used to determine when a storage tank 302 has been depleted of active agent and thus requires additional active agent. In one or more embodiments, level sensors may further be used to identify degradation within the piping of operating system 300. In one or more embodiments, a controller, such as any controller as described in this disclosure may identify a flow rate of active agent exiting storage tank 302 and thus identify a flow rate of active agent entering soap channel. In one or more embodiments, flow rates identified by level sensor and flow rate identified by other sensors may be used to determine component degradation, pipe degradation and/or the like.

With continued reference to FIG. 3, operating system 300 may include one or more water solenoids 306. A water solenoid is a component used to distribute water (or water-based mixtures) from a single input source to multiple output lines or dispensing points. The water solenoid maty serve as a centralized control and distribution block, allowing water or mixtures to be directed accurately and efficiently to different destinations-such as dispensing nozzles, mixing tanks, or processing equipment. In one or more embodiments, water solenoids 306 may be made from stainless steel, plastic, or other corrosion-resistant materials. In one or more embodiments, water solenoids 306 may include valves, flow meters, pressure gauges, sensors for real-time monitoring and precise control over a flowrate and composition. In one or more embodiments, water solenoids 306 may include valves that allow for a fluid, such as water to enter operating system 300. In one or more embodiments, water solenoids may include electrical, pneumatic and/or any other sort of valves that control the flow of a fluid. In one or more embodiments, water solenoids may include actuators that control the flow of a fluid, such as water.

With continued reference to FIG. 3, water solenoid may include one or more valves used to control the flow of a fluid such as water. For the purposes of this disclosure, a “valve” is a component that controls fluidic communication between two or more components. As nonlimiting examples, valve may include directional valves, control valves, selector valves, multi-port valves, check valves, and the like. Valves may include any suitable valve construction including ball valves, butterfly valves, needle valves, globe valves, gate valves, wafer valves, regulator valves, and the like. Valves may be included in a manifold of hydraulic or pneumatic circuit, for example allowing for multiple ports and flow paths. Valves may be actuated by any known method, such as without limitation by way of hydraulic, pneumatic, mechanical, or electrical energy. For instance, in some cases, valve may be actuated by an energized solenoid or electric motor, as described above. Valve actuators and thereby valves themselves may be controlled by computing device. Computing device and/or control unit may be in communication with valve, for example by way of one or more of electrical communication, hydraulic communication, pneumatic communication, mechanical communication, and the like. A person of ordinary skill in the art, upon reviewing the entirety of this disclosure, will be able to recognize how devices such as flow rate sensors and valves may be implemented within operating system 300. For the purposes of this disclosure, an “actuator” is a device or a component of a machine that produces force, torque, or displacement, usually in a controlled manner, when an electrical, pneumatic, or hydraulic input is supplied to it in an actuating system and converted into a required form of mechanical energy. Actuator may, in some cases, require a control signal and/or a source of energy or power, as described below in this disclosure. In some cases, control signal may be relatively low energy. Exemplary control signal forms include electric potential or current, pneumatic pressure or flow, hydraulic fluid pressure or flow, mechanical force/torque or velocity, or even human power. In some cases, actuator may have source of energy or power other than control signal. This may include a main energy source, which may include for example electric power, hydraulic power, pneumatic power, mechanical power, and/or the like. In some cases, upon receiving control signal, actuator may respond by converting source power into mechanical motion. In some cases, actuator may be understood as a form of automation or automatic control.

With continued reference to FIG. 3, in one or more embodiments, actuator may include a hydraulic actuator. Hydraulic actuator may consist of a cylinder or fluid motor that uses hydraulic power to facilitate mechanical operation. Output of hydraulic actuator may include mechanical motion, such as without limitation linear, rotatory, or oscillatory motion. In some cases, hydraulic actuator may employ a liquid hydraulic fluid. As liquids, in some cases, are incompressible, hydraulic actuators may be capable of exerting large forces. Additionally, as force is equal to pressure multiplied by area, hydraulic actuators may act as force transformers with changes in area (e.g., cross-sectional area of a cylinder and/or piston). An exemplary hydraulic cylinder may consist of a hollow cylindrical tube within which piston can slide. In some cases, hydraulic cylinder may be considered single acting. A single-acting piston may be used when fluid pressure is applied substantially to just one side of the piston. Consequently, single-acting piston may move in only one direction. In some cases, a spring may be used to give single-acting piston a return stroke. In some cases, hydraulic cylinder may be double acting. A double-acting piston may be used when pressure is applied substantially on each side of the piston; any difference in resultant force between the two sides of piston may cause the piston to move.

With continued reference to FIG. 3, in one or more embodiments, actuator may include a pneumatic actuator. In some cases, pneumatic actuators may enable considerable forces to be produced from relatively small changes in gas pressure. In some cases, pneumatic actuators may respond more quickly than other types of actuators, for example hydraulic actuators. Pneumatic actuators may use compressible fluid. In some cases, pneumatic actuators may operate on compressed air. Operation of hydraulic and/or pneumatic actuators may include control of one or more valves, circuits, fluid pumps, and/or fluid manifolds.

With continued reference to FIG. 3, in some cases, actuator may include an electric actuator. Electric actuator may include any electromechanical actuators, linear motors, and the like. Electromechanical actuators may convert a rotational force of an electric rotary motor into a linear movement to generate a linear motion through a mechanism. Exemplary mechanisms include rotational-to-translational motion transformers, such as without limitation a belt, a screw, a crank, a cam, a linkage, a scotch yoke, and the like. In some cases, control of electromechanical actuator may include control of electric motor; for instance, control signal may control one or more electric motor parameters to control the electromechanical actuator. Nonlimiting examples of electric motor parameters include rotational position, input torque, velocity, current, and potential. Electric actuator may include a linear motor. Linear motors may differ from electromechanical actuators, as power from linear motors is output directly as translational motion, rather than output as rotational motion and converted to translational motion. In some cases, linear motor may cause less friction loss than other devices. Linear motors may be further specified into at least three different categories, including flat linear motor, U-channel linear motors and tubular linear motors. Linear motors may be directly controlled by control signal for controlling one or more linear motor parameters. Nonlimiting examples of linear motor parameters include position, force, velocity, potential, and current. In some cases, electric actuator may include a solenoid actuator. For the purposes of this disclosure, a “solenoid” is a device capable of converting electrical energy into mechanical work; it comprises a coil of wire, a housing, and a movable plunger; when an electrical current is introduced, a magnetic field forms around the coil which moves the plunger.

With continued reference to FIG. 3, in one or more embodiments, actuator may include a mechanical actuator. In some cases, mechanical actuator may function to execute movement by converting one kind of motion, such as rotary motion, into another kind, such as linear motion. An exemplary mechanical actuator includes without limitation a rack and pinion. In some cases, a mechanical power source, such as a power take-off, may serve as a power source for mechanical actuator. Mechanical actuators may employ any number of mechanisms, including for example without limitation gears, rails, pulleys, cables, linkages, and the like.

With continued reference to FIG. 3, operating system 300 may include a plurality of water solenoids 306, wherein each water solenoid may be configured for a separate storage tank 302 containing a separate active agent. In one or more embodiments, each storage tank 302 may be assigned a separate water solenoid which is used to mix active agent with a fluid within water solenoid. In one or more embodiments, each storage tank 302 may be assigned more than one water solenoids for redundancy.

With continued reference to FIG. 3, each water solenoid 306 may be connected to a central fluid line 320, such as a central water line that provides fluids to operating system 300. In one or more embodiments, each water solenoid may provide fluid to a designated channel 308. In one or more embodiments, designated channel 308 may include piping and/or a means to transfer fluid from water solenoid through operating system 300. In one or embodiments, designated channel may include tubular piping made of aluminum, steel, plastic and/or the like and be configured to route fluid from water manifold through operating system. In one or more embodiments, each water solenoid may be fluidly connected to designated channel. In one or more embodiments, each designated channel 308 may include a sensor, such as a pressure sensor and/or flow meter configured to identify a pressure or flow of from each water solenoid. in one or more embodiments, operating system 300 may further include a flow rate sensor. For the purposes of this disclosure, a “flow rate sensor” is a device installed adjacent to a stream of liquid and configured to measure its real-time flow rate, i.e., the amount or volume of fluid that passes through per unit time, in gallons per minute, liters per minute, milliliters per minute, gallons per second, liters per second, milliliters per second, or another unit similar thereto. As a nonlimiting example, when liquid flow is steady, i.e., with a constant or nearly constant flow rate, duration of liquid flow may be calculated by dividing the amount/volume of liquid by the flow rate. In one or more embodiments, operating system 300 may include a pressure sensor 310 at or near water solenoid 306 in order to identify a pressure of fluid from water solenoid and in designated channel. In one or more embodiments, pressure sensor 310 may be used to ensure pressure is not starved.

With continued reference to FIG. 3, operating system 300 further includes a valve 312. Valve may include any valve as described in this disclosure. In one or more embodiments, valve 312 may include a motorized ball valve. In one or more embodiments, valve may be used to control a flow of fluid from water solenoid and through designated channel 308. In one or more embodiments, pressure sensor 310 may be located between valve 312 and water solenoid 306 to identify a pressure of a fluid within channel 308. In one or more embodiments, water solenoid may provide fluid from one end of designated channel 308, wherein valve 312 may control a flow of fluid through designated channel. In one or more embodiments, valve 312 may include a motorized ball valve to adjust flow rate. In one or more embodiments, each designated channel 308 and/or water solenoid may include a valve 312 configured to control a flow rate of a fluid such as water. In one or more embodiments, valve 312 may include a motorized ball valve. A motorized ball valve is an automated valves that use an electric motor to operate the ball inside the valve, allowing precise control of fluid flow in a piping system. In one or more embodiments, motorized ball valve, may include an on/Off motorized ball valve, modulating motorized ball valves, multi-port motorized ball valves, fail-safe motorized all valves and/or the like. In one or more embodiments, valve 312 may include any proportional control valve, i.e., a valve whose flow aperture increases and decreases over a defined range via a digital or analog modulation signal operated by computing devices, analog control signal sources, or other devices in a feedback loop. This valve could also be the sole means of activating water flow, eliminating the need for a solenoid valve as the on/off water supply valve for a given dilution channel. In one or more embodiments, valve 312 may be configured to adapt to varying flow rates. In one or more embodiments, a controller such as any controller as described in this disclosure may be configured to actuate and/or manipulate valve 312 in order to control a flow of fluid though soap channel. In one or more embodiments, controller may be configured to transmit command signals to valve 312 in order to increase or decrease a flow rate of fluid navigating through soap channel. In one or more embodiments, a controller, such as any controller as described in this disclosure may use sensors such as level sensors, pressure sensors, flow meters and/or the like to identify a flow rate of fluid and/or active agent and adjust the flow rate of fluid to ensure proper dilution ratios between active agent and fluid.

With continued reference to FIG. 3, in one or more embodiments, operating system may include one or more flow meters 314. In one or more embodiments, flow meters 314 may allow for identification of a flow rate of fluid within designated channel 308 after navigation through valve 312. In one or more embodiments, flow meter 314 may be used to identify an amount of fluid that is allowed to pass through ball valve. In one or more embodiments, flow meter 314 may be used to control valve 312, such that flow meter 314 may identify an amount of fluid flowing, and a controller as described in detail below, may be used to control a flow rate of valve 312. This will be described in further detail below. In one or more embodiments, flow meter 314 may include any flow meter as described in this disclosure and/or any sensor used to monitor flow of a fluid. In one or more embodiments, operating system 300 may include and/or be fluidly connected to airbox An “Airbox” as described in this disclosure is a component configured to provide air to operating system. In one or more embodiments, airbox may provide air to operating system 300 such that air is injected into a mixture created by operating system. In one or more embodiments, Overall air pressure per application may be regulated by operating system 300. The air pressure set on operating system 300 should match what the pressure gauge is reading on the Airbox. The gauge in Airbox is after the airbox's regulator and will indicate the output pressure of the secondary regulator present in the air boxes for each unique soap application. The regulator should be fully open (turned fully counterclockwise), and the needle valve should be used to adjust outgoing air. Each applicator contains its own needle valve to adjust its individual outgoing air-which will adjust foaminess at that applicator. Overall outgoing air pressure settings and needle valve settings should match the standard settings highlighted on the table below. Additional components of operating system 300 will be described in further detail below.

With continued reference to FIG. 3, operating system 300 may include an air supply manifold 316 with solenoid valves. The air supply manifold 316 is designed and/or configured to manage and distribute compressed air for soap application within operating system 300. In the direction of airflow, the system begins with a pressure regulator, which ensures that the air pressure is reduced and maintained at a consistent, pre-set level suitable for the downstream components. Immediately following the regulator is an output pressure gauge and sensor, which continuously monitor and display the regulated air pressure, providing real-time feedback for system diagnostics or automation control. Next, the air flows into a distribution manifold, which serves as a hub to evenly route the regulated air to multiple outputs. These outputs are each connected to solenoid valves, with one valve dedicated to each soap application line. The solenoid valves control the on/off flow of air to their respective applicators, enabling precise control over soap dispensing operations.

With continued reference to FIG. 3, operating system 300 may include one or more sensors, such as for example, pressure sensor, flow meter, level sensor and/or the like. Sensor may include one or more sensors. For example, and without limitation, a sensor may transduce a detected charging phenomenon and/or characteristic, such as, and without limitation, temperature, voltage, current, pressure, and the like, into a sensed signal such as a voltage with respect to a reference. Sensor may detect a plurality of data. A plurality of data detected by sensor may include, but is not limited to pressure, temperature, carbon saturation, oxygen saturation and/or the like. In one or more embodiments, and without limitation, sensor may include a plurality of sensors. In one or more embodiments, and without limitation, sensor may include an optical or image sensor such as a camera, a CMOS detector, a CCD detector, a video camera, a photodiode, a photovoltaic cell, a photoconductive device, a thermal and/or infrared camera, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor may be a contact or a non-contact sensor. Signals may include electrical, electromagnetic, visual, audio, radio waves, or another undisclosed signal type alone or in combination.

With continued reference to FIG. 3, sensor may include a plurality of independent sensors, where any number of the described sensors may be used to detect any number of physical or thermal qualities associated with carbon capture chamber 316a-n. Independent sensors may include separate sensors measuring physical or thermal quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of sensor to detect phenomenon may be maintained.

With continued reference to FIG. 3, sensor may include a pressure sensor. A “pressure,” for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure an atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors or alone or in a combination thereof. The pressor sensor may include a barometer. In some embodiments, the pressure sensor may be used to indirectly measure fluid flow, speed, water level, and altitude. In some embodiments, a pressure sensor may be configured to transform a pressure into an analogue electrical signal. In some embodiments, the pressure sensor may be configured to transform a pressure into a digital signal.

With continued reference to FIG. 3, sensor may include a moisture sensor. “Moisture,” as used in this disclosure, is the presence of water, which may include vaporized water in air, condensation on the surfaces of objects, or concentrations of liquid water. Moisture may include humidity. “Humidity,” as used in this disclosure, is the property of a gaseous medium (almost always air) to hold water in the form of vapor. In an embodiment, a moisture sensor may include a hygrometer. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity,” for the purposes of this disclosure, is expressed as a percentage, indicating a present stat of absolute humidity relative to a maximum humidity given the same temperature. “Specific humidity,” for the purposes of this disclosure, is the ratio of water vapor mass to total moist air parcel mass, where parcel is a given portion of a gaseous medium. Humidity sensor may be psychrometer. Humidity sensor may be a hygrometer. Humidity sensor may be configured to act as or include a humidistat. A “humidistat,” for the purposes of this disclosure, is a humidity-triggered switch, often used to control another electronic device. Humidity sensor may use capacitance to measure relative humidity and include in itself, or as an external component, include a device to convert relative humidity measurements to absolute humidity measurements.

With continued reference to FIG. 3, sensor may include a moisture sensor. In one or more embodiments, operating system 300 may include moisture sensor configured to measure moisture datum.

With continued reference to FIG. 3, sensor may include thermocouples, thermistors, thermometers, infrared sensors, resistance temperature detectors (RTDs), semiconductor based integrated circuits (ICs), a combination thereof, or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor, may be measured in Fahrenheit (°F), Celsius (°C), kelvin (K), Rankine (° R), or another scale alone or in combination. The temperature measured by sensors may comprise electrical signals, which are transmitted to their appropriate destination wireless or through a wired connection.

With continued reference to FIG. 3, sensor may include a plurality of sensing devices, such as, but not limited to, temperature sensors, humidity sensors, accelerometers, electrochemical sensors, gyroscopes, magnetometers, inertial measurement unit (IMU), pressure sensor, proximity sensor, displacement sensor, force sensor, vibration sensor, air detectors, hydrogen gas detectors, and the like. Sensor may be configured to detect a plurality of data, as discussed further below in this disclosure. A plurality of data may be detected from sensor.

With continued reference to FIG. 3, sensor may include a sensor suite which may include a plurality of sensors that may detect similar or unique phenomena. For example, in a non-limiting embodiment, a sensor suite may include a plurality of voltmeters or a mixture of voltmeters and thermocouples. System 300 may include a plurality of sensors in the form of individual sensors or a sensor suite working in tandem or individually. A sensor suite may include a plurality of independent sensors, as described in this disclosure, where any number of the described sensors may be used to detect any number of physical or electrical quantities associated with a charging connection. Independent sensors may include separate sensors measuring physical or thermal quantities that may be powered by and/or in communication with circuits independently, where each may signal sensor output to a control circuit. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained.

With continued reference to FIG. 3, sensor is configured to transmit a sensor output signal representative of sensed information. As used in this disclosure, a “sensor signal” is a representation of a sensed information that sensor may generate. A sensor signal may include any signal form described in this disclosure, for example digital, analog, optical, electrical, fluidic, and the like. In some cases, a sensor, a circuit, and/or a controller may perform one or more signal processing steps on a signal. For instance, sensor, circuit, and/or controller may analyze, modify, and/or synthesize a signal in order to improve the signal, for instance by improving transmission, storage efficiency, or signal to noise ratio.

With continued reference to FIG. 3, exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued, and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 3, operating system 300 includes a modular skid frame 318. A “modular skid frame” as described in this disclosure is a structural chassis designed to house the mechanical, fluidic, and/or electrical components of a system as a single unit. In one or more embodiments, modular skid frame 318 may be configured to support and organize the mechanical, fluidic, and electrical components of the system as a cohesive, mobile assembly. The modular skid frame 318 may be constructed from structural members, such as stainless steel or aluminum square tubing, providing a rigid chassis for the mounting of a plurality of storage tanks 302, peristaltic pumps 304, and manifold assemblies. In one or more embodiments, the modular skid frame 318 may be engineered for mobility and rapid installation, featuring integrated forklift pockets and a base height configured to receive the tines of a standard pallet jack. In one or more embodiments, modular skid frame 318 may include a self-contained unit configured for transport. For the purposes of this disclosure, a “self-contained unit” is a discrete, pre-assembled module that incorporates all primary internal hardware and control logic necessary for operation, such that it can function independently or in tandem with another unit upon connection to a limited set of external utilities. As a self-contained unit, the modular skid frame 318 may house its own dedicated controller, dilution blocks, and internal wiring harnesses, eliminating the need for complex field-wiring of individual sensors or pumps. To become fully operational, the modular skid frame 318 may require only four primary external connections: a power connection (e.g., 277V AC) to provide energy to the controller and pump motors; a data connection (e.g., Ethernet or PoE) for network communication and emergency stop signaling; a pressurized water inlet fluidly connected to the central fluid line 320 to supply the dilution channels; and a compressed air inlet to supply the air manifold and associated foam applicators. In one or more embodiments, the modular skid frame 318 may be configured to facilitate maintenance within its own footprint through integrated structural features. The frame may include a rear-access portion moveably coupled to the main chassis, such as a flip-up door supported by one or more gas struts, which allows internal components to be serviced while the unit remains in its installed position. Additionally, the frame may include an integrated horizontal support bar with a pre-drilled lifting point positioned vertically above high-mass components, such as a water booster pump or motor, allowing for the installation of an eye-bolt to assist in the removal or replacement of said components. By consolidating these features into a self-contained unit, the modular skid frame 318 enables a plug-and-play” deployment model that reduces the time and technical expertise required for on-site setup. In one or more embodiments, the modular skid frame 318 may be transportable such that it is not fixed to a surface and can be removably attached and moveable when needed. In one or more embodiments, the modular skid may be moved with a pallet jack and connected to external water supplies and electrical supplies.

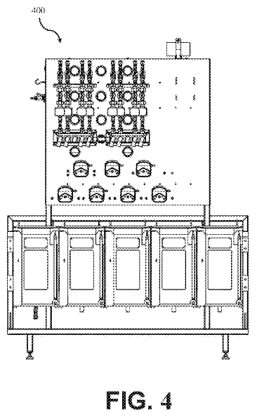

Referring now to FIG. 4, an exemplary embodiment of operating system 400 is described. In one or more embodiments, operating system 400 may lack an airbox in instances in which the injection of air may not be required and/or needed within mixture.

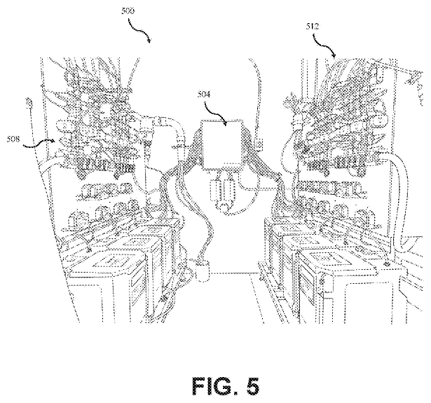

Referring now to FIG. 5, an exemplary embodiment of a dispensing station 500 is described. In one or more embodiments, dispensing station 500 may include a controller 504 communicatively connected to operating system. In one or more embodiments, controller 504 may include any controller as described in this disclosure.

With continued reference to FIG. 5, computing device may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 5, system and/or controller 504 may include and/or be communicatively connected to a server, such as but not limited to, a remote server, a cloud server, a network server, and the like. In one or more embodiments. In one or more embodiments, computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by system computing device. In one or more embodiments, computing device may transmit processes to server wherein computing device may conserve power or energy.

With continued reference to FIG. 5, one or more processes as described in this disclosure may be performed by server. In one or more embodiments, processor may communicate with server to receive information needed for one or more instructions tasked by processor. In one or more embodiments, server may include one or more systems and/or software configured to provide information and/or data to processor. A “server” for the purposes of this disclosure is a system that provides resources, data, or services to other computing systems over a network. For example, without limitation, server may include a web server, a file server, a database server, and/or the like.

With continued reference to FIG. 5, controller 504 may be configured to receive a datum, or multiple datums, from pressure sensor, flow meter, and/or any other device capable of sensing a phenomenon. In one or more embodiments, controller 504 may be configured to transmit commands to operating system such as to valve to control fluid rate. In one or more embodiments, operating system may include a shut off switch. In one or more embodiments, shut off switch may allow for the immediate ceasing of electrical power to operating system. In one or more embodiments, dispensing station 500 may include multiple operating systems. In one or more embodiments, the use of multiple operating systems may allow for redundancy. In one or more embodiments, each operating system may be referred to as a ‘Skid,’ wherein a first dispensing station may be referred to as Skid 1 or a first skid 508 and a second dispensing station may be referred to as Skid 2 or a second skid 512. In one or more embodiments, dispensing station may include soap storage to hold additional soaps and/or active agents.

With continued reference to FIG. 5, in some cases, each operating system and/or skid may include one or more dilution blocks and/or apparatuses. As a non-limiting example, each operating system and/or skid may include a plurality of dilution blocks arranged in parallel to supply mixtures to multiple application points, or a plurality of dilution blocks arranged in series to provide staged or sequential mixing operations. In some embodiments, each operating system and/or skid may include dilution blocks configured to generate different ratios of fluid to active agent for different operational modes. For example, and without limitation, a first dilution block may be configured to generate a higher concentration mixture for pre-treatment, while a second dilution block may be configured to generate a lower concentration mixture for rinsing or finishing operations. In some embodiments, each operating system and/or skid may include dilution blocks dedicated to different active agents. For example, and without limitation, a first dilution block may be configured to dispense a cleaning agent, while a second dilution block may be configured to dispense a disinfecting agent. In some embodiments, each operating system and/or skid may include dilution blocks configured to operate independently or in coordination with one another. For example, and without limitation, multiple dilution blocks may be selectively activated based on operational requirements. In some embodiments, each operating system and/or skid may include dilution blocks configured to share one or more common resources. For example, and without limitation, multiple dilution blocks may be fluidly coupled to a common fluid supply line or may be controlled by a shared controller. In some embodiments, each operating system and/or skid may include dilution blocks configured to be modular and replaceable. For example, and without limitation, each dilution block may be removably connected to the operating system and/or skid to facilitate maintenance, repair, or replacement. In some embodiments, each operating system and/or skid may include dilution blocks configured to operate under different pressure or flow conditions. For example, and without limitation, a first dilution block may be configured for high-pressure operation while a second dilution block may be configured for lower-pressure operation. In some embodiments, each operating system and/or skid may include dilution blocks configured to integrate additional components. For example, and without limitation, each dilution block may include integrated sensors, valves, or control elements configured to enable localized control and monitoring.

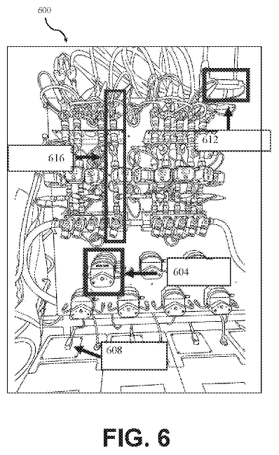

Referring now to FIG. 6, an exemplary embodiment of operating system 600 is described. In one or more embodiments, operating system 600 may include peristaltic pumps 604 configured to extract active agent from storage tanks. In one or more embodiments, operating system 600 may include a PH sensor 612 configured to monitor fluid entering through water solenoid. In one or more embodiments, water entering through water solenoid may contain an unexpected and/or undesired PH, wherein PH sensor 612 may be configured to identify a PH of fluid entering through water solenoid. In one or more embodiments, operating system 600 may include a dilution block 616. In one or more embodiments, dilution block 616 may be consistent with designated channel. In one or more embodiments, dilution block 616 may include a portion of operating system in which fluid and active agent are combined to create mixture. In one or more embodiments, the PH sensor 612 may be located on the water main and designed to monitor TDS and PH of incoming city water. PH sensor 612 may be positioned on the outlet of a dilution block 616 that is easily accessible as the dilution block 616 applies water to rinse the bottom of the car without soap. In one or more embodiments, dilution block 616 may be consistent with apparatus 100 and/or soap channel. In one or more embodiments, dilution block 616 may include pressure sensors, valves, flow meters, venturi valves, and/or the like. In one or more embodiments, dilution block 616 may include one or more pressure sensors, flow meters and/or valves as described in this disclosure to monitor back pressure and any potential issues. In an embodiment, sensors may be used to monitor backflow of active agent and/or fluid within dilution block 616. In one or more embodiments, a system may be configured to monitor sensors, collect a datum, and adjust flow valves, flow rates and, peristaltic pumps and/or the like accordingly. In one or more embodiments, operating system may include a tank level sensor 608. Tank level sensor 608 may include a sensor configured to measure an amount of active agent within each storage tank. In one or more embodiments, tank level sensor 608 may include any sensor as described in this disclosure and configured to identify an amount of active agent within storage tank. In one or more embodiments, tank level sensor may be consistent with ultrasonic sensor and/or ultrasonic level sensor as described in this disclosure.

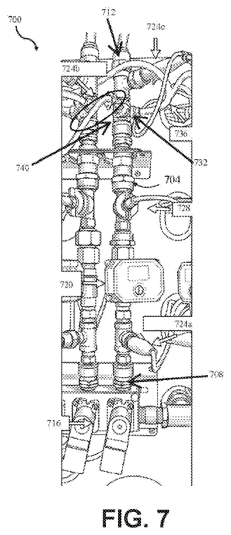

Referring now to FIG. 7, an exemplary embodiment of apparatus 700 for generating a mixture of a fluid and an active agent is illustrated. In one or more embodiments, apparatus 700 includes a manifold body 704 defining a designated channel extending from an inlet 708 to an outlet 712. For the purposes of this disclosure, “manifold body” is a unitary structure configured to receive fluidic material from more than one source or location. In some cases, manifold body may be configured to receive a fluid and an active agent and to generate a mixture of the fluid and the active agent. In some embodiments, mixture may be generated by combining a fluid and an active agent within a flow path In some cases, substances may be physically intermingled without requiring a chemical reaction to form a new substance. In some embodiments, the mixture may include a homogeneous mixture in which the fluid and the active agent are uniformly distributed. In some embodiments, the mixture may include a heterogeneous mixture in which the fluid and the active agent are not uniformly distributed. For example, and without limitation, the mixture may include a solution in which the active agent is dissolved within the fluid or a dispersion in which the active agent is suspended within the fluid. In some embodiments, the mixture may include additional phases such as gas. For example, and without limitation, the mixture may include air bubbles dispersed within a liquid to form a foamed mixture. In some embodiments, the mixture may have properties that differ from the individual components. For example, and without limitation, the mixture may exhibit cleaning, disinfecting, or foaming characteristics based on the presence of the active agent. In some embodiments, the mixture may be defined by a ratio of the fluid to the active agent, wherein the ratio may determine a concentration of the active agent within the mixture. In some embodiments, the mixture may be generated continuously as the fluid and the active agent flow together or may be generated intermittently based on operation of apparatus 700.

With continued reference to FIG. 7, for the purposes of this disclosure, “designated channel” is an internal passage within a manifold body configured to convey fluid and facilitate mixing with an active agent or secondary fluid. In one or more embodiments, designated channel may be consistent with soap channel. In some embodiments, designated channel may comprise a continuous internal passage extending through manifold body 704 from inlet 708 to outlet 712. In some embodiments, designated channel may be configured to transport a fluid along a defined flow path while providing a region within which mixing may occur. In some embodiments, designated channel may include a single, uninterrupted bore. In some embodiments, designated channel may include a straight-through bore, a curved conduit, or a multi-segment passage. For example, and without limitation, designated channel may include a cylindrical bore extending longitudinally through manifold body 704 or intersecting passages defining a mixing region. In some embodiments, designated channel may include multiple connected segments forming a composite flow path. For example, and without limitation, designated channel may include a first segment aligned with inlet 708 and a second segment aligned with outlet 712, wherein the first segment and the second segment are connected by an intermediate region. In some embodiments, designated channel may include a varying cross-sectional geometry along a length of designated channel. In some embodiments, designated channel may include a uniform diameter along its length. In some embodiments, designated channel may include one or more sections having reduced or enlarged diameters. For example, and without limitation, designated channel may include a narrowed portion configured to increase fluid velocity and a widened portion configured to reduce fluid velocity. In some embodiments, designated channel may be configured to define one or more regions that facilitate interaction between a fluid and an active agent. In some embodiments, designated channel may include a region configured to promote mixing through fluid motion. For example, and without limitation, designated channel may include internal contours or curvature configured to induce directional changes in fluid flow. In some embodiments, designated channel may include internal surface features. In some embodiments, designated channel may include a smooth internal surface configured to reduce pressure loss. In some embodiments, designated channel may include a textured or roughened internal surface configured to increase fluid interaction. For example, and without limitation, designated channel may include grooves, ridges, or patterned surface features. In some embodiments, designated channel may be configured to support different flow regimes. In some embodiments, designated channel may support laminar flow conditions. In some embodiments, designated channel may support turbulent flow conditions. For example, and without limitation, designated channel may be dimensioned to achieve a Reynolds number corresponding to a desired flow regime. In some embodiments, designated channel may be configured to accommodate different fluid types and operating conditions. In some embodiments, designated channel may be configured to withstand high-pressure fluid flow. In some embodiments, designated channel may be configured to accommodate fluids having different viscosities. For example, and without limitation, designated channel may be sized to maintain a desired flow rate for fluids having varying viscosities. In some embodiments, designated channel may be formed using one or more manufacturing processes. For example, and without limitation, designated channel may be formed by drilling, milling, casting, or additive manufacturing. In some embodiments, designated channel may be formed as part of a monolithic structure of manifold body 704. In some embodiments, designated channel may be configured to be maintained or cleaned. In some embodiments, designated channel may be configured to allow fluid flushing. For example, and without limitation, designated channel may be configured to permit passage of a cleaning fluid to remove accumulated material.

With continued reference to FIG. 7, for the purposes of this disclosure, “inlet” is an opening or interface through which a fluid enters a manifold body. Designated channel is configured to receive a fluid and combine the fluid with an active agent within designated channel to generate and output a mixture at outlet 712. In some embodiments, inlet 708 may be configured to provide a fluid into manifold body 704, wherein inlet 708 may be positioned at an upstream portion of manifold body 704 relative to designated channel, or inlet 708 may be positioned at a downstream portion of manifold body 704 depending on a configuration of designated channel. In some embodiments, inlet 708 may include an opening, port, or interface configured to receive the fluid from an external source. In some embodiments, inlet 708 may include a geometry configured to facilitate fluid entry into designated channel, wherein inlet 708 may comprise a cylindrical opening aligned with designated channel, or inlet 708 may comprise an angled or offset opening configured to direct fluid into designated channel. For example, and without limitation, inlet 708 may be oriented along a longitudinal axis of designated channel or may be oriented at an angle to redirect flow into designated channel. In some embodiments, inlet 708 may include a connection feature configured to couple to a fluid supply line, wherein inlet 708 may include threads, barbs, or quick-connect features. For example, and without limitation, inlet 708 may include a threaded interface configured to engage with a corresponding threaded fitting of a supply conduit. In some embodiments, inlet 708 may be configured to accommodate different fluid pressures and flow rates, wherein inlet 708 may be sized to allow high-pressure fluid entry and maintain a desired flow profile as the fluid enters designated channel. For example, and without limitation, inlet 708 may include a tapered entry region configured to reduce turbulence at entry. In some embodiments, inlet 708 may include internal features configured to condition the fluid prior to entering designated channel, wherein inlet 708 may include a straightening section configured to align fluid flow. For example, and without limitation, inlet 708 may include internal vanes or flow-directing features configured to reduce swirl.

With continued reference to FIG. 7, for the purposes of this disclosure, “outlet” is an opening or interface through which a mixture exits a manifold body. In some embodiments, outlet 712 may be configured to discharge a mixture from manifold body 704, wherein outlet 712 may be positioned at a downstream portion of manifold body 704 relative to designated channel, or outlet 712 may be positioned at an upstream portion of manifold body 704 depending on a configuration of designated channel. In some embodiments, outlet 712 may include a geometry configured to facilitate discharge of the mixture, wherein outlet 712 may comprise a cylindrical opening aligned with designated channel or may include an expanded or tapered region configured to modify exit conditions. For example, and without limitation, outlet 712 may include a diverging section configured to decelerate the mixture prior to discharge. In some embodiments, outlet 712 may include a connection feature configured to couple to a downstream conduit, wherein outlet 712 may include threads, barbs, or quick-connect interfaces. For example, and without limitation, outlet 712 may be configured to connect to a hose, nozzle, or distribution line. In some embodiments, outlet 712 may be configured to direct the mixture toward a target location, wherein outlet 712 may include a directional feature configured to guide flow. For example, and without limitation, outlet 712 may include a nozzle portion configured to shape a discharge pattern.

With continued reference to FIG. 7, in some embodiments, inlet 708 and outlet 712 may be aligned with one another or offset relative to one another, wherein inlet 708 and outlet 712 may define a straight-through configuration or a bent or curved flow path through manifold body 704. For example, and without limitation, inlet 708 and outlet 712 may be arranged coaxially or may be arranged at an angle relative to one another. In some embodiments, inlet 708 and outlet 712 may be configured to support different operating conditions, wherein inlet 708 may receive fluid at a higher pressure than a pressure at outlet 712. In some embodiments, inlet 708 and outlet 712 may be formed as integral features of manifold body 704 during manufacturing, wherein inlet 708 and outlet 712 may be machined, molded, or additively manufactured as part of manifold body 704.

With continued reference to FIG. 7, apparatus 700 includes a fluid providing valve 716 fluidly coupled to inlet 708. For the purposes of this disclosure, “fluid providing valve” is an electrically actuated valve configured to selectively permit or block fluid flow. Fluid providing valve 716 is configured to selectively provide the fluid to manifold body 704. In some embodiments, fluid providing valve 716 may be positioned upstream of inlet 708 and may receive fluid from a pressurized supply line. As a non-limiting example, fluid providing valve 716 may transition between an open state permitting flow and a closed state preventing flow in response to an electrical signal. In some embodiments, fluid providing valve 716 may be configured to selectively provide a fluid to manifold body 704 by controlling flow into designated channel. In some cases, fluid providing valve 716 may include an electrically actuated valve that transitions between at least an open state permitting fluid flow and a closed state preventing fluid flow in response to an electrical signal. As a non-limiting example, fluid providing valve 716 may include solenoid valve, piezo valve, and the like. In some embodiments, fluid providing valve 716 may be positioned along a fluid supply path upstream of designated channel, wherein fluid providing valve 716 may control whether fluid is introduced into manifold body 704. In some embodiments, fluid providing valve 716 may include an electromagnetic coil, a movable plunger, and a valve seat, wherein energizing the electromagnetic coil causes the plunger to move relative to the valve seat to permit fluid flow, and de-energizing the electromagnetic coil causes the plunger to return to a position restricting fluid flow. For example, and without limitation, fluid providing valve 716 may include a normally closed configuration in which fluid flow is blocked in the absence of electrical power and permitted when the fluid providing valve 716 is energized, or fluid providing valve 716 may include a normally open configuration in which fluid flow is permitted in the absence of electrical power and blocked when energized. In some embodiments, fluid providing valve 716 may be configured for rapid actuation to enable precise control of fluid delivery timing. For example, and without limitation, fluid providing valve 716 may be actuated in response to a control signal from a controller to initiate or terminate fluid flow within a predetermined time interval. In some embodiments, fluid providing valve 716 may be configured to operate under a range of fluid pressures, wherein fluid providing valve 716 may be selected based on pressure ratings corresponding to a fluid supply. In some embodiments, fluid providing valve 716 may include internal sealing elements configured to prevent leakage when in a closed state. For example, and without limitation, fluid providing valve 716 may include elastomeric seals or seats configured to provide a fluid-tight seal. In some embodiments, fluid providing valve 716 may be configured to be controlled by a controller, wherein fluid providing valve 716 may receive electrical signals corresponding to operational conditions. In some embodiments, fluid providing valve 716 may be actuated based on sensor data to enable or disable fluid flow. For example, and without limitation, fluid providing valve 716 may be closed in response to detection of an unsuitable fluid condition or opened when a mixing operation is initiated. In some embodiments, fluid providing valve 716 may be configured to operate in coordination with other flow control components to provide controlled delivery of fluid into designated channel.

With continued reference to FIG. 7, in some embodiments, components of apparatus 700 may be described as being fluidly coupled to one another to define a fluid communication path. For the purposes of this disclosure, “fluidly coupled” is a relationship between two or more components in which a fluid is capable of flowing between the components, either directly or through one or more intermediate structures, such that the components are in fluid communication. In some embodiments, fluidly coupled components may be directly connected without intervening elements, wherein a first component is physically joined to a second component such that fluid flows between them through a shared interface. For example, and without limitation, a conduit may be directly attached to a port such that fluid passes from the conduit into the port without passing through additional components. In some embodiments, fluidly coupled components may be indirectly connected, wherein one or more intermediate components are positioned between the components while still permitting fluid flow. For example, and without limitation, a valve, sensor, or conduit may be positioned between two components, and the components may still be fluidly coupled because fluid flows through the intermediate component. In some embodiments, fluidly coupled components may be connected via rigid structures such as pipes or channels. In some embodiments, fluidly coupled components may be connected via flexible structures such as hoses or tubing. For example, and without limitation, fluidly coupled components may be connected using elastomeric tubing configured to transport fluid between the components. In some embodiments, fluidly coupled components may be connected using detachable or permanent interfaces. For example, and without limitation, fluidly coupled components may be connected using threaded fittings, barbed connectors, compression fittings, or quick-connect interfaces. In some embodiments, fluidly coupled components may be arranged such that fluid flows in a unidirectional manner. In some embodiments, fluidly coupled components may permit bidirectional flow depending on operating conditions. For example, and without limitation, a check valve may be included within a fluidly coupled path to restrict flow to a single direction. In some embodiments, fluidly coupled components may be configured to maintain a sealed fluid path to prevent leakage. For example, and without limitation, seals, gaskets, or O-rings may be used to maintain fluid integrity between fluidly coupled components. In some embodiments, fluidly coupled components may be configured to accommodate different fluid pressures and flow rates while maintaining fluid communication between the components.

With continued reference to FIG. 7, in some embodiments, fluid may be configured to be received at inlet 708 and conveyed through designated channel for combination with an active agent. In some cases, fluid may include liquids, gases, or mixtures thereof. In some embodiments, the fluid may include a liquid. In some embodiments, the fluid may include water. For example, and without limitation, the fluid may include potable water, deionized water, distilled water, or recycled water. In some embodiments, the fluid may include a solution or mixture of multiple substances. For example, and without limitation, the fluid may include water combined with dissolved minerals, salts, or additives. In some embodiments, the fluid may comprise a gas. For example, and without limitation, the fluid may include air or another compressible gas introduced into the system. In some embodiments, the fluid may include a multiphase substance including both liquid and gas components. For example, and without limitation, the fluid may include a liquid containing entrained air bubbles. In some embodiments, the fluid may be provided at a range of pressures. In some embodiments, the fluid may be supplied at a relatively high pressure to facilitate movement through designated channel. For example, and without limitation, the fluid may be provided at pressures sufficient to induce flow through internal passages of manifold body 704. In some embodiments, the fluid may be provided at a controlled flow rate. In some embodiments, the fluid may have a viscosity that affects flow characteristics within designated channel. For example, and without limitation, the fluid may comprise a low-viscosity liquid such as water or a higher-viscosity liquid such as a solution containing suspended materials. In some embodiments, the fluid may include additional properties that influence interaction with an active agent. In some embodiments, the fluid may have a pH value within a specified range. In some embodiments, the fluid may contain impurities or dissolved substances that affect compatibility with the active agent. For example, and without limitation, the fluid may include ions, organic compounds, or particulates. In some embodiments, the fluid may be conditioned prior to entering designated channel. For example, and without limitation, the fluid may be filtered, heated, cooled, or otherwise treated prior to introduction. In some embodiments, the fluid may be selected based on a desired application of the mixture generated at outlet 712. For example, and without limitation, the fluid may be selected to serve as a carrier for a cleaning agent, a disinfectant, or another active substance. In some embodiments, the fluid may be compatible with the active agent to ensure effective mixing and performance of the resulting mixture.

With continued reference to FIG. 7, apparatus 700 includes a modulating valve 720 fluidly coupled to inlet 708. For the purposes of this disclosure, “modulating valve” is a valve configured to regulate a magnitude of fluid flow through variable positioning of a flow restriction element. Modulating valve 720 is configured to regulate a flow of the fluid into designated channel. In some embodiments, modulating valve 720 may comprise a proportional valve configured to continuously vary flow rate. For example, and without limitation, modulating valve 720 may adjust an internal aperture to control the flow of the fluid entering designated channel. In some embodiments, modulating valve 720 may be configured to regulate a flow of a fluid into designated channel by varying a degree of flow restriction within a fluid path. In some embodiments, modulating valve 720 may be positioned upstream of designated channel and downstream of inlet 708, wherein modulating valve 720 may control a magnitude of fluid flow delivered into manifold body 704. As a non-limiting example, modulating valve 720 may be positioned between a first pressure sensor 724a and a flow sensor as described in detail below. In some embodiments, modulating valve 720 may include a movable flow control element configured to adjust an effective flow area. For example, and without limitation, modulating valve 720 may include a needle, diaphragm, gate, or ball configured to vary a passage through which the fluid flows. In some embodiments, modulating valve 720 may be configured to operate in response to a control signal received from controller, wherein modulating valve 720 may adjust fluid flow based on sensor data. In some embodiments, modulating valve 720 may be configured to provide fine-grained control of flow rate to achieve a desired operating condition within designated channel. For example, and without limitation, modulating valve 720 may be adjusted incrementally to maintain a target flow rate measured by flow sensor 728. In some embodiments, modulating valve 720 may comprise a proportional valve configured to continuously vary flow rate in proportion to an input signal, or modulating valve 720 may comprise an electronically controlled valve configured to adjust position based on an electrical control signal. For example, and without limitation, modulating valve 720 may include a motor-driven actuator or a piezoelectric actuator configured to position a flow control element. In some embodiments, modulating valve 720 may be configured to operate under a range of pressures and flow conditions, wherein modulating valve 720 may be configured to maintain a desired downstream pressure or flow rate within designated channel. For example, and without limitation, modulating valve 720 may adjust flow in response to pressure variations detected within manifold body 704. In some embodiments, modulating valve 720 may be configured to cooperate with fluid providing valve 716 to control fluid delivery, wherein fluid providing valve 716 may provide on/off control and modulating valve 720 may provide variable flow control. For example, and without limitation, fluid providing valve 716 may be opened to initiate flow and modulating valve 720 may then adjust the flow rate to a desired level. In some embodiments, modulating valve 720 may be configured to reduce fluctuations in flow, wherein modulating valve 720 may provide smoothing or stabilization of fluid flow entering designated channel. For example, and without limitation, modulating valve 720 may dampen pressure spikes or flow oscillations. In some embodiments, modulating valve 720 may be constructed from materials selected to withstand exposure to the fluid, wherein modulating valve 720 may include metal, polymer, or composite materials compatible with the fluid and operating conditions. In some embodiments, modulating valve 720 may be configured to be calibrated to achieve specific flow characteristics, wherein modulating valve 720 may be adjusted during setup or operation to match desired system performance. For example, and without limitation, modulating valve 720 may be tuned to achieve a specific flow rate corresponding to a desired mixture output.

With continued reference to FIG. 7, apparatus 700 includes a plurality of pressure sensors 724a-c integrated with manifold body 704. For the purposes of this disclosure, “pressure sensors” are sensing devices configured to measure pressure at respective locations within an apparatus. Pressure sensors 724a-c are configured to monitor a pressure associated with at least one of inlet 708, soap port 732, and outlet 712. In some embodiments, pressure sensors 724a-c may include a first pressure sensor 724a disposed between inlet 708 and modulating valve 720, a second pressure sensor 724b disposed at soap port 732, and a third pressure sensor 724c disposed at outlet 712. As a non-limiting example, pressure sensors 724a-c may include piezoresistive sensors or capacitive pressure sensors. In some embodiments, pressure sensors 724a-c may be configured to generate electrical signals corresponding to measured pressure values, wherein the electrical signals may be transmitted to controller for processing. In some embodiments, pressure sensors 724a-c may be configured to provide real-time monitoring of pressure conditions within manifold body 704. For example, and without limitation, pressure sensors 724a-c may continuously measure pressure during operation to detect changes in flow conditions. In some embodiments, pressure sensors 724a-c may be configured to detect pressure differentials between locations within apparatus 700. For example, and without limitation, a difference between measurements from first pressure sensor 724a and third pressure sensor 724c may be used to determine a pressure drop across designated channel. In some embodiments, pressure sensors 724a-c may be configured to facilitate detection of abnormal operating conditions. For example, and without limitation, pressure sensors 724a-c may detect a pressure increase indicative of a blockage or a pressure decrease indicative of a leak. In some embodiments, pressure sensors 724a-c may be configured to assist in regulating operation of apparatus 700, wherein controller may adjust one or more components based on measured pressure values. For example, and without limitation, controller may modify operation of a valve in response to pressure data to maintain a desired operating condition. In some embodiments, pressure sensors 724a-c may be configured to operate across a range of pressures and fluid types, wherein pressure sensors 724a-c may be selected based on compatibility with operating conditions. In some embodiments, pressure sensors 724a-c may be integrated within manifold body 704 such that sensing elements are positioned in fluid communication with internal passages. In some embodiments, pressure sensors 724a-c may be mounted externally and connected via pressure ports. For example, and without limitation, pressure sensors 724a-c may be coupled to pressure taps formed in manifold body 704. In some embodiments, pressure sensors 724a-c may be configured to have a response time suitable for detecting rapid pressure changes. For example, and without limitation, pressure sensors 724a-c may be configured to detect transient pressure spikes or drops during operation. In some embodiments, pressure sensors 724a-c may be configured to provide data for calibration or diagnostics of apparatus 700, wherein pressure measurements may be used to evaluate performance or identify maintenance needs.

With continued reference to FIG. 7, apparatus 700 includes a flow sensor 728 fluidly coupled downstream of modulating valve 720. For the purposes of this disclosure, “flow sensor” is a sensing device configured to measure a flow rate of a fluid. Flow sensor 728 is configured to measure a flow rate of the fluid. In some embodiments, flow sensor 728 may be configured to measure a flow rate of a fluid within a fluid path and generate corresponding sensor data. In some embodiments, flow sensor 728 may generate sensor data corresponding to volumetric flow rate, mass flow rate, or velocity of the fluid entering designated channel. As a non-limiting example, flow sensor 728 may include a turbine flow meter, an ultrasonic flow sensor, or a thermal mass flow sensor. In some embodiments, flow sensor 728 may be positioned along a fluid path upstream of designated channel or downstream of a flow control component, wherein flow sensor 728 may monitor fluid entering manifold body 704. In some embodiments, flow sensor 728 may be configured to provide real-time measurements of fluid flow. For example, and without limitation, flow sensor 728 may generate a signal proportional to a rate at which fluid passes through a sensing region. In some embodiments, flow sensor 728 may comprise a turbine flow sensor, wherein rotation of a turbine element corresponds to a flow rate of the fluid. In some embodiments, flow sensor 728 may comprise an ultrasonic flow sensor configured to measure flow based on propagation of ultrasonic signals through the fluid. In some embodiments, flow sensor 728 may comprise a thermal mass flow sensor configured to determine flow rate based on heat transfer characteristics of the fluid. For example, and without limitation, flow sensor 728 may detect changes in temperature distribution caused by fluid movement to determine flow rate. In some embodiments, flow sensor 728 may be configured to operate across a range of fluid types, pressures, and viscosities, wherein flow sensor 728 may be selected based on compatibility with a particular fluid. In some embodiments, flow sensor 728 may be configured to output data to controller, wherein controller may process the data to monitor system performance. For example, and without limitation, controller may adjust operation of one or more valves based on a measured flow rate to maintain a desired operating condition. In some embodiments, flow sensor 728 may be configured to detect anomalies in fluid flow, wherein flow sensor 728 may indicate conditions such as reduced flow, blockage, or unexpected increases in flow rate. For example, and without limitation, flow sensor 728 may detect a deviation from an expected flow profile and provide corresponding data to controller. In some embodiments, flow sensor 728 may be integrated into manifold body 704 or may be coupled to a conduit external to manifold body 704. In some embodiments, flow sensor 728 may be configured to maintain minimal pressure loss while measuring flow, wherein flow sensor 728 may include a low-profile sensing structure that does not substantially obstruct fluid flow.

With continued reference to FIG. 7, in some embodiments, flow rate may be used to characterize movement of a fluid through a fluid path. For the purposes of this disclosure, “flow rate” is a quantity of a fluid that passes through a defined cross-sectional area per unit time. In some embodiments, flow rate may be expressed as a volumetric flow rate representing a volume of fluid per unit time. For example, and without limitation, flow rate may be expressed in units of liters per minute, gallons per minute, or cubic meters per second. In some embodiments, flow rate may be expressed as a mass flow rate representing a mass of fluid per unit time. For example, and without limitation, flow rate may be expressed in units of kilograms per second or pounds per minute. In some embodiments, flow rate may be related to a velocity of the fluid and a cross-sectional area through which the fluid flows. For example, and without limitation, flow rate may be determined based on a product of fluid velocity and cross-sectional area of a passage. In some embodiments, flow rate may vary based on operating conditions such as pressure, temperature, and fluid properties. For example, and without limitation, flow rate may increase with increased pressure differential across a passage or may decrease with increased fluid viscosity. In some embodiments, flow rate may be monitored to control operation of apparatus 700, wherein a controller may adjust one or more components based on measured flow rate to maintain a desired operating condition.

With continued reference to FIG. 7, apparatus 700 includes a soap port 732 formed in manifold body 704. For the purposes of this disclosure, “soap port” is an opening in a manifold body configured to receive an active agent. Soap port 732 is configured to receive the active agent. In some embodiments, soap port 732 may be coupled to tubing or a conduit delivering the active agent from a reservoir. In some embodiments, soap port 732 may be formed as an aperture extending from an external surface of manifold body 704 to an internal region. In some embodiments, soap port 732 may be configured to fluidly communicate with an internal passage such that the active agent is introduced into the fluid. For example, and without limitation, soap port 732 may intersect an internal passage at a defined location to enable delivery of the active agent into a flowing stream. In some embodiments, soap port 732 may be configured to receive the active agent from a reservoir or supply line. In some embodiments, soap port 732 may include a connection feature configured to couple to a conduit delivering the active agent. For example, and without limitation, soap port 732 may include threads, barbs, compression fittings, or quick-connect interfaces to facilitate connection to tubing or hoses. In some embodiments, soap port 732 may be oriented at an angle relative to an internal flow path to influence introduction of the active agent. For example, and without limitation, soap port 732 may be oriented substantially perpendicular to a primary flow direction or may be oriented at an acute angle to promote entrainment of the active agent. In some embodiments, soap port 732 may include an internal passage configured to guide the active agent into the fluid path. In some embodiments, soap port 732 may include a restricted opening configured to control a rate at which the active agent is introduced. For example, and without limitation, soap port 732 may include a nozzle or orifice configured to meter the active agent.

With continued reference to FIG. 7, a check valve assembly is disposed at soap port 732 and is configured to permit one-way flow of the active agent into designated channel. For the purposes of this disclosure, “check valve assembly” is a valve structure configured to permit fluid flow in a first direction and restrict fluid flow in an opposite direction. In some embodiments, check valve assembly may be positioned at an interface where an active agent is introduced into a fluid path, wherein check valve assembly may prevent fluid from flowing backward toward a source of the active agent. In some embodiments, check valve assembly may include a movable sealing element configured to transition between an open position permitting forward flow and a closed position preventing reverse flow. For example, and without limitation, check valve assembly may include a spring-biased poppet, ball, diaphragm, or flap configured to move in response to a pressure differential. In some embodiments, check valve assembly may be configured such that a forward flow pressure overcomes a biasing force to open the valve, while a reverse pressure causes the valve to close and seal against a valve seat. For the purposes of this disclosure, “spring-biased valve” is a valve comprising a movable sealing element and a spring configured to apply a force to the movable sealing element to maintain the valve in a default position until a threshold pressure is applied. For example, and without limitation, a spring-biased valve may include a spring configured to urge a sealing element toward a closed position, wherein forward flow compresses the spring to permit passage of fluid. In some embodiments, check valve assembly may be configured to provide a cracking pressure corresponding to a minimum pressure required to initiate opening of the valve. In some embodiments, check valve assembly may be configured to minimize leakage when in a closed state, wherein sealing surfaces may be designed to provide a fluid-tight seal. For example, and without limitation, check valve assembly may include elastomeric seals or precision-machined surfaces configured to reduce leakage. In some embodiments, check valve assembly may be configured to operate with different types of fluids, including liquids having varying viscosities or containing particulates. For example, and without limitation, check valve assembly may be selected to accommodate fluids containing dissolved or suspended materials without clogging. In some embodiments, check valve assembly may be integrated within a structure or may be provided as a separate component coupled to the structure. In some embodiments, check valve assembly may be configured to respond rapidly to changes in flow direction, thereby preventing contamination or backflow. For example, and without limitation, check valve assembly may close automatically when forward flow ceases or when reverse pressure is detected. In some embodiments, check valve assembly may be configured to protect upstream components from exposure to downstream fluid conditions by restricting reverse flow.

With continued reference to FIG. 7, in some embodiments, active agent may be configured to be combined with a fluid to produce a mixture having one or more functional properties. In some embodiments, the active agent may comprise a liquid substance. In some embodiments, the active agent may comprise a cleaning agent. For example, and without limitation, the active agent may include a detergent, soap, or degreasing solution configured to remove contaminants. In some embodiments, the active agent may comprise a disinfecting or sanitizing agent. For example, and without limitation, the active agent may include an antimicrobial solution, a bleach-based compound, or an alcohol-based solution configured to reduce or eliminate microorganisms. In some embodiments, the active agent may comprise a chemical additive configured to modify properties of the fluid. For example, and without limitation, the active agent may include a surfactant configured to reduce surface tension, a foaming agent configured to generate foam, or a corrosion inhibitor configured to protect surfaces. In some embodiments, the active agent may comprise a concentrated formulation configured to be diluted by the fluid to achieve a desired concentration. For example, and without limitation, the active agent may be stored in a concentrated form and introduced into the fluid at a controlled ratio to produce a usable solution. In some embodiments, the active agent may have properties such as viscosity, density, or reactivity that influence mixing behavior. For example, and without limitation, the active agent may comprise a higher-viscosity liquid that requires sufficient suction or flow conditions to be entrained into the fluid. In some embodiments, the active agent may be selected based on compatibility with the fluid. In some embodiments, the active agent may react with the fluid to produce a desired effect or may remain chemically stable within the fluid. For example, and without limitation, the active agent may be selected to avoid undesirable reactions such as precipitation or degradation when combined with the fluid. In some embodiments, the active agent may be delivered from a reservoir or supply system and introduced into a fluid path at a controlled rate. In some embodiments, the active agent may be configured to produce a mixture having cleaning, foaming, disinfecting, or other functional characteristics upon combination with the fluid. In some embodiments, soap port 732 may be configured to withstand exposure to the active agent, wherein materials of soap port 732 may be selected for chemical compatibility. In some embodiments, soap port 732 may be formed integrally with manifold body 704 during manufacturing or may be formed as a separate component coupled to manifold body 704. In some embodiments, soap port 732 may be configured to allow maintenance or cleaning, wherein soap port 732 may be accessible for flushing or inspection.

With continued reference to FIG. 7, in some embodiments, a soap tube 736 may be configured to transport an active agent from a source to soap port 732. For the purposes of this disclosure, “soap tube” is a conduit configured to convey an active agent between components of a system. In some embodiments, the soap tube 736 may comprise flexible tubing configured to accommodate routing within a system. In some embodiments, the soap tube 736 may comprise a rigid conduit configured to maintain a fixed geometry. For example, and without limitation, the soap tube 736 may include polymer tubing, elastomeric hose, or metal tubing. In some embodiments, the soap tube 736 may be configured to withstand exposure to the active agent, wherein materials of the soap tube 736 may be selected based on chemical compatibility. In some embodiments, the soap tube 736 may be configured to deliver the active agent at a controlled flow rate. For example, and without limitation, the soap tube 736 may be coupled to a pump or flow control component to regulate delivery. In some embodiments, the soap tube 736 may be configured to be removably connected to soap port 732 to facilitate maintenance or replacement.

With continued reference to FIG. 7, apparatus 700 includes an injector system 740 disposed within designated channel. For the purposes of this disclosure, “injector system” is a structure configured to induce flow of an active agent into a fluid stream by generating a pressure differential. Injector system 740 is configured to increase a velocity of the fluid flowing through designated channel and generate a suction force that draws the active agent from soap port 732 into designated channel. In some embodiments, injector system 740 may be positioned at a mixing region within designated channel. In some embodiments, injector system 740 may include a venturi injector including an orifice configured to increase the velocity of the fluid flowing through designated channel. For the purposes of this disclosure, “venturi injector” is a structure configured to generate a pressure differential that draws another fluid into a moving fluid stream. In some cases, venturi injector may include a converging section, a throat region, and a diverging section arranged to increase a velocity of a fluid and decrease a pressure at the throat region. For the purposes of this disclosure, “orifice” is a restriction having a defined opening through which a fluid flows, the restriction being configured to alter at least one of a velocity, pressure, and flow rate of the fluid. As a non-limiting example, the venturi injector may include a converging section, a throat region, and a diverging section configured to create a localized pressure drop. In some embodiments, injector system 740 may be configured such that the pressure at the throat region is lower than a pressure at soap port 732, thereby causing the active agent to be drawn into designated channel due to the pressure differential. In some embodiments, injector system 740 may be configured to regulate an amount of suction generated based on a geometry of the orifice and surrounding flow path. For example, and without limitation, a diameter of the throat region may be selected to control a magnitude of the pressure drop and corresponding suction force. In some embodiments, injector system 740 may be configured to operate across a range of flow rates, wherein a higher fluid velocity may result in increased suction force and increased entrainment of the active agent. In some embodiments, injector system 740 may include multiple stages or regions configured to progressively increase fluid velocity and enhance mixing. For example, and without limitation, injector system 740 may include a first constriction region followed by a second constriction region to amplify suction effects. In some embodiments, injector system 740 may be configured to introduce the active agent into the fluid stream at a location corresponding to a region of reduced pressure and increased turbulence. In some embodiments, injector system 740 may be configured to promote mixing downstream of the injection point. For example, and without limitation, injector system 740 may be configured to generate vortices or turbulent flow patterns that enhance dispersion of the active agent within the fluid. In some embodiments, injector system 740 may be formed integrally within designated channel as part of manifold body 704. In some embodiments, injector system 740 may be formed as a separate insert or component positioned within designated channel. For example, and without limitation, injector system 740 may comprise a removable insert configured to be replaced or serviced. In some embodiments, injector system 740 may be configured to operate without moving parts, thereby reducing mechanical complexity and increasing reliability. In some embodiments, injector system 740 may be configured to minimize pressure loss downstream of the mixing region while still providing sufficient suction to draw the active agent. For example, and without limitation, a diverging section of injector system 740 may be configured to recover pressure following the throat region. In some embodiments, injector system 740 may be configured to accommodate different types of active agents having varying viscosities, wherein geometry of injector system 740 may be selected to ensure sufficient suction for entrainment of higher-viscosity substances. In some embodiments, injector system 740 may be configured to provide consistent entrainment of the active agent under varying operating conditions, thereby enabling controlled and repeatable mixing within designated channel.

With continued reference to FIG. 7, apparatus 700 may include a controller communicatively coupled to at least one of flow sensor 728, pressure sensors 724a-c, fluid providing valve 716, or modulating valve 720. For the purposes of this disclosure, “controller” is a computing device configured to receive data and generate control signals. The controller may be configured to control operation of at least one of fluid providing valve 716 or modulating valve 720 based on sensor data. In some embodiments, controller may include one or more processors, memory devices, and communication interfaces configured to process and transmit data. In some embodiments, controller may be configured to execute instructions stored in memory to perform control operations. For example, and without limitation, controller may execute a control algorithm configured to maintain a desired flow rate or pressure within apparatus 700. In some embodiments, controller may be configured to receive real-time data from one or more sensors and dynamically adjust operation of components in response to changing conditions. For example, and without limitation, controller may modify operation of fluid providing valve 716 or modulating valve 720 based on detected variations in flow rate or pressure. In some embodiments, controller may be configured to implement feedback control, wherein controller may compare measured values to target values and adjust operation of one or more components to reduce a difference between the measured values and the target values. In some embodiments, controller may be configured to store historical data associated with operation of apparatus 700. For example, and without limitation, controller may record flow rates, pressure values, or operational states for diagnostic or optimization purposes. In some embodiments, controller may be configured to communicate with external systems or devices. For example, and without limitation, controller may transmit data to a remote system or receive control inputs from an external interface. In some embodiments, controller may be configured to initiate or terminate operation of apparatus 700 based on predefined conditions. For example, and without limitation, controller may close fluid providing valve 716 when a fault condition is detected or may enable operation when system parameters are within acceptable ranges. In some embodiments, controller may be configured to coordinate operation of multiple components to achieve a desired system performance. For example, and without limitation, controller may simultaneously adjust flow control and monitor pressure to maintain consistent mixture generation. In some embodiments, controller may be implemented as a dedicated hardware device or as part of a distributed control system. For example, and without limitation, controller may be implemented as a microcontroller, programmable logic controller, or embedded computing system.

With continued reference to FIG. 7, in some embodiments, the controller may determine a ratio of the fluid to the active agent based on the sensor data. For example, and without limitation, the controller may adjust modulating valve 720 to maintain a target dilution ratio. In some embodiments, a ratio of the fluid to the active agent may be used to characterize a relative proportion of the fluid and the active agent within a mixture. For the purposes of this disclosure, “ratio of the fluid to the active agent” is a quantitative relationship representing an amount of the fluid relative to an amount of the active agent in a mixture. In some embodiments, the ratio may be expressed as a volumetric ratio. For example, and without limitation, the ratio of the fluid to the active agent may be expressed as a ratio of volumes, such as 70:7, indicating ten units of fluid for every one unit of active agent. In some embodiments, the ratio may be expressed as a mass-based ratio representing a mass of the fluid relative to a mass of the active agent. For example, and without limitation, the ratio may be expressed in units such as kilograms of fluid per kilogram of active agent. In some embodiments, the ratio may be determined based on flow rates of the fluid and the active agent. For example, and without limitation, the ratio may be calculated by dividing a flow rate of the fluid by a flow rate of the active agent. In some embodiments, the ratio may be adjusted to achieve a desired concentration or performance characteristic of the mixture. For example, and without limitation, a higher proportion of the active agent may increase cleaning effectiveness, while a lower proportion may reduce chemical usage. In some embodiments, the ratio may be controlled by controller based on sensor data. For example, and without limitation, controller may adjust one or more components to maintain a target ratio during operation. In some embodiments, the ratio may vary dynamically in response to changing operating conditions or system requirements.

With continued reference to FIG. 7, in some embodiments, sensor data may be generated by one or more sensing devices and utilized by controller to monitor and control operation of apparatus 700. For the purposes of this disclosure, “sensor data” is information produced by one or more sensors that represents a measured parameter associated with operation of a system. The sensor data may include a measured physical parameter. In some embodiments, sensor data may include measurements corresponding to flow rate, pressure, temperature, or other measurable properties of a fluid or system components. For example, and without limitation, sensor data may include a signal representing a flow rate measured by flow sensor 728 or a pressure value measured by one or more of pressure sensors 724a-c. In some embodiments, sensor data may be generated in real time and continuously updated during operation of apparatus 700. In some embodiments, sensor data may be transmitted to controller in the form of electrical signals, digital values, or encoded information. For example, and without limitation, sensor data may comprise analog voltage signals, current signals, or digital communication signals corresponding to measured parameters. In some embodiments, sensor data may be processed by controller to derive additional information. For example, and without limitation, controller may calculate a ratio of fluid to active agent based on flow rate and pressure data. In some embodiments, sensor data may be used to detect changes in operating conditions. For example, and without limitation, sensor data may indicate a deviation from a target flow rate, a pressure fluctuation, or an abnormal system condition. In some embodiments, sensor data may be used to implement feedback control, wherein controller may adjust operation of one or more components in response to differences between measured values and desired values. In some embodiments, sensor data may be stored for later analysis or diagnostics. For example, and without limitation, historical sensor data may be analyzed to identify trends, performance characteristics, or maintenance needs. In some embodiments, sensor data may be filtered, averaged, or otherwise processed to reduce noise or improve accuracy. For example, and without limitation, controller may apply smoothing or calibration techniques to sensor data prior to using the data for control decisions. In some embodiments, sensor data may be used to trigger alerts or protective actions. For example, and without limitation, controller may initiate a shutdown or adjust system operation when sensor data indicates a fault condition or unsafe parameter.

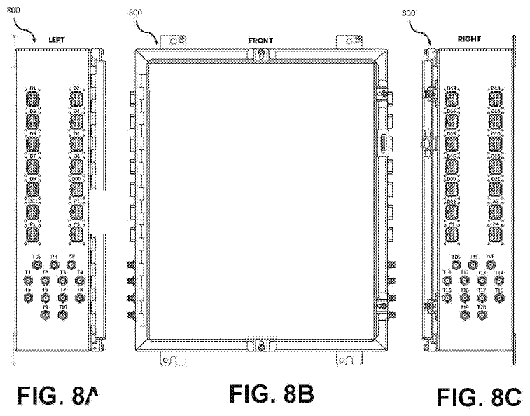

Referring now to FIGS. 8A-C, an exemplary embodiment of a controller 800 is described. In some cases, controller 800 may be consistent with processor 112 described with respect to FIG. 1. In one or more embodiments, Controller 800 might exist as a single controller that operates both skids, or multiple controllers that exist external or internal to each skid, controlling individual skids in concert with each other, with or without orchestration by an attached server. In one or more embodiments, controller 800 may include any controller as described in this disclosure. In one or more embodiments, controller 800 may be communicatively connected to operating system and configured to receive data from operating system. In one or more embodiments, controller 800 may be configured to receive information from water solenoid, pressure sensor, flow meter, outlet pressure sensor, soap pressure sensor and/or any other sensors and/or electromechanics devices. In one or more embodiments, controller 800 may be configured to control a flow of active agent and/or fluid by manipulating valves, peristaltic pumps and/or the like. In one or more embodiments, controller 800 may receive a datum from level sensors, pressure sensors and/or the like and generate commands to various components of operating system to increase pressure, increase flow rate and/or the like. In one or more embodiments, controller 800 may be configured to communicate with a remote device to transmit notifications associated with pressure buildup, changes in flow rate, changes in PH levels and/or the like.

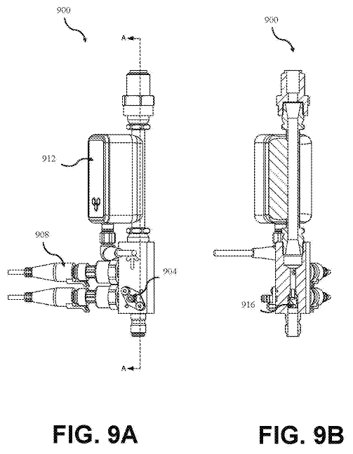

Referring now to FIGS. 9A-B, an exemplary embodiment of a soap channel 900 is described. FIG. 9A illustrates the soap channel and FIG. 9B illustrates a cross sectional view of the soap channel. In one or more embodiments, soap channel 900 may include a designated channel in which water or a fluid enters an inlet of designated channel and a mixture of water and active agent exit through an outlet of designated channel. In one or more embodiments designated channel may include a portion of an ultrasonic flow sensor. In one or more embodiments, some ultrasonic flow meter design, particularly in-line flow meters, a sensor comes with a built-in pipe section already integrated into the device. As a result, designated channel may be integrated into the flow meters wherein the built-in pipe may include designated channel and/or a portion thereof. This means the flow meter is not just attached to designated channel, but it is part and/or a portion of the designated channel. Fluid flows through the internal passage of the designated channel, wherein designated channel may be connected as a medium through which fluid flows through operating system. Inside an integrated section, ultrasonic transducers are positioned to send and receive sound waves across the flow of fluid with designated channel. These waves travel diagonally or directly through the liquid inside the built-in pipe. By measuring how long it takes for the ultrasonic signals to move from one side to the other, the flow meter determines the speed of the fluid, and from that, it calculates the flow rate. In one or more embodiments, soap channel 900 may include a soap port 904. In one or more embodiments, soap port 904 may allow for the introduction of soap and/or active agent within soap channel 900. In one or more embodiments, soap port 904 may be fluidly connected to soap tube, wherein active agent may be pumped through peristaltic pump, through soap tube and into soap port 904. In one or mor embodiments, soap channel 900 may include pressure sensors 908 configured to monitor a pressure at soap port 904. In one or more embodiments, pressure sensors 908 may indicate to controller if pressure buildup is occurring within soap part and/or within soap tube connected to soap port 904. In one or more embodiments, soap channel may include an injector system integrated into a soap channel. In one or more embodiments, flow sensor 912 may measure the flow of fluid and/or active agent in order to identify how much fluid is being utilized. In one or more embodiments, a venturi orifice 916 may be situated within a designated channel and/or piping of soap channel and configured to pull active agent through soap port 904. In one or more embodiments, flow meter may indicate a concentration of active agent within fluid by identifying an amount of water entering inlet and an amount of mixture exiting outlet. In one or more embodiments, flow rates of active agent may be monitored and/or recorded using peristaltic pump, while flow rates of fluid may be monitored using flow meter. In one or more embodiments, a flow rate from peristaltic pump and a flow rate from flow meter may be used to identify a dilution ratio. In one or more embodiments, flow meter may include a non-intrusive or clamp-on flow sensor. These sensors typically use ultrasonic or electromagnetic technology to measure flow rates without physically touching the fluid inside. In one or more embodiments, the ultrasonic flow meter may be positioned downstream of the soap mixture, active agent and/or mixture in order to avoid potential damage to the sensor due to high PH and chemicals within active agent. In one or more embodiments, ultrasonic flow sensor and/or flow meter may not contact fluid and/or fluid mixture but rather identify fluid and/or mixture through a separation, such as a wall. These sensors may include two transducers that are clamped to the outside surface of the pipe. They work by sending and receiving ultrasonic sound waves through the pipe wall and the flowing fluid inside. The time it takes for the sound waves to travel with and against the flow is measured, and the difference in transit times is used to calculate the velocity of the fluid. From there, flow rate is derived based on the pipe's internal diameter. In one or more embodiments, flow meter may be situated external to fluid and/or mixture and identify a flow of fluid or mixture within a piping. In one or more embodiments, water flow metering on soap is achieved exclusively through the venturi nozzle's flow orifice, eliminating the need for a separate flow control valve. The orifice is precisely sized to deliver a fixed flow rate, simplifying system architecture and reducing component count. A soap port 904 sensor may be incorporated to monitor conditions that could compromise proper venturi operation. One potential issue is that if inlet water pressure drops below a critical threshold, the venturi may lose suction, resulting in a reversal to positive pressure at the chemical inlet. This condition can disrupt the intended draw of chemical concentrate and potentially force water into the chemical reservoir. Additionally, the system may encounter excessive backpressure at the outlet due to downstream restrictions such as kinked lines or clogged applicators. Under such conditions, the venturi's suction capability can also be impaired. The soap port 904 sensor enables detection of these abnormal pressure states, ensuring operational reliability and proper dilution performance. In one or more embodiments, other embodiments as described in this disclosure may incorporate alternative flow control mechanisms or sensing strategies, depending on application requirements or system complexity.

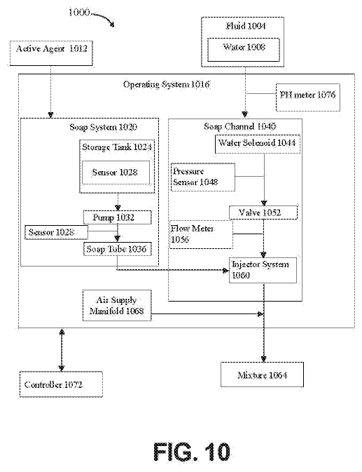

Referring now to FIG. 10, an exemplary system 1000 for creating mixtures is described. In one or more embodiments, mixtures 1064 may include a combination of an active agent 1012 and a fluid 1004 such as water 1008. In one or more embodiments, active agent 1012 may include a cleaning product, such as soap, a mixture of chemicals used for cleaning vehicles and/or the like. In one or more embodiments, active agent 1012 may serve as the primary agent that is needed to clean a vehicle or another component. In one or more embodiments, mixtures 1064 may include a combination of fluid and active agent 1012 with precise amounts, such as for example, an 5% concentration of active agent 1012 within fluid and/or the like.

With continued reference to FIG. 10, system 1000 includes an operating system 1016. In one or more embodiments, operating system 1016 may include any operating system 1016 as described in this disclosure. In one or more embodiments, operating system 1016 includes a soap system 1020. A “soap system” as described in this disclosure refers to one or more components associated with the storage and movement of active agent. In one or more embodiments, soap system 1020 may include one or more storage tanks configured to store active agent 1012. In one or more embodiments, active agents may be poured and/or stored within storage tanks 1024 prior to use by system 1000. In one or more embodiments, storage tanks 1024 may include sensors 1028. In one or more embodiments, sensors 1028 may include any sensors a described in this disclosure. In one or more embodiments, sensors 1028 utilized for storage tanks may include level sensors, ultrasonic sensors and/or the like. In one or more embodiments, sensors 1028 may be used to identify a volumetric datum wherein a volumetric datum includes an amount of active agent within each storage tank. In one or more embodiments, soap system 1020 further includes a pump 1032. In one or more embodiments, pump 1032 may include any pump as described in this disclosure such as a peristaltic pump and/or a gear pump. In one or more embodiments, pump 1032 may be connected to storage tank by way of fluid connection such as through a hose and/or other piping that allows for a fluid to flow from storage tank 1024 as a result of pump 1032. In one or more embodiments, pump 1032 may pump active agent 1012 from storage tank 1024 and through soap tube 1036. In one or more embodiments, soap tube 1036 may include any piping and/or hosing that allows for fluid to flow from storage tank 1024 without leakage. In one or more embodiments, soap tube 1036 may be made of a pliable material such as soft plastic, silicone and/or the like. In one or more embodiments, a sensor 1028 may be located on the soap tube. In one or more embodiments, sensor 1028 on soap tube may include a pressure sensor configured to detect a pressure of active agent within soap tube 1036. In an embodiments, a buildup of pressure within soap tube 1036 may indicate that either pump 1032 is working too hard such that there is buildup, soap tube 1036 has been degraded and therefore flow rate has decreased and/or some other blockage down the line is causing a buildup of active agent 1012 within soap tube 1036 or that downstream backpressure on output has caused the venturi's inlet pressure to reverse, eliminating the suction we expect during normal operation.

With continued reference to FIG. 10, operating system 1016 further includes a soap channel 1040. Soap channel 1040 includes any soap channel as described in this disclosure. In one or more embodiments, soap channel may be configured to route fluid 1004 through soap channel which may then be used to mix with active agent 1012. In one or more embodiments, an inlet of soap channel may include a water solenoid 1044. In one or more embodiments, water solenoid may include any solenoid 1044 as described in this disclosure. In one or more embodiments, fluid 1004 may be received from a city water line, a water tank connected to operating system 1016 and/or the like. In one or more embodiments, water solenoid may control a flow of fluid 1004 into operating system 1016. In one or more embodiments, water solenoid may be configured to provide a flow of fluid 1004 into operating system 1016. In one or more embodiments, a solenoid valve such as water solenoid 1044 may include an electromechanically operated valve. It may be controlled by an electric current (usually through a coil) which generates a magnetic field, causing the valve to open or close. In one or more embodiments, system 1000 may include a PH meter 1076. In one or more embodiments, PH meter 1076 may be configured to identify a PH of fluid 1004 prior to entry within soap channel. In one or more embodiments, information from PH meter may be transferred to a computing device, wherein the computing device (such as a controller as described in this disclosure) may be configured to identify a PH of the fluid and determine if the fluid is suitable for use. In an embodiment, a fluid containing a differing PH may interact negatively with active agent 1012.

With continued reference to FIG. 10, soap channel further includes a valve 1052. In one or more embodiments, valve 1052 may include any valve as described in this disclosure. In one or more embodiments, valve 1052 may be configured to control a flow or flow rate of fluid through soap channel 1040. In one or more embodiments, valve may be electromechanically operated, wherein valve 1052 may be operated through the use of commands transmitted by a controller 1072. In one or more embodiments, soap channel 1040 may contain a pressure sensor 1048 situated prior to valve and after water solenoid. In one or more embodiments, pressure sensor 1048 may monitor a pressure of fluid exiting water solenoid 1044 and entering valve 1052. In one or more embodiments, pressure sensor may be used to identify pressure drops from fluid entering through water solenoid. In one or more embodiments, fluid from valve 1052 may flow through soap channel 1040. In one or more embodiments, a flow meter 1056, such as any flow meter as described in this disclosure may be configured to monitor a flow rate or fluid after valve 1052. In one or more embodiments, a flow rate of fluid 1004 may decrease due to constrictions in flow rate placed by valve 1052. In one or more embodiments, flow meter 1056 may be used to ensure a proper flow rate through soap channel 1040.

With continued reference to FIG. 10, soap tube may be fluidly connected to soap channel 1040. In one or more embodiments, soap tube may be fluidly connected to soap channel such that active agent may flow from soap tube and into soap channel.

With continued reference to FIG. 10, soap channel 1040 further includes an injector system 1060. Injector system 1060 includes any injector system as described in this disclosure. In one or more embodiments, injector system 1060 may include a venturi valve configured to create a pressure differential that can be used to draw active agent from soap tube and into soap channel. A Venturi valve works by using the principles of fluid dynamics, specifically, the Venturi effect, to create a pressure differential that can be used to draw in active agent into a fluid stream of fluid 1004. Inside the Venturi valve is a specially shaped passage that narrows in the middle and then widens again, forming three sections: the inlet, the throat, and the outlet. As fluid 1004 enters the valve through the inlet, it flows into the throat, which is the narrowest part. Due to the constriction, the fluid velocity increases sharply in the throat, and as a result, the static pressure drops significantly in that area. Adjacent to this low-pressure zone is a suction port, where a secondary substance, such as active agent 1012, can be introduced. The drop in pressure at the throat creates a vacuum effect that pulls active agent into the main fluid flow within soap channel 1040. Once inside, the two fluids mix and continue through the expanding outlet section, where the flow slows down and pressure begins to recover. In one or more embodiments, fluid 1004 and active agent 1012 may combine to create mixture 1064 at an outlet of soap channel. In one or more embodiments, operating system 1016 may further include an air supply manifold 1068, wherein the air supply manifold is configured to supply air to the fluid and active agent combination in order to create mixture 1064 having air bubbles and/or foamy properties. In one or more embodiments, air distribution subsystem may allow for mixture to contain foamy properties and this allow for a better solution used to clean vehicles.

With continued reference to FIG. 10, system 1000 includes a controller 1072. Controller 1072 includes any controller as described in this disclosure. In some cases, controller 1072 may be consistent with processor 112 described with respect to FIG. 1. Controller 1072 may be configured to receive a datum from sensors 1028, pressure sensors, flow meters and/or the like in order to ensure that system 1000 is working properly. In one or more embodiments, controller may be configured to increase pressure of pump 1032 as a result of a decrease in active agent entering mixture 1064. In one or more embodiments, controller 1072 may receive flow rate of fluid within soap channel 1040 from flow meter and transmit commands to valve 1052 in order to adjust valve to increase or decrease flow rate. In one or more embodiments, controller may utilize sensor 1028 within soap tube and sensor 1028 within storage tank to identify the rate at which active agent is entering soap channel. This may be done by identifying a change in volume of storage tank using sensor and/or identifying a flow rate of soap using sensors within soap tube 1036. In one or more embodiments, controller 1072 may use a flow rate of active agent 1012 and a flow rate of fluid as identified by flow meter 1056 to identify a concentration of active agent within mixture 1064. In one or more embodiments, changes in concentration may indicate fluid buildup and/or issues with system 1000. In one or more embodiments, operating system 1016 may include a plurality of soap channels 1040 and a plurality of soap systems 1020, wherein each soap system 1020 may contain a correlated soap channel 1040. In one or more embodiments, operating system 1016 may contain a plurality of soap systems 1020, wherein each soap system may be configured for a differing active agent, such as for example, an active agent used for windows of a vehicle, an active agent used for cleaning tires, an active agent used for cleaning various portions of the car and/or the like. In one or more embodiments, controller may be configured to monitor each soap system 1020 and each soap channel 1040 in order to modify and/or adjust flow rates accordingly. In one or more embodiments, system 1000 and/or operating system 1016 may contain redundant components all connected to the same outlet. For example and without limitation, system 1000 may include more than one operating systems 1016, wherein the more than one operating systems 1016 may be used to ensure that mixture may flow in the event of a failure within a first operating system 1016. In one or more embodiments, each operating system 1016 may be connected to the same or similar outlet, such that mixture may be created within either operating system 1016 or reach the same location.

With continued reference to FIG. 10, controller 1072 may be configured to adjust flow rates of fluid and/or active agent in order to ensure proper concentration within mixture 1064. In one or more embodiments, controller 1072 may identify concentration of mixture by receiving a flow rate from flow meter 1056 and calculating flow rate of active agent using sensor within soap tube and/or sensor within storage tanks. In one or more embodiments, controller 1072 may adjust flow rates my increasing a power input of peristaltic pump and thus increasing a flow rate of active agent. In one or more embodiments, controller may identify a flow rate of active agent and increase or decrease power to peristaltic pump in order to adjust flow rate due to degradation of one or more components. In one or more embodiments, controller may further be configured to adjust valve, such that a flow rate of fluid may increase or decrease in order to maintain a desired dilution ration between active agent and fluid within mixture.

With continued reference to FIG. 10, controller 1072 may be configured to identify tube degradation within system 1000. “Tube degradation” as described in this disclosure refers to the capability of an object to continue transfer fluids. For example, and without limitation, soap tube may be configured to navigate active agent to soap channel. However, if soap tube has become degraded, soap tube may lack the ability to continue to transport active agent at the desired flow rate under the same conditions. In one or more embodiments, controller 1072 may be configured to identify a tube degradation, wherein the tube degradation indicates the capability of a tube to transport a fluid such as fluid 1004 and/or active agent. In one or more embodiments, tube degradation may be measured in maximum flow rate, a percentage in comparison to an ideal tube and/or the like. In one or more embodiments, tube degradation may be measured in terms of pressure needed by peristaltic pump to increase flow rate. In one or more embodiments, tube degradation may be measured in terms of increased power output of one or more components of system 1000 needed in order to maintain the same or similar flow rate. For example, tube degradation may be measured at 120%, wherein an increase of 20% of power output may be needed to maintain the desired flow rate. In one or more embodiments, a pump may be operated by a stepper motor wherein RPM of the pump is a known valve. In one or more embodiments, controller 1072 may identify tube degradation by comparing an actual flow rate to an expected flow rate. An “actual flow rate” as described in this disclosure refers to a flow rate that has been calculated based on the use of one or more sensors. An expected flow rate for the purposes of this disclosure refers to a flow rate that is expected under the current power output conditions of system 1000. For example, and without limitation, actual flow rate may be determined by identifying flow rate of active agent 1012 through sensors 1028, by identifying flow rate of fluid through flow meter 1056 and/or by identifying flow rate of mixture using a sensor located at or near mixture. In another nonlimiting example, expected flow rate may include a flow rate that is calculated based on system 1000 working ideally. For example, expected flow rate may include a flow rate of 1 gallon per minute in instances in which no tube degradation occurs. In an embodiments, expected flow rate may include an initial flow rate identified by system 1000 on a previous day, month year and/or the like. In one or more embodiments, expected flow rate may be stored in a database and retrieved by controller. In one or more embodiments, controller 1072 may be configured to calculate actual flow rate by identifying a change in volume within storage tank and/or identifying a pressure within soap channel. In one or more embodiments, controller 1072 may compare actual flow rate to expected flow rate and transmit commands to peristaltic pump, water solenoid, valve and/or other electromechanical devices in order to increase power output and thus increase to decrease flow rate. In one or more embodiments, controller 1072 may identify tube degradation of system 1000 iteratively and adjust power output of various components accordingly.

With continued reference to FIG. 10, in one or more embodiments, a pump may be driven by a stepper motor, allowing precise control of rotational speed (RPM), which is a known and commanded parameter. Pump output may be directly proportional to RPM, assuming consistent mechanical and fluid conditions. Over time, the tubing connected to the pump may degrade due to chemical exposure or mechanical wear, leading to a reduction in the volume of fluid displaced per revolution. This degradation results in a lower actual flow rate for a given RPM. Actual Flow rate may then be determined by monitoring the change in tank level over time during dispensing. By measuring the volume dispensed, calculated from the rate of tank level change over a known time interval, the system can assess the real output of the pump. A calibration value, referred to as “pump trim,” may be periodically updated based on this observed flow rate. The pump trim value may be applied to the calculated nominal RPM to compensate for any discrepancy between expected and actual output. This adjustment ensures accurate dosing even as tubing characteristics change. The pump trim value may be maintained through ongoing calibration and is updated continuously throughout operation. When tubing is replaced, restoring original flow characteristics, the pump trim value is reset to a nominal baseline.

With continued reference to FIG. 10, in one or more embodiments, controller 1072 may be configured to store actual and expected flow rates on database. In one or more embodiments, controller 1072 may be configured to identify a change in tube degradation over time by plotting actual and expected flow rates over time. In one or more embodiments, controller may be configured to predict tube degradation and/or change in tube degradation over time by identifying trends in changes to expected and actual flow rates. Similarly, controller may be configured to identify component degradation wherein component degradation includes the ability of a component of system 1000 to work properly. In one or more embodiments, component degradation may include identification of a valve that does not work properly, identification of injection device not working properly and/or beginning to degrade. In one or more embodiments, controller 1072 may be configured to modify power output to one or more components of system in order to adjust for component degradation. In one or more embodiments, controller 1072 may be configured to predict degradation of components by identifying trends in actual vs expected flow rates. In one or more embodiments, controller 1072 may be configured to notify a user such as through a remote device, when a component has degraded and/or when a component is expected to require replacement due to degradation. In one or more embodiments, changes in environmental pressure, temperature and/or the like may affect flow rates. In one or more embodiments, controller 1072 may be configured to identify expected vs actual flow rates and adjust accordingly due to changes in the surrounding environment. For example, and without limitation, on a hotter day, actual flow rates may differ. In one or more embodiments, controller may use linear models and/or machine learning model to calculate and/or predict component degradation and/or tube degradation. In one or more embodiments, a surrounding environment of system 1000 may affect flow rates and/or dilution ratios. In one or more embodiments, factors affecting dilution ratios may include changes in humidity, changes in temperature, changes in PH of the fluid entering system, changes in chemicals within fluid entering system and/or the like. In one or more embodiments, controller may identify changes in flow rate that may emanate from environmental factors, wherein controller may adjust peristaltic pump and/or valve to ensure a desired dilution ratio between active agent and fluid. In one or more embodiments, controller may be configured to identify tube life estimation, wherein tube life estimation includes an indication on how long a tube can be used until it required replacement. In one or more embodiments, controller 1072 may use changes in tube degradation to calculate tube life estimation.

With continued reference to FIG. 10, soap system 1020 and/or storage tank 1024 may be configured to store active agents, such as active agents utilized for washing bugs off of vehicles. In one or more embodiments, active agent 1012 may include a bug remover pre-treatment for a vehicle. In one or more embodiments, the bug remover pre-treatment may include on or more chemicals designed to break down and loosen the proteins, sugars, and acids in bug splatter so they can be rinsed away more easily. In one or more embodiments, the pre-treatment may include alkaline surfactants, to break down organic matter such as bugs and tree sap. In one or more embodiments, the pre-treatment may include citrus-based solvents, used to cleaning as well. In one or more embodiments, the pre-treatment may further include enzymatic cleaners used to help digest organic matter. In one or more embodiments, soap system 1020 may be configured to store active agent 1012 such as pre-treatment in order to utilize active agent 1012 for cleaning a vehicle. In one or more embodiments, active agent 1012 may be diluted with fluid, such as water 1008 and navigated downstream to a car washing device. In one or more embodiments, the car washing device may include pumps, tubing and/or the like configured to expel the mixture 1064 at a high pressure.

With continued reference to FIG. 10, in one or mor embodiments, system 1000 may be activated and/or deactivated through the use of external devices. An “external device” for the purposes of this disclosure is a device separate from system 1000 that is configured to communicate with system 1000. For example, and without limitation, external device may include a remote device, such as a smart phone, wherein the smart phone maybe configured to initiate system 1000 and allow for active agent 1012 to be pumped through system and thus mixture 1064 is created. In one or more embodiments, external device may include pressure sensors within a car wash tunnel, wherein engagement of the pressure sensors by a vehicle, may indicate to system 1000 to initiate pumps, water manifolds, and/or the like in order to create mixture 1064 and navigate mixture 1064 through system 1000 and into car wash tunnel onto vehicle. In one or more embodiments, external device may include ultrasonic sensors, pressure sensors and/or any other sensors configured to identify the presence of a vehicle. In one or more embodiments, external devices may be used to initiate system 1000 and communicate with controller to initiate generation of mixture 1064.

With continued reference to FIG. 10, in one or more embodiments, aspects of the present disclosure may allow for dilution adjustment. Dilution adjustment is achieved through digital control of water and chemical flow rates using a remote device communicatively connected to controller 1072. Controller may receive input from a user via a graphical user interface (GUI). The GUI may be presented on a remote device, such as a smart phone, laptop and/or the like. In one or more embodiments, the GUI may present interactive sliders that correspond to dilution ratio settings. These inputs may be transmitted wirelessly or via a local network (e.g., Wi-Fi, Ethernet) to controller. The controller then adjusts either digital proportional valves or pump speeds, depending on the hardware configuration, to alter water and soap flow rates entering a venturi or mixing chamber. The adjustments may be performed in real time while the operator observes the output directly in the wash tunnel, enabling immediate response to desired changes in mixture characteristics. The GUI may be developed using common web-based frameworks and served from an embedded HTTP server within the control unit.

With continued reference to FIG. 10, system 1000 may include a tank level sensor, typically an ultrasonic, capacitive, or float-type sensor, installed in the soap reservoir within storage tank. This sensor may continuously report the fluid level to controller. Expected consumption rate is calculated based on known operational parameters such as pump RPM, commanded duty cycles, and dispensing intervals. Controller may compare the real-time rate of level depletion against the calculated expected rate over fixed time windows. If the observed depletion rate significantly exceeds the expected rate, controller 1072 may flag a discrepancy indicating a possible major leak. This function may use a time-weighted moving average algorithm or threshold-based logic to avoid false positives from minor variations. Leak detection logic runs continuously and logs data to support diagnostics.

With continued reference to FIG. 10, coil current monitoring may be implemented by integrating current-sensing circuitry into the power lines supplying solenoid valves and stepper motor drivers. This may be typically done using Hall-effect current sensors, low-resistance current shunt monitors, or integrated motor driver feedback signals. The current draw may be sampled at a fixed frequency by an analog-to-digital converter and processed by controller 1072 to identify electrical characteristics such as normal energizing current, open coil (zero current when commanded on), or short circuit (excessive current). For stepper motors, this monitoring can also reveal mechanical stalling, cable faults, or partial winding failures. Current profiles may be stored and compared against known operational baselines, and any deviations outside pre-defined bounds can trigger diagnostics or alerts.

With continued reference to FIG. 10, a diagnostic system may operate on controller 1072 wherein the diagnostic system continuously collects data from sensors (e.g., pressure sensors, flow sensors), electrical inputs (e.g., valve states, motor currents), and logic conditions (e.g., command status vs. sensor feedback). It executes rule-based logic trees or conditional decision trees where individual fault criteria are evaluated in real time. For example, if outlet pressure sensors report values exceeding 20 psi while the water valve control signal is off and the valve coil current is measured at zero, the system infers a mechanical failure in the valve (stuck open). Each diagnostic rule has a unique identifier that corresponds to a fault code. These fault codes are logged, timestamped, and optionally displayed via a user interface or exported to maintenance systems. Diagnostic rules are defined using condition sets with logical operators and can be updated via firmware.

With continued reference to FIG. 10, Quick-disconnect fittings may be implemented using standardized push-to-connect or twist-lock connectors placed at critical junctions in a dilution channel, soap channel and/or designated channel fluid pathway. These fittings allow for tool-less disconnection and reconnection of tubing, simplifying maintenance tasks such as tubing replacement, venturi cleaning, or chemical flushing. Material selection for these fittings must consider chemical compatibility (e.g., using EPDM, Viton, or polypropylene) and pressure rating consistent with the system's operating parameters. Fittings may also be installed with locking clips or retention mechanisms to prevent accidental disconnection under pressurized conditions. Integration of flow shutoff valves directly into the fittings is also possible, allowing automatic sealing of lines when disconnected.

With continued reference to FIG. 10, in one or more embodiments, a positive displacement gear pump may replace the peristaltic pump, delivering chemicals and/or active agents at a regulated high pressure of approximately 75 psi. This pressure is sufficient to overcome backpressure and to inject the chemical directly into a pressurized water line without relying on venturi suction. The mixing point consists of a T junction where water and chemical converge. A check valve is installed on the chemical line at the T junction to prevent backflow into the gear pump when water pressure exceeds chemical line pressure. Flow regulation is controlled by the gear pump speed, set via a variable-frequency drive or electronically controlled motor. This configuration simplifies the fluid circuit and enables high-precision dosing by directly metering chemical volume per pump revolution, leveraging the consistent output characteristics of gear pumps.

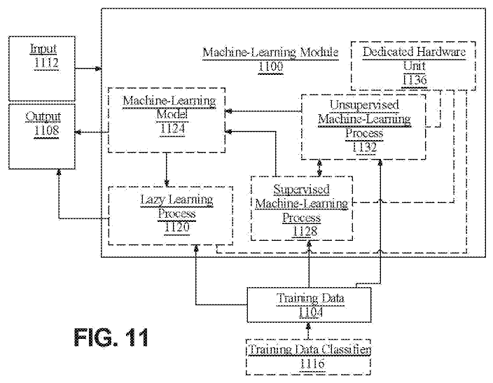

Referring now to FIG. 11, an exemplary embodiment of a machine-learning module 1100 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1104 to generate an algorithm instantiated in hardware or software logic, data structures, and/or functions that will be performed by a computing device/module to produce outputs 1108 given data provided as inputs 1112; this is in contrast to a non-machine learning software program where the commands to be executed are determined in advance by a user and written in a programming language.

Still referring to FIG. 11, “training data,” as used herein, is data containing correlations that a machine-learning process may use to model relationships between two or more categories of data elements. For instance, and without limitation, training data 1104 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1104 according to various correlations; correlations may indicate causative and/or predictive links between categories of data elements, which may be modeled as relationships such as mathematical relationships by machine-learning processes as described in further detail below. Training data 1104 may be formatted and/or organized by categories of data elements, for instance by associating data elements with one or more descriptors corresponding to categories of data elements. As a non-limiting example, training data 1104 may include data entered in standardized forms by persons or processes, such that entry of a given data element in a given field in a form may be mapped to one or more descriptors of categories. Elements in training data 1104 may be linked to descriptors of categories by tags, tokens, or other data elements; for instance, and without limitation, training data 1104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 11, training data 1104 may include one or more elements that are not categorized; that is, training data 1104 may not be formatted or contain descriptors for some elements of data. Machine-learning algorithms and/or other processes may sort training data 1104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1104 to be made applicable for two or more distinct machine-learning algorithms as described in further detail below. Training data 1104 used by machine-learning module 1100 may correlate any input data as described in this disclosure to any output data as described in this disclosure. As a non-limiting illustrative example, input data may include operation data, sensor data, command-status data, root-cause component, fault state, and the like. As a non-limiting illustrative example, output data may include root-cause component, fault state, fault resolution protocol, display data, prompt, and the like.

Further referring to FIG. 11, training data may be filtered, sorted, and/or selected using one or more supervised and/or unsupervised machine-learning processes and/or models as described in further detail below; such models may include without limitation a training data classifier 1116. Training data classifier 1116 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1100 may generate a classifier using a classification algorithm, defined as a process whereby a computing device and/or any module and/or component operating thereon derives a classifier from training data 1104. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1116 may classify elements of training data to a sub-population characterization, such as a cohort of persons, a demographic grouping, a diagnostic grouping, a geographic grouping, a device-specific grouping, a condition-specific grouping, or another analyzed-item or analyzed-phenomenon grouping for which a subset of training data may be selected.

Still referring to FIG. 11, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 11, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 11, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 11, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 11, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 11, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 11, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 11, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 11, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 11, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 11, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{n e w} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}} .$$

and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Further referring to FIG. 11, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 11, machine-learning module 1100 may be configured to perform a lazy-learning process 1120 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1104. Heuristic may include selecting some number of highest-ranking associations and/or training data 1104 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 11, machine-learning processes as described in this disclosure may be used to generate machine-learning models 1124. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1124 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1124 may be generated by creating an artificial neural network, such as a convolutional neural network comprising an input layer of nodes, one or more intermediate layers, and an output layer of nodes. Connections between nodes may be created via the process of “training” the network, in which elements from a training data 1104 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, machine-learning algorithms may include at least a supervised machine-learning process 1128. At least a supervised machine-learning process 1128, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include operation data, sensor data, command-status data, root-cause component, fault state, and the like as described above as inputs, root-cause component, fault state, fault resolution protocol, display data, prompt, and the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1104. Persons skilled in the art, upon reviewing the entirety of this disclosure, will be aware of various possible variations of at least a supervised machine-learning process 1128 that may be used to determine relation between inputs and outputs. Supervised machine-learning processes may include classification algorithms as defined above.

With further reference to FIG. 11, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including, without limitation, gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 11, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 11, machine learning processes may include at least an unsupervised machine-learning processes 1132. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1132 may not require a response variable; unsupervised processes 1132 may be used to find interesting patterns and/or inferences between variables, to determine a degree of correlation between two or more variables, or the like.

Still referring to FIG. 11, machine-learning module 1100 may be designed and configured to create a machine-learning model 1124 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 11, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including, without limitation, support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 11, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 11, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 11, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 11, one or more processes or algorithms described above may be performed by at least a dedicated hardware unit 1136. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1136 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1136 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1136 to perform one or more operations described herein, such as evaluation of model and/or algorithm outputs, one-time or iterative updates to parameters, coefficients, weights, and/or biases, and/or any other operations such as vector and/or matrix operations as described in this disclosure.

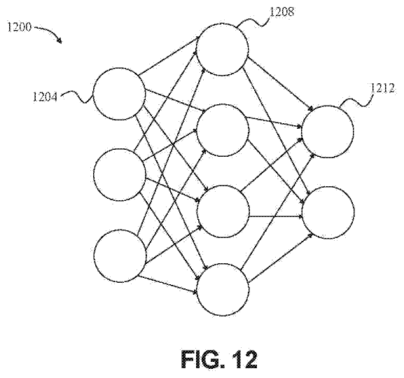

Referring now to FIG. 12, an exemplary embodiment of neural network 1200 is illustrated. A neural network 1200 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1204, one or more intermediate layers 1208, and an output layer of nodes 1212. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

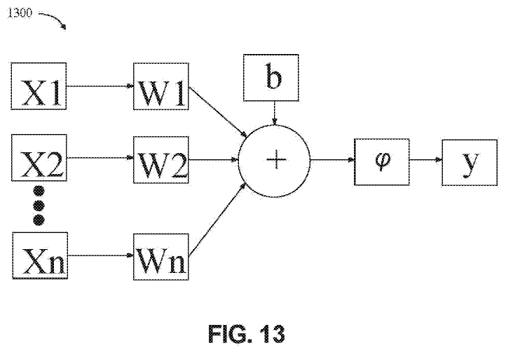

Referring now to FIG. 13, an exemplary embodiment of a node 1300 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, or of other coefficients and/or parameters of an activation function, may be determined by training a neural network using training data, which may be performed using any suitable process as described above. Each weight in a neural network may, without limitation, be updated and/or tuned, based on an error function J, using a backpropagation updating method, such as:

$${w}_{n e w} = {w}_{o l d} - α \frac{d J}{d w}$$

where w_{new} is the updated weight value, w_{old} is the previous weight value, α is a parameter to set the learning rate, and

$$\frac{d J}{d w}$$

is the partial derivative or with respect to weight w.

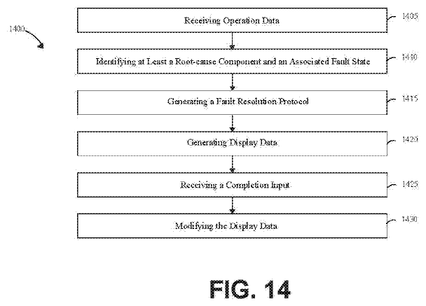

Referring now to FIG. 14, a flow diagram of an exemplary method 1400 of guided fault resolution for an operating system. Method 1400 contains a step 1405 of receiving, using at least a processor, operation data associated with operation of the operating system, wherein the operation data includes command-status data associated with the operating system, and sensor data from the one or more sensor for at least a control component of the operating system. In some embodiments, the sensor data may include at least one of pressure data, flow data, current data, and level data. In some embodiments, the at least a control component may include at least one of a valve, a pump, an injector, and a fluid line component of the operating system. In some embodiments, the operating system may include a fluid dispensing system configured to dispense a mixture of fluid and an active agent. This may be implemented with reference to FIGS. 1-13 and without limitation.

With continued reference to FIG. 14, method 1400 contains a step 1410 of identifying, using at least a processor, at least a root-cause component and an associated fault state as a function of operation data. In some embodiments, identifying the at least a root-cause component and the associated fault state may include selecting a diagnostic rule set that defines a plurality of fault conditions as logical relationships between the command-status data and the sensor data, and identifying the at least a root-cause component and the associated fault state as a function of the operation data and the diagnostic rule set. In some embodiments, identifying the at least a root-cause component and the associated fault state may include determining, from the command-status data, a commanded state of the at least a control component, determining, from the sensor data, an observed operating state of the at least a control component, and identifying the at least a root-cause component and the associated fault state in response to a mismatch between the commanded state and the observed operating state. In some embodiments, identifying the at least a root-cause component and the associated fault state may include retrieving historical operation data associated with prior operation of the operating system as a function of the operation data, and identifying the at least a root-cause component and the associated fault state by comparing the operation data to the historical operation data. This may be implemented with reference to FIGS. 1-13 and without limitation.

With continued reference to FIG. 14, method 1400 contains a step 1415 of generating, using at least a processor, a fault resolution protocol corresponding to at least a root-cause component and an associated fault state, wherein the fault resolution protocol includes one or more resolution instructions. This may be implemented with reference to FIGS. 1-13 and without limitation.

With continued reference to FIG. 14, method 1400 contains a step 1420 of generating, using at least a processor, display data for a communication interface, wherein the display data causes the communication interface to present one or more of an identification of at least a root-cause component, a fault indication corresponding to an associated fault state, and a first resolution instruction of one or more resolution instructions. In some embodiments, the communication interface may include a first user interface of the at least a control component, and a second user interface of a remote user device communicatively connected to the operating system. This may be implemented with reference to FIGS. 1-13 and without limitation.

With continued reference to FIG. 14, method 1400 contains a step 1425 of receiving, using at least a processor, a completion input indicating completion of a first resolution instruction and updated operation data associated with an operation of an operating system. This may be implemented with reference to FIGS. 1-13 and without limitation.

With continued reference to FIG. 14, method 1400 contains a step 1430 of modifying, using at least a processor, display data to present a subsequent resolution instruction of one or more resolution instructions as a function of updated operation data. In some embodiments, modifying the display data may include receiving the updated operation data indicating that the first resolution instruction has not been completed, and modifying the display data as a function of the updated operation data by presenting a modified instruction. In some embodiments, modifying the display data may include identifying partial completion of the first resolution instruction as a function of the updated operation data, generating a modified instruction and a prompt requesting an additional completion input as a function of the identification of partial completion of the first resolution instruction, and modifying the display data to present the modified instruction and the prompt. This may be implemented with reference to FIGS. 1-13 and without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

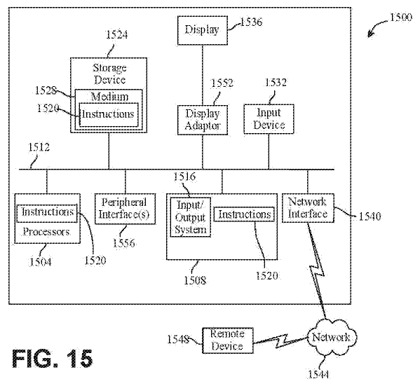

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulpo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof. Memory 1508 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In some embodiments, storage device 1524 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or more remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display 1536. Examples of a display device include, but are not limited to, a liquid crystal display (LCD), a cathode ray tube (CRT), a plasma display, a light emitting diode (LED) display, and any combinations thereof. Display adapter 1552 and display 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

Further referring to FIG. 15, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 15, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 15, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1500, processor 1504, and memory 1508 may be virtualized; that is, a virtual machine and/or container may interact directly with such computing system 1500, processor 1504, and/or memory 1508, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1504 comprises a plurality of processors and/or processor cores, virtualization may, in some cases, simulate or emulate a single (virtual) processor whose functions are allocated to one or more of the plurality of processors and/or processor cores. In this case, while processor 1504 may be said to be virtualized, the processor 1504, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU; (2) VMware by Broadcom Inc of Palo Alto, California; (3) VirtualBox by Oracle Corporation headquartered in Austin, Texas; and (4) kernel-based virtual machine (KVM).

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for guided fault resolution for an operating system, the apparatus comprising:
one or more sensors incorporated with an operating system;
at least a processor; and
a memory communicatively connected to the at least a processor, wherein the memory contains instructions configuring the at least a processor to:
receive operation data associated with operation of the operating system, wherein the operation data comprises:
command-status data associated with the operating system; and
sensor data from the one or more sensors for at least a control component of the operating system;
identify at least a root-cause component and an associated fault state as a function of the operation data;
generate a fault resolution protocol corresponding to the at least a root-cause component and the associated fault state, wherein the fault resolution protocol comprises one or more resolution instructions;
generate display data for a communication interface, wherein the display data causes the communication interface to present one or more of:
an identification of the at least a root-cause component;
a fault indication corresponding to the associated fault state; and
a first resolution instruction of the one or more resolution instructions;
receive a completion input indicating completion of the first resolution instruction and updated operation data associated with the operation of the operating system; and
modify the display data to present a subsequent resolution instruction of the one or more resolution instructions as a function of the updated operation data.

2. The apparatus of claim 1, wherein the sensor data comprises at least one of pressure data, flow data, current data, and level data.

3. The apparatus of claim 1, wherein the at least a control component comprises at least one of a valve, a pump, an injector, and a fluid line component of the operating system.

4. The apparatus of claim 1, wherein the operating system comprises a fluid dispensing system configured to dispense a mixture of fluid and an active agent.

5. The apparatus of claim 1, wherein identifying the at least a root-cause component and the associated fault state comprises:
selecting a diagnostic rule set that defines a plurality of fault conditions as logical relationships between the command-status data and the sensor data; and
identifying the at least a root-cause component and the associated fault state as a function of the operation data and the diagnostic rule set.

6. The apparatus of claim 1, wherein identifying the at least a root-cause component and the associated fault state comprises:
determining, from the command-status data, a commanded state of the at least a control component;
determining, from the sensor data, an observed operating state of the at least a control component; and
identifying the at least a root-cause component and the associated fault state in response to a mismatch between the commanded state and the observed operating state.

7. The apparatus of claim 1, wherein identifying the at least a root-cause component and the associated fault state comprises:
retrieving historical operation data as a function of the operation data; and
identifying the at least a root-cause component and the associated fault state by comparing the operation data to the historical operation data.

8. The apparatus of claim 1, wherein the communication interface comprises:
a first user interface of the at least a control component; and
a second user interface of a remote user device communicatively connected to the operating system.

9. The apparatus of claim 1, wherein modifying the display data comprises:
receiving the updated operation data indicating that the first resolution instruction has not been completed; and
modifying the display data as a function of the updated operation data by presenting a modified instruction.

10. The apparatus of claim 1, wherein modifying the display data comprises:
identifying partial completion of the first resolution instruction as a function of the updated operation data;
generating a modified instruction and an action trigger requesting an additional completion input as a function of the identification of partial completion of the first resolution instruction; and
modifying the display data to present the modified instruction and the action trigger.

11. A method of guided fault resolution for an operating system, the method comprising:
receiving, using at least a processor, operation data associated with operation of an operating system, wherein the operation data comprises:
command-status data associated with the operating system; and
sensor data from one or more sensors for at least a control component of the operating system;
identifying, using the at least a processor, at least a root-cause component and an associated fault state as a function of the operation data;
generating, using the at least a processor, a fault resolution protocol corresponding to the at least a root-cause component and the associated fault state, wherein the fault resolution protocol comprises one or more resolution instructions;
generating, using the at least a processor, display data for a communication interface, wherein the display data causes the communication interface to present one or more of:
an identification of the at least a root-cause component;
a fault indication corresponding to the associated fault state; and
a first resolution instruction of the one or more resolution instructions;
receiving, using the at least a processor, a completion input indicating completion of the first resolution instruction and updated operation data associated with the operation of the operating system; and
modifying, using the at least a processor, the display data to present a subsequent resolution instruction of the one or more resolution instructions as a function of the updated operation data.

12. The method of claim 11, wherein the sensor data comprises at least one of pressure data, flow data, current data, and level data.

13. The method of claim 11, wherein the at least a control component comprises at least one of a valve, a pump, an injector, and a fluid line component of the operating system.

14. The method of claim 11, wherein the operating system comprises a fluid dispensing system configured to dispense a mixture of fluid and an active agent.

15. The method of claim 11, wherein identifying the at least a root-cause component and the associated fault state comprises:
selecting a diagnostic rule set that defines a plurality of fault conditions as logical relationships between the command-status data and the sensor data; and
identifying the at least a root-cause component and the associated fault state as a function of the operation data and the diagnostic rule set.

16. The method of claim 11, wherein identifying the at least a root-cause component and the associated fault state comprises:
determining, from the command-status data, a commanded state of the at least a control component;
determining, from the sensor data, an observed operating state of the at least a control component; and
identifying the at least a root-cause component and the associated fault state in response to a mismatch between the commanded state and the observed operating state.

17. The method of claim 11, wherein identifying the at least a root-cause component and the associated fault state comprises:
retrieving historical operation data as a function of the operation data; and
identifying the at least a ROOT-cause component and the associated fault state by comparing the operation data to the historical operation data.

18. The method of claim 11, wherein the communication interface comprises:
a first user interface of the at least a control component; and
a second user interface of a remote user device communicatively connected to the operating system.

19. The method of claim 11, wherein modifying the display data comprises:
receiving the updated operation data indicating that the first resolution instruction has not been completed; and
modifying the display data as a function of the updated operation data by presenting a modified instruction.

20. The method of claim 11, wherein modifying the display data comprises:
identifying partial completion of the first resolution instruction as a function of the updated operation data;
generating a modified instruction and am action trigger requesting an additional completion input as a function of the identification of partial completion of the first resolution instruction; and
modifying the display data to present the modified instruction and the action trigger.
